(19) United States
(12) Patent Application Publication
(10) Pub. No.: US 2026/0154040 A1
(43) Pub. Date: Jun. 4, 2026

(54) BUILDING SOLUTIONS USING NATURAL LANGUAGE PROCESSING

(71) Applicant: BRANE COGNITIVES PTE. LTD., Singapore (SG)

(72) Inventor: Ramalinga Raju Byrraju, Hyderabad (IN)

(73) Assignee: BRANE COGNITIVES PTE. LTD., Singapore (SG)

(21) Appl. No.: 18/865,300

(22) PCT Filed: May 12, 2023
(86) PCT No.: PCT/SG2023/050330

§ 371 Date: Nov. 12, 2024

(30) Foreign Application Priority Data
May 13, 2022 (IN) 202241027734
Jul. 5, 2022 (IN) 202241038565
Jul. 28, 2022 (IN) 202241043310
Sep. 8, 2022 (IN) 202241051441

(51) Int. Cl. G06F 8/20; G06F 40/30

(52) U.S. Cl. CPC G06F 8/20; G06F 40/30

(57) ABSTRACT

The present disclosure relates to the field of information technology. More particularly, the present disclosure relates to computer-implemented methods, systems, and computer-readable media for designing and deploying solutions.

The present complete specification is accompanied with the Indian patent application which is a cognate of the Indian application numbers 202241027734, 202241038565, 202241043310, and 202241051441, each of which was accompanied with a respective provisional specification.

### TECHNICAL FIELD

The present disclosure relates to the field of Information Technology. More particularly, the present disclosure relates to computer-implemented methods, systems, and computer-readable media for designing and deploying solutions.

### BACKGROUND

Software engineering, design, and architecture practices have changed and evolved significantly over the last sixty years. For the sake of simplicity, many levels of abstraction in communicating the logic of operations to the computer can be classified into two groups: (1) high-level application logic being imparted through programming languages; and (2) operating-systems-and-below that mediate or deal with the computers and their operations more directly.

There are primarily three popular operating systems: Microsoft Windows, Apple Mac OS X, and Linux. However, there are hundreds of programming languages. All programming languages are extensively driven by code (symbols that have specific meanings and functions delineated from natural language and arithmetic). It takes several weeks to months for software specialists and engineers to master a programming language and participate in creating or maintaining solutions. Therefore, the users may not be able to create or modify solutions without the interventions of technology specialists.

Over the years, the information technology's computing and communication power has grown exponentially. The software design and management techniques have improved with the movement towards component-based design, service-oriented architecture, web services, business process management, and agile project management methodologies. However, concomitantly the landscape of technology has become more complex as the number of moving parts has proliferated. The common user remained alienated from the computing technologies and solution design and effecting changes to the solutions. This overdependence of the user on the technology experts and mediators is due to the programming languages being different from the natural languages. The technology systems have not realized a creative and innovative opportunity for programming languages to be as powerful as the natural languages.

Natural Solution Language (NSL) generates a transformative effect by eliminating the need to convey solution or application logic to the computers through programming code. NSL permits users to convey the solution logic to the computer directly, as they would convey the user requirements to a technology specialist using natural language constructs that are similar to natural languages.

NSL relies on a layer of ‘technology framework,’ called NSL-TF, that sits on top of operating systems, functioning as though it is an integral part of those operating systems. NSL is driven by a simple but powerful method called ‘differentiation principles,’ whereby traditional functions and processes get converted to information. NSL is fundamentally influenced by the fact that all solution logic pertains to entities and their relationships.

NSL democratizes solution design, maintenance, and related operations by empowering the users and bringing all the relevant entities to the user interface levels.

The features, terms, concepts, and applications of NSL have been elaborated in greater detail in the Indian Patent Application Number 201941028675 with the corresponding PCT Application Number PCT/SG2020/050004. The description of the Indian Patent Application Number 201941028675 is incorporated herein by reference.

### SUMMARY

The present disclosure is about additional features and concepts integrated with the NSL Technology Framework (NSL-TF) that establishes the equivalence principles of NSL with any established existing solution frameworks in use. By quantifying solutions in Binary Entities (BETs) and allowing BETs to be present in multiple substrates, NSL allows substrate crossover and substrate tagging that can have a powerful impact on building efficient solutions that the existing systems lack.

NSL aims to eliminate information asymmetries and functional asymmetries between human agents and machine agents. The Analytical Engine and Inference Engine help to unleash the machines' true potential by replicating human behaviour or, in some cases, exceeding human intelligence by their ability to process large amounts of data, make quick decisions and act without the help of human interventions.

### BRIEF DESCRIPTION OF FIGURES

Features, aspects, and advantages of the present disclosure will be better understood when the following detailed description is read with reference to the accompanying figures.

FIG. 1 represents an example of BET.

FIG. 2 represents an example of Tightly coupled entities.

FIG. 3 represents an example of Loosely coupled entities.

FIG. 4 represents an example of Connected Change Unit.

FIG. 5 represents an example of Related Change Unit.

FIG. 6 represents an example of Minimum Membership Criterion.

FIG. 7 represents an example of Principles of Physical Continuum.

FIG. 8 represents an example of Dynamic Switch between potentiality and reality.

FIG. 9 represents an example of Analytical Engine.

FIG. 10 represents an example of Inference Engine.

FIG. 11 represents an example of NSL-Technology Framework Architecture

FIGS. 12a and 12b represent an example of Vantage Point Switching.

FIG. 13 represents an example of Functional Distances.

FIG. 14 represents an example of Negative Entities.

FIG. 15 represents an example of Bayesian logic.

FIG. 16 represents an example of Variability.

FIG. 17 represents an example of Principles of Correlations

FIG. 18 represents an example of Regression Analysis.

FIG. 19 represents an example of Residual Information in NSL.

FIG. 20 represents an example of Information Rights and Decision Rights.

FIG. 21 represents an example of Assignment and Delegation of Information Rights and Decision Rights.

FIG. 22 represents an example of delivery of a product to a customer within a specified time frame or more than a specified time frame.

FIG. 23 represents an example of four layered CUs.

FIG. 24 represents a CU as a local network of nodes.

FIG. 25 represents interrogatives helping convert descriptive statements to prescriptive statements in a binary state.

FIG. 26 represents interrogatives helping convert descriptive statements to prescriptive statements with multiple options.

FIG. 27 represents an example of a desired event and null events using pen and paper entities.

FIG. 28 represents an example of a class within a class.

FIG. 29 represents an example of five identified substrates in the substrate library.

FIG. 30 represents an example of the GSI of the lower-level CUs triggering the higher-level CU.

FIG. 31 represents an example of nested CUs applying greater contextuality to the contextuality existing at the higher-level CU.

FIG. 32 represents an example of shades of potentiality in a combination of two binary entity models.

FIG. 33 represents an example of carrying varying amounts of information irrespective of the substrates.

FIG. 34 represents an example of the Parallel CUs.

FIG. 35 represents a generalized computer network arrangement for NSL.

FIG. 36 represents Multi-layered CUs in NSL.

FIG. 37 illustrates an exemplary method for building a computer-implemented solution using a natural language understood by users and without using programming codes.

### DETAILED DESCRIPTION

While system, device or apparatus, and method are described herein by way of examples and embodiments, those skilled in the art recognize that system and method for providing solutions are not limited to the embodiments or figures described.

It should be understood that the figures and description are not intended to be limiting to the particular form disclosed. Rather, the intention is to cover all modifications, equivalents, and alternatives falling within the spirit and scope of the appended claims. Any headings used herein are for organizational purposes only and are not meant to limit the scope of the description or the claims. As used herein, the word “may” is used in a permissive sense (e.g., meaning having the potential to) rather than the mandatory sense (e.g., meaning must). Similarly, the words “include”, “including”, and “includes” mean including, but not limited to.

The following description is a full and informative description of the best method and system, device, or apparatus presently contemplated for carrying out the present disclosure, which is known to the inventor at the time of filing the patent application. Of course, many modifications and adaptations will be apparent to those skilled in the relevant arts in view of the following description, accompanying figures, and the appended claims. While the system, device or apparatus, and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique, and not in limitation thereof since the present technique is defined solely by the claims.

As a preliminary matter, the definition of the term “or” for the purpose of the following discussion and the appended claims is intended to be an inclusive “or” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A” by itself, “B” by itself, and any combination thereof, such as “AB” and/or “BA.” It is worth noting that the present discussion relates to exemplary embodiments, and the appended claims should not be limited to the embodiments discussed herein.

For the purpose of description herein, a processor may be implemented as microprocessors, microcomputers, microcontrollers, digital signal processors, central processing units, state machines, logic circuitries, and/or any devices that manipulate signals based on operational instructions. Among other capabilities, the processor may fetch and execute computer-readable instructions stored in a non-transitory computer readable storage medium coupled to the processor. The non-transitory computer-readable storage medium may include, for example, volatile memory (e.g., RAM), and/or non-volatile memory (e.g., EPROM, flash memory, NVRAM, memristor, etc.).

For the purpose of description herein, a memory may be a memory of a computing device and may include any non-transitory computer-readable storage medium including, for example, volatile memory (e.g., RAM), and/or non-volatile memory (e.g., EPROM, flash memory, NVRAM, memristor, etc.).

For the purpose of description herein, a module, amongst other things, includes routines, programs, objects, components, data structures, and the like, which perform particular tasks or implement particular data types. The module further includes modules that supplement applications on a computing device, for example, modules of an operating system. The operating system comprises at least one of Batch Operating System, Time-Sharing Operating Systems, Distributed Operating Systems, Network Operating Systems, and Realtime Operating Systems.

Each of the terms listed below have specific roles and applications with respect to computer implemented NSL methodology. These individual technological and methodological elements have their roles explained with respect to NSL.

It is claimed that Natural Solution Language (NSL) will replace programming languages by communicating with the machine in a natural language like fashion. For Natural Solution Language (NSL) to cause a transformative technical effect, a computer-implemented method is required to be applied. This method requires a sensitive approach to entities and their relationships as the situations warrant. Entities and their relationships come in different variations and each one of those variations has to be properly defined and treated.

Central Dogma of NSL: All solutions are about entities and their relationships in the context of the agent's intentionality. All solutions are about getting from one desired state to another more desired state. Most solutions are about getting to the desired state through a series of connected solution states.

Solution Ecosystem: The solution designers choose and use potential entities from the ‘real world’ to establish relationships between them. The relationships between potential entities are such that they combine and interact in ways that solutions could be accomplished along the established pathways of change.

Way World Works (WWW) Principles: Rather than just the traditional technology, NSL is a blend of understanding from science and technology, creating a new paradigm in the solution architecture. WWW are the principles that guide the way universe or nature functions as understood and appreciated by current day science. The NSL logic takes advantage of all the scientific insights with respect to the way the world works and brings to bear certain innovative methodologies with respect to solutions that human agents seek through the use of computers. For example, all things are made up of particles. When particles combine, they give rise to emergent properties which happen in space and time. All these events are driven by energy, in accordance with the way world works principles. These, in turn, have a bearing on what agents do and how they cause movements from one desired state to another through directed changes.

Entities: Anything that is distinct is an entity. That is, anything that has a standing of its own and can be represented in terms of information is an entity. In language, entities are represented by words, symbols, or numbers. For example, a sand grain also qualifies to be an entity, just as a car is qualified to be an entity.

Differentiated Entities: Anything that is distinct and at the same time different from other entities is a differentiated entity. That is, as compared to some other entity, it is different. In natural language, these are represented by words. For example: a ‘pen’ is different from a ‘paper’.

Un-Differentiated Entities: Anything that is distinct, and same-as-some other entity or entities is considered un-differentiated from the other entity or entities. Such ‘recurrences’ happen in space and time. These recurrences fall in the domain of mathematics and are represented by numbers. From a solution design perspective, if one entity can be effectively replaced by some other entity without affecting the outcome, such entity is considered recurrent in either space or time. For example, if there is a pen and a paper on the table, one can say, ‘there is a pen and a paper’ on the table. But, if there is one pen and ‘another pen’ on the table, one can say, ‘there are two pens on the table.’

Potential Entities Vs. Non-Potential Entities: Solution design involves entities and their relationships. These entities are chosen from the real world in the context of solution design. Those that are chosen for the potential they hold with respect to the solution are declared as ‘potential entities’. Those that are not made part of the solution related ‘potentiality set’ are left out and would have no relevance from the perspective of the solution ecosystem.

Independent Entities: These are entities at the level of which binary events happen—that is, switching between potentiality and reality happen resulting in changes in Combinatorial Entity States in which they participate. For example, a pen may move into existence or disappear from existence. As an independent entity event happens, it could change the state of the combinatorial ecosystem it is a part of. If it exists along with paper as a potential entity, together they can give rise to 2\hat{ }2, 4, potential combinatorial states.

Implied Entities: Many times, entities connected to other entities are implied and ignored. For example, if a person enters a street, it is implied that he is there in association with the clothes he wears. Clothes here are implied. Similarly, it is implied that there is air for the human agents to breathe. In case of room reservation, the presence of an ‘agent’ for inputting the information may be implied. The designer of the solution takes such implied entities as a given. Even attributes are implied most of the time. All change happens within the ‘change units’ (SIs). Change happens only when physical interactions take place in space and time. If the space and time of one independent entity is known, the space and time attributes of the other entity may be implied. Even otherwise, it may even be the case that for the solution designer, not specifying those attributes may not alter the essence of the design making.

Shared Entities: A shared entity is one that is common across many local or global statements of intent. There are many independent entities that are part of a trigger state for a given statement of intent. When a statement of intent is in a trigger state, during the lapse time associated with the trigger, that entity would not be available for participation with respect to any other statement of intent. But once the triggered change is completed, the participating entity becomes available again as a shared entity across all the related statements of intent.

Informational Entities: Informational entities are entities artificially created by human agents for the purpose of communicating the representational entities they are in possession to other agents in the ecosystem.

Attributes: An attribute is also an entity but one that is dependent on some other entity for its existence. Such dependent entities are explicitly referred to as attributes. Dependence is defined as presence of one entity being owed to the presence of another independent entity. For example, a pen may exist in space and time. Here, space and time are considered attributes or dependent entities. Note that a ‘spatial unit’ or a ‘temporal unit’ qualify to be called entities. As they are dependent on the higher-level entity, NSL refers to them as attributes. When the pen is deleted, the attributes are automatically deleted. Entities contain a lot of implied information. Some implied information is recognized but yet ignored as it may not be central to the solutions. For example, one may care for someone being dressed well or not. But one may not care about the color of a shirt. Sometimes implied information may not be known or accessible. For example, one may not know the number of cells there are in one's body or, for that matter, most people may not know that the body has an organ called ‘Spleen’. An attribute arises out of surfacing such implied and associated information relating to an entity as the context demands.

Levels of Attributes: There is no limit to number of levels at which attributes can exist. The first level is called the ‘primary attribute’, the second level is called the ‘secondary attribute’, the third level is called the ‘tertiary attribute’, and so on. For example, if at the first level, space is defined as India, each state would exist at the secondary level, and each city at the tertiary level.

Natural Attribute Values: Any information that is attached as an attribute value in a solution belongs to this category. Spatial coordinates and time will, therefore, naturally belong to this category, as they are standard essential attributes. All the attribute values extracted from any entity such as its weight, volume, color, and the like, shall also belong to this category.

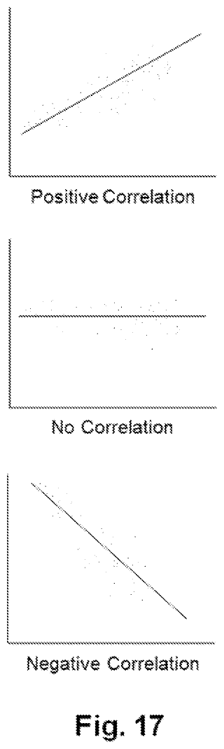

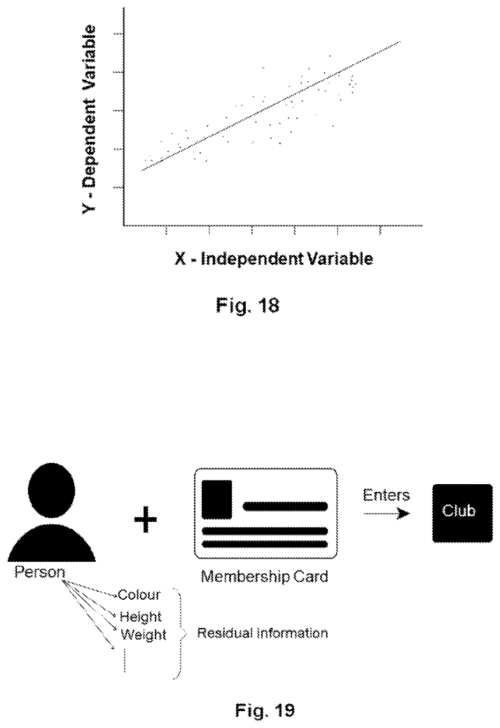

Derived Attribute Values: As the name suggests, all the derived attribute values shall belong to this category. All the values derived by applying different kinds of established statistical techniques shall belong to this category. For example, probabilities, correlations (as shown in the FIG. 17), variability, averages, ratios, measurements of various kinds, regression analysis (as shown in the FIG. 18), and the like. These values can either be derived in real time or through a batch mode, as the situation may warrant. NSL provides these options that give the flexibility to the solution designer or the user to specify what they are looking for.

Change Drivers: The entities along with its attributes that bring about the change in the change unit are known as change drivers. Attributes are also entities, but they are dependent on independent entities. There can be any number of layers of attributes that differentiate independent entities even further. Every change driver has a slot, and every slot is connected to a transformational pathway. Each slot is called as a change component. Each driver has their own unique and distinct identity and intrinsic information.

Change Units (CUs): A change unit is one that is described by a statement of intent (SIs) from the natural language point of view. Value of any kind happens only through controlled changes, and that happens only inside the change units. It is by knitting together the local change units (creating paragraphs by combining sentences) that one can get to the global change units that human agent desire or intend. In the interest of simplicity, NSL treats these change units as synonymous with SIs. Therefore, CUs and SIs are used interchangeably in this document. Local Statements of Intent are local ‘change units’ expressed as statements of intent (sentences) in terms of natural language. Global Statement of Intent are ‘global change units’ expressed as global statements of intent (paragraphs) in terms of natural language.

Agents: Agents are also entities. Agents are both creators of solutions and consumers of solutions. Agents are differentiated from ‘nature’ as they are driven by ‘purpose. In other words, they seek favourable changes and avoid unfavourable ones. As every solution deal with a controlled change, it is presupposed that all change units are influenced by agents—whether human agents or machine agents. As all change requires energy, agents use the energy inherent in them or borrow it from one or more combinatorial entities and provide directionality to change by following predetermined pathways or through application of free will.

Human Agents: Also referred to as ‘stakeholders’, human agents play multiple roles depending on the requirements the solution environment imposes on them. Some change units are driven by human agents of necessity. For example, a physical delivery of some ‘hard asset’ will require human agents to be involved.

Agent Functions: The agent functions that take place within statements of intent can be divided into three layers of statements of intent: i) Physical Functions: Physical functions relate to the participation of independent entities resulting in combinatorial entity states (CES) that form the backbone of statements of intent. Physical functions serve the principal function of facilitating solutions, while the other two categories either directly or indirectly support physical functions. ii) Information Functions: Information functions relate to entities that are connected to combinatorial entity states and serve only the function of providing information but not involved in the physical function. By extension, these information functions are connected to statements of intent and the agents who drive them. Information functions keep the agents well informed and play a role in dynamic solution re-design and other value adding functions like analytics, machine learning, and artificial intelligence. iii) Mind Functions: Mind functions, from the computer implemented NSL perspective, emulate the functions of human mind in the real world. These functions ‘anticipate’ entity states and guide the physical functions in the process of bringing about desired transformations. Anticipation applies to the ‘temporal aspects’ that concern the future. But anticipation can apply to all situations where there is uncertainty. In theory, uncertainty can pertain to things in the past or present also. For example, one may not fully know about, but could attempt to anticipate, what happened yesterday or what is happening in the other room at the present. A revision in ‘estimates’ or ‘anticipation’ could happen at the instance of every event. If such anticipation has a bearing on the physical function at the present, those are feedback into physical function as entities that influence. Apart from playing a similar role such as information function, mind function also helps in advance planning and optimization functions.

Information Rights: These are the rights of the human agents for information with respect to specific independent or combinatorial entities and statements of intent connected thereto.

Decision Rights: These are the rights of the human agents to change the potentiality or reality states of individual or combinatorial entities and statements of intent connected thereto.

Machine Agents: These are synonymous with ‘computers’ where the units of change are driven by the machine agents—as designed by human agents or other machine agents—so that proper outputs are generated in response to inputs. Machine agents essentially emulate human agents in their ability to consume inputs, bring about a controlled change among them (process those inputs) and generate outputs. Human agents impart qualities of being purpose driven into machine agents.

Events: All events arrive in one local-statement of intent or the other. All events are about an individual entity being turned from one state to another—a state of potentiality to reality or vice versa. The occurrence of an event by way of arrival or departure of an individual entity into or from an LSI, results in the state of the combinatorial set as a whole changing. If there are 6 variable entities in the LSI, there could be 64 different states in which the combinatorial entities could exist. A binary state change at the individual entity level can lead to any one of the 64 different states in LSI. While 63 other states may be in non-trigger combinatorial entity states, the 64th one would be in a trigger state influencing other LSI states or itself.

Combinatorial Entity States (CES): When independent entities (dragging with them their attributes) combine with other independent entities, those give rise to combinatorial states that are differentiated and have emergent properties of their own. CES are housed in local statements of intent (LSI), each representing a unit of change—which is equivalent of a sentence. A collection of such LSI leading to a bigger desired change is referred to as Global Statements of Intent (GSI)—which is equivalent of a paragraph. The size of CES in an LSI is proportionate to the number of independent entities participating. Each LSI will entertain 2\hat{ }n states, where ‘n’ is the number of independent entities, as each independent entity could exist either in a state of ‘potentiality’ or ‘reality’. Fundamentally, there are two kinds of Combinatorial Entity States in each Local statements of intent: i) Non-Trigger CES: These are entity combinations that do not cause alteration in the combinatorial entity states in other local statements of intent or within the same LSI to which they belong. For example, if there are four independent entities, as binary variables, they give rise to 2\hat{ }4 entity states-that is, 16 CES. Of these states, 15 states are non-trigger CES as they do not trigger any change. ii) Trigger CES: These combinatorial entity states trigger changes in one or more other LSI or within the same LSI. Trigger CES are those where all the independent entities and their attributes are in a state of reality. When a CES in one LSI influences CES in other LSIs, those sentences get connected. LSIs are grouped together based on their involvement in the realization of GSI, making a paragraph. Going by the previous example, the 16th state is the trigger state as all the four independent entities are present in a state of reality in that state.

Binary States: In NSL solution design, all entity states are expressed as existing only in binary states. That is, they either exist in potentiality or reality states. Every state is discrete and there is no intermediary state. Each word operates in a binary state, and even sentences and paragraphs exist in binary states. Agents only keep changing the vantage points from which they view the entities. As one zooms in or zooms out, the vantage points change. But each vantage point is in a binary state. The choice of binary states in NSL solution design is a choice for discrete states as versus continuous-akin to a choice of the digital as versus analogue. When events happen, there are state transitions with the excluded middle. In theory, these binary states can also be represented by assigning values of being ‘true or false’.

Natural Solution Language (NSL): This is a slightly modified version of natural language, a computer implemented method, where things are recast in the form of capturing only statements of intent and making all descriptive statements subservient to the statements of intent. These statements of intent exist in two states: i) Static Statements of Intent: These only express the intent but lack the ability to transform them into reality. Static entity states are those entity states that have no properties of being able to trigger changes in other states. If there are 6 variables in a system (independent entities and their attributes), they could potentially exist in 64 different states. But only the 64th state is capable of triggering change when all the variables are present in the ‘reality’ state. All the other entity states are called ‘static entity’ states. A point to be noted in this respect is that statement of intent (SI) is just another independent entity that describes the nature of desired change, participating in the ‘change unit’. The existence of an SI is based on the fact that for any action to follow, it has to be backed up by an agent's intention. ii) Dynamic Statements of Intent: These are the underlying, transformation causing entities behind the statements of intent that collectively trigger on attaining a certain desired state, called Trigger Combinatorial Entity States, as influenced by events at independent entity level. Dynamic entities states are those entity states that can cause further changes in one or more entity states, including themselves. In the previous example, the 64th state is the ‘dynamic entity’ state. In other words, for a static statement of intent to become dynamic and fulfil a statement of intent, it needs to be powered by a trigger CES.

User Interfaces (UI): Entities can exist at different levels of abstraction either in the databases or at the user interface levels. It is at the level of user interfaces that the human agents exercise their ‘information rights’ or ‘decision rights’. UI plays quite a prominent role in NSL as the ‘users’ oversee creation or use of solutions. All things happen over the hood rather than under the hood. NSL drives the behaviour of entities at the UI level by making UI an ‘essential attribute’. These attributes specify how an entity should appear at the UI level, what its address is (which screen and place on the screen), whether it is sensitized for navigation or inputting of information, and the like.

NSL Technology Framework: An innovative technical effect that NSL brings about is a combination of a unique method and a technology framework. NSL rides over a standardized technology framework that caters to a wide range of application requirements where the ‘users’ are the primary drivers of solutions. The Technology framework, encapsulating all the innovative methods described in this document, sits on top of the operating systems to cater to any kind of application logic to be conveyed to the computers. The user remains agnostic to this underlying technology framework and is empowered to use NSL in a natural language like fashion. In summary, the NSL technology framework is a thin additional layer on top of existing operating systems which gives life to principles and methods behind NSL that is based on differentiation principles. In addition, it also helps automate most of the otherwise human agent functions. But for enhancements from time to time, the NSL technology framework will remain a constant. Just like an operating system, it conveys NSL logic to the computer without the use of any code and through natural language constructs.

Technology Translation Framework (TTF): One of the most significant things that NSL has is the ability to convert any programming code into natural language like NSL format based on the same principles that deal with controlled differentiations using NSL methods and NSL Technology Framework (NSL-TF), thereby surfacing the logic for direct use and influence of the users or stakeholders. TTF rides over the matrix-based/tile-based approach, which encapsulates the keywords, operators, symbols, and functions of each programming language and its representation in NSL. The TTF analyses the construct of the code, identifies the programming language it is written in and using the matrix picks up the matching NSL equivalent of every keyword, operator, symbol, function or combinations thereof.

Technology Re-translation Framework (TRF): An innovative framework that NSL brings about is the ability to convert any solution constructed in NSL into any programming language. TRF is based on the same matrix-based approach on which TTF is based upon. The TRF understands the NSL construct and identifies the matching keyword and functions in the programming languages, thereby constructing the code in any programming language selected by the user.
a. Translation 360° Any To Any (A2A): The TRF, together with TTF, completes a full life cycle of the regime called 360° Any to Any (“A2A”), using which one has the ability to convert the solution in any programming language or any natural language to any other programming language or natural language. Just like meaning is constant and can be expressed across various natural languages, the solution logic can be expressed in any programming or natural language substrate. In NSL, solutions are a special class of information known as prescriptive information. The Prescriptive information expressed in a potentiality state, when acted upon becomes a reality and that prescription is done at a class level and when their members arrive, the reality happens at a transaction level. Any member arriving at the defined classes will behave the same way as the class. These are replacing the traditional processes. The events that arrive select from the potentiality text and when that happens, the whole thing becomes capable of being expressed in natural language format. In other words, there is a certain differentiation cycle NSL adheres to, where differentiations are expressed appropriately and contextually, and such differentiations as per NSL are expressible in any substrate. The NSL, through TTF and TRF can extract the solution logic embedded in each of the substrate and treating them the same way as it is treated in the original substrate. This A2A has been tested with the principle that the inputs being the same, the outputs are same in every solution built in various programming or natural languages. In short, the NSL construct acts as a Hub and other programming languages are like spokes. For example, if a programming language has to be translated to another programming language, the programming languages have to touch the HUB called NSL and then branch out as another programming language.

Stakeholder Engagement Centre (SEC): This is synonymous with user interfaces. SEC can recognize all entities that hold potentiality with respect to any agent and present the same at the user interface levels in a structured fashion. NSL recognizes relevant entities because all change units are driven by one agent or the other, clearly establishing ownership. The additional fact that all entities have the decision and information rights over them clearly specified, makes entity distribution across agents and navigation easy. SEC provides highly customized interfaces to stakeholders that is contextually driven. It provides a distributed and secure environment to each stakeholder. It adjusts itself to users in a personalized way.

Mission Control Centre (MCC): A MCC pulls together those entities that are of importance in the regular course of human agents performing their responsibilities or fulfilling their needs. These entities of importance are pulled together from among the entities that pertain to agents—that is, where they have either information rights or decision rights. Distributed MCC is about the ability of the system to first automatically recognize the entities that pertain to specific agent or agents; then pick up entities of importance for the agent(s)' functions. MCC takes the contextuality of SEC to yet another level. It adjusts itself contextually to ‘time’ or ‘events’. It brings to the fore all the relevant ‘BETs’ that drive the pertinent SSA cycles better. Among other things, informational or actionable measures are also made available contextually.

Everything is a Binary Entity (BET): In NSL, all things distinct and discrete are called entities. These entities are either unique (differentiated distinct entities) or identical (undifferentiated distinct entities). Unique entities are represented by words and identical entities are represented by numbers. The term Binary Entity (BET) connotes all discrete entities being in a state of potentiality or reality. As the word ‘BIT’ (Binary Digit) exists in the context of information in general, a ‘BET’ is a subset of a ‘BIT’ that exists in the context of a solution. Each BET is at a differentiated state on account of a lot of BITs of information that it carries and is frozen. Events arrive only at the BITs level. Since all bits are frozen, they lose the ability to be loosely coupled. For example, a pen is made up of many atoms. When the pen is frozen, one cannot plug out an atom and call it as a ‘pen excluding that atom’.

BETs at all Vantage points: A solution can be broken down into its components. As it is broken down, one can traverse through various Vantage points—at a Chapter level, at a Paragraph level, at an Extended Combinatorial Entity States level, at Change Units level, at Entities level, and at Attributes level. One important thing to remember from NSL point of view, is to view anything distinct as a BET. A BET status is accorded to Attributes, General Entities, Agents, and combinations thereof, Change Units, Collection of Change Units, Solution Ecosystem and to all higher-level collection of BETs. At every Vantage point, NSL treats each BET as a binary variable. The solution ecosystem is set up in such a way that potentialities and their memberships are laid out to enable events to find their way and tag themselves to their members. BETs exist in different substrates and every representation of BET in every substrate will have a unique identity. Examples: (a) an image or a video representing an entity will have its identity. Each representation may consume its own quantum of BITs in the form of BETs. (b) An end-to-end telecom billing solution is a BET. The Change Units which make up this Telecom Solution such as Customer Profiling, Address Verification, Bill Generation etc., are also BETs, and this continues down to the last attribute which is attached to every entity.

BIT and BET: A ‘BET’ (Binary Entity) is to solutions, what a BIT (Binary Digit) is to information. By extension, a BET is to ‘Solutions Theory’, what a BIT is to Information Theory. Information, in general, is measured by the number of ‘BITs’. What it essentially means is that every bit is in a binary state of being a ‘0’ or a ‘1’. Information arises only when the position of every bit is determined or, in a sense, differentiated. To count the size of information, one ignores the state of every bit, but only counts the number of bits contained within the information. Similarly, in a solution ecosystem, one could count the number of ‘BETs’ by ignoring the state of each BET. ‘BITs’ and ‘BETs’ are highly correlated concepts only differentiated by contextuality—one pertaining to information in general and the other pertaining to solutions in general. A ‘BET’ is like a ‘Primordial Entity’ which is devoid of any differentiations. The ‘BET’ is represented in FIG. 1. When every entity attains that state, all entities become identical and countable. For example, a one GB video would ignore the states of the BITS. All that matters is the number of bits that make up the video. Similarly, in NSL, the quantification of solutions is done by counting the number of BETS that make up the solution. BET represents a unit of value and a central to agent system, which provides for all change continuities being converted to controlled and directed discrete states like picture frames in a video. All BETs in the ecosystem system are quantifiable and all BETs in the ecosystem system are connected with each other based on nearest neighbor principles. All BET events being driven by qualified agents with the internals of any BET type being exactly the same, while contextually providing for any permitted type. BET accommodates both trigger property CES and non-trigger property CES. BET entertains events at individual and tightly joined entity levels. Multiple verticals belonging to either embedded BETs or nested BETs. Multiple horizontals being tagged to evolutionary taxonomy-based hierarchy, where hierarchy arises out of three dimensional networked nodal structures serving as foundational elements for pathways of generalisation-and-differentiation, which is being laid with the directionality of the pathway being contextual and the direction in which the objective is headed defining the differentiation direction. When the direction reverses contextually, the generalization end becomes the differentiation end. Nodal structures assume hierarchical structure based on defined pathways.

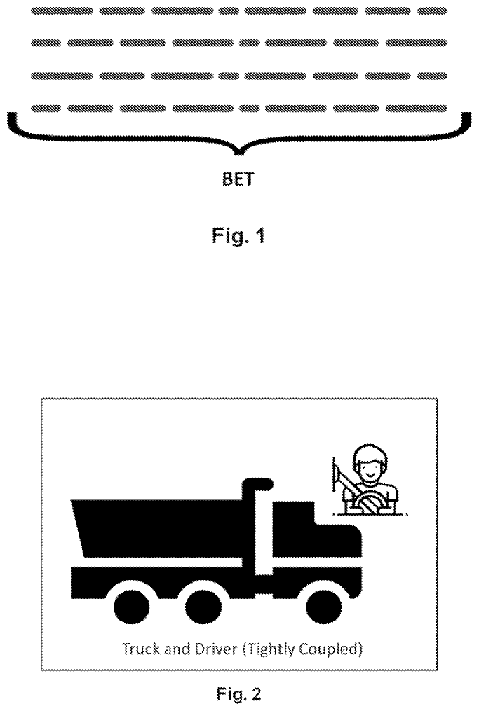

Tightly Coupled Entities: Agents and general entities come together contextually to produce an intended change. Often, a combination of entities may arrive or depart together. Tightly coupled entities are those that act together. Example of tightly coupled entities: a truck and a driver arrive and depart together. Tightly coupled entities cannot act independently. In any change, where tightly coupled entities are participating, they must participate together. There cannot be any occasion when one of them is missing from the action. Instances of multiple entities participating in the change together are called tightly joined entities. For example, while performing a surgery, the doctors come in specified suits, gloves, mask and so on. Example of tightly coupled entities is represented in FIG. 2.

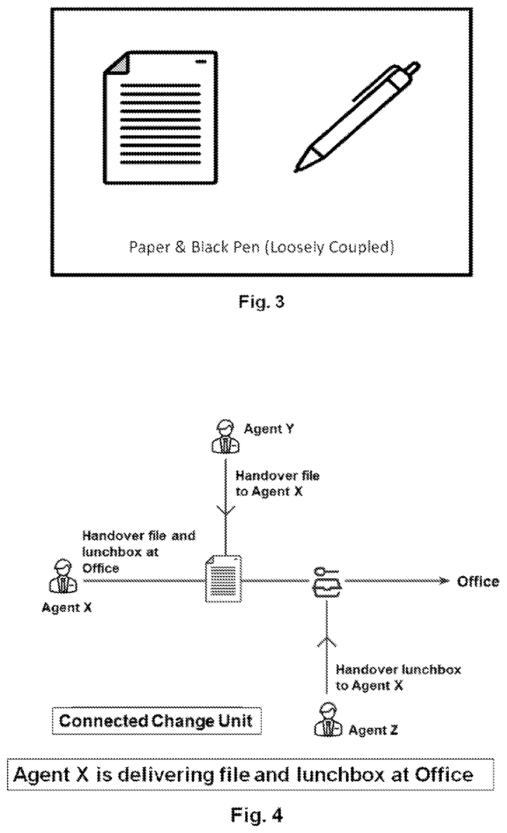

Loosely Coupled Entities: Loosely coupled entities are unitary entities that arrive separately to participate in a change. Example of loosely coupled entities: a pen and a paper can arrive separately in the change unit. They are loosely coupled entities; they can arrive independently. Example of loosely coupled entities is represented in FIG. 3.

Substitute Entities: Substitution of entities can happen at (a) Independent entity level (b) Attribute level (c) CU level. The word ‘substitution’ is used only in cases where the ensuing state will generate the same set of events. If the transformational pathways are different, then it cannot be called a substitute entity. When substitution happens, the nearest neighbor should not notice the difference. The effects of the trigger states should remain the same. For example, A pencil can act as substitute for a Pen in the context of writing. The system plays out dynamically that the recipient shall not even notice which entity participated in the change—whether it is the original entity or the substitute entity.

Cloned Entities: As a part of solutions, sometimes, there is a need to make copies of soft assets without differentiating one from another. Such identical non differentiated soft assets are called cloned entities. For example, an organization's policy has to be communicated to all the employees through an email and each copy of the email is identical and undifferentiated. The NSL system provides for entity cloning as a part of the solution design. Amongst the cloned entities, one will not be able to determine which is an original entity and which is a cloned entity.

Negative Entities: It is generally the case that Change Drivers (CDs) that matter is a part of a trigger CES. But in some rare instances, what matters may be the absence of an entity rather than the presence of an entity. For example, to complete a delivery order it may be important that ‘rain’ as an entity is not present. This example is represented in FIG. 14. NSL provides for n-Potentialities and n-Realities, that provide an alternative way of dealing with it at attribute levels.

Representational Entities: In NSL, all things are contextual and relative in nature. Whatever entity that sits in the physical layer of a CU (as a CD) that is contextually relevant becomes the ‘real entity’. All other entities that have an ‘equality relationship’ with it will become representational entities. In other words, what is ‘real or representational’ is based on contextuality and is relative in nature. To determine what is a real entity or a representational entity, no substrate has primacy over the other. A change unit can have change drivers (CDs) from different substrates at the same time. For example, a Message can be one CD, a ‘physical pen’ can be another CD, and an ‘image’ can be yet another CD, each belonging to different substrates and yet sitting in the same CU.

Truth Values: Though the representational entities purportedly represent ‘real entities’ or ‘other representational entities’, the truth values may vary due to the uncertainty inherent in nature or the understanding, motivation, or intentions of human agents. For example, it may be represented that ‘X’ is at place ‘Y’ but that may or may not be a correct statement. If it is correct, the statement is ‘true’ and if it is incorrect, the statement is ‘false’.

Physical Reality: All entities—real, perceptual, and informational entities—exist ‘physically’ in the physical world. While it is intuitive to come to that conclusion with respect to real entities, even perceptual and informational entities exist in physical reality—space and time. The fact that they derive their value from being representational entities does not change the character of those also being physical.

Lapse Time: When a trigger state is attained in a statement of intent, it precipitates one or more changes in one or more statements of intent, including its own statement of intent. All changes take time, which. is called the ‘lapse time’. Whether the change is driven by human agents or machine agents, lapse time is always involved. In some instances, such changes can happen in a fraction of seconds, and in other instances the length of time can be as high as hours or even days. All the entities involved in interactions producing the required change would be occupied during the lapse time and will become available for being involved in any other trigger only after the completion of the previous action.

Vantage Points: Each basic entity exists in a binary state at an individual level. Entities also combine to form combinatorial entities. Vantage points refer to the relative positions from which one may view entities. If one views an entity holistically from a higher vantage point—a higher rung of the differentiating ladder that consists of all its subsets-the connected entity count would be quite high. On the contrary, if one views an entity that is at a lower vantage point—a lower rung of the differentiating ladder—the connected entity count would be much lower. For example, imagine a higher vantage point ‘A’ from which one can view in the direction of differentiation. ‘A’ could have a differentiated subset ‘A-B’. If that combines with ‘C’, one can have a second level more differentiated subset ‘A-B-C’. ‘A-B’ encompasses only subset ‘A-B-C’. ‘A-B’ has fewer connected entities in the direction of differentiation as compared to ‘A’. Another way of putting it is that higher vantage point entities carry more information than lower vantage point entities. Further, the direction of differentiation is from the top to the bottom and all entities are connected through their nearest neighbors. The entities are loosely coupled but are unitary in nature, which means that the events can arrive at individual BET levels but constantly change the collective states. Higher vantage points have the largest number of BETs or information. The BET structure is a Node, potentiality, and reality. Information is often ignored to reduce cognitive load. When that happens, the nearest neighbors in the direction of generalization become identical. When pen color is ignored, two pens become identical. But if the pen itself is ignored, only the BET/node remains. That is where the number of BETs being higher at higher vantage points comes in. How much information should be ignored is based on optimization principles. For example, a CEO of an Organization ignores most of the information and counts only the number of transactions and revenues though he has access to all the information.

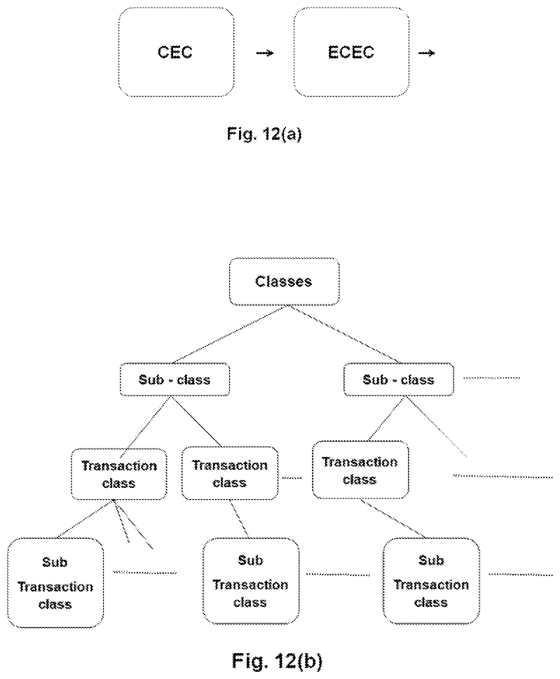

Vantage Point Switching: Differentiations proceed horizontally through connected CES and ECES. An example of horizontal differentiation is represented in FIG. 12a. Differentiations can also happen vertically through the creation of classes, sub-classes, and any number of sub-sub classes all the way down to transactional classes or even sub-transactional classes. An example of the vertical differentiation is represented in FIG. 12b. When one descends down the vertical differentiation tree, the extent of differentiations keeps increasing. For ‘adjudication’ or ‘optimal differentiations’, the solution designer may leave room for the transaction classes to switch between higher level or lower-level differentiations to apply as the situation warrants. As one subtracts or ignores more information, one moves to a higher vantage point. For example, an application for pizza delivery is created. If the information called “Pizza” is ignored, it becomes food delivery. If the information called “Food” is ignored, then it becomes delivery. Here, the information exists, but at higher vantage points, the information is ignored.

Differentiations: In NSL, anything distinct and/or discrete that matters for the solution is an entity. This takes the form of a ‘BET’ when animated. In case of entities, events flow only one way that is, from the entity to the brain or system. But there is no mechanism for a feedback or flow back of events. A BET structure incorporates the feedback flow. If every entity is informational (because it is distinct and/or discrete), every event that changes its status (from potentiality to reality or vice versa) is also informational. Every entity is also a class. A class arises when one can limit the possibility against many. ‘Pen’ is a class because the only member it entertains is a pen. One cannot fit a paperweight or a pencil into that class. A class differentiates a one or a few against many. A set of classes differentiate to more granular levels. A pen is a differentiated class. When combined with another class called ‘red’, it is even more differentiated. If yet another class such as ‘deep’ is combined with it, it is further differentiated. All solutions are optimally differentiated set of classes. There are different synonymous words that one can use to describe these, such as ‘rules’, ‘algorithms’ and ‘laws.’ If one adds a class, a solution is more differentiated and if one deletes a class the solution is less differentiated. Since all classes adhere to nearest neighbor principles, the directionality of differentiation operates the following way, The preceding set is ABC and the subsequent set is ABCD. If the class ‘D’ is ignored, then it merges with ABC. But if ABCD is ignored as a differentiating set, but its existence is still considered, ignoring the presence of ‘D’ results in there being two ABCs—the preceding and the succeeding set.

CU as A Local Network of Nodes: There are innumerable species and organisms on earth. But all those species, without exception, are made up of ‘cells’. The fundamental building block of all organisms is a ‘cell’. Similarly, the fundamental unit of any solution is a ‘change unit’ (CU). All change units are made up of a ‘local network of nodes. A node represents the identification of the existence of an entity. The connection of nodes is expressed through ‘transformation lines’ (TL) with arrows (or equivalents) showing the direction of differentiation between nodes. Nodes are differentiated by unique or identical entities hanging to them. A CU begins with the ‘principal node,’ which is differentiated by ‘statements of intent’ attached to them. FIG. 24 represents a CU as a local network of nodes. At the initial level CUs have nodes that relate to ‘independent entities’ differentiating the principal node. There is no theoretical limit on the number of nodes at the initial level. There can be any number of levels of attributes and that every level can have any number of attributes. There are four levels of nodes i.e., known as FOUR LAYERED CUs. The nature of this local network of entities is one that it has a property to cause an event in one or more local network of nodes on the trigger condition being met. This property is referred to as the driver of change drivers (DCDs). It is also known as ‘change drivers’ in NSL. A triggered state of a local network can drive changes in any of the layers of any local network of nodes (say, the information layer) including itself.

Further, NSL is driven by network of nodes to which BETs are connected in an unbroken chain. Boxed or monolithic structures must be avoided. Structure of BETs in building solutions proceeds in the manner as follows: Every BET hangs to an implied node. A BET is anything that matters for the solution, including CES and ECES, so long as it is worthy of being treated as free standing. Example: A, B, C and D are all BETs—so is the CES ‘ABCD’. Each BET has its own properties causing events when triggered; the non-trigger CES causes ‘null’ events. An unbroken network of nodes is formed when nodes are connected to the nearest nodes following the nearest neighbor principles. CU nodes are connected to each other all the way up to the GSI node. Those GSI nodes are connected to each other at higher aggregate functions level based on the IRDR at that level. All the transactional CU nodes hang to their respective solution nodes. A CU node is the principal node of that CU representing the combinatorial entity states (CES) of that CU. Each combinatorial entity state node is made up of nodes of each non-trigger node all the way up to trigger CES. Each CES node is made up of loosely coupled and at the same time unitary CES. Potentiality (anticipated) BETs hang to the respective nodes. Reality (experienced or perceived) BETs, in turn, hang to the potentiality BETs in the dimension of ‘reality’ or, so to say, as members of potentiality BETs. For visualization, imagine potentiality BETs are those that first occur in mind in anticipation of what is desired. Reality BETs or member BETs are those that match the anticipated potentiality BETs in the real world.

Classification of CUs: CUs are broadly classified into the following:
a. Horizontal Change Units: These are change units where interactions happen horizontally, and the resultant trigger moves from one CU to another Horizontal CU. In a practical scenario, every solution consists of multiple Horizontal Change Units. Sequential, Alternative, and Parallel CUs belong to this class.
b. Vertical Change Units: These are change units within change units where a higher-level change unit triggers a lower-level change unit. Embedded and Nested CUs belong to this class.
c. Multi-Layered Change Units: All the layers and Sub-layers of CUs belong to this class.
d. Aggregate Change Units: Those CUs that are hitherto referred to as ordinate and super-ordinate CUs belong here. These essentially feed on information inputs and transactional aggregates of CUs at lower vantage points. For example, the aggregate of a CU of a supervisor, feeds on the transactions generated by the delivery leaders reporting to that person.

Basic Change Units: These are the fundamental units where all the transactional interactions between entities and the resultant trigger states happen. Basic CUs exist and operate the same way irrespective of the vantage points at which they exist. At higher vantage points, the information layer tends to carry a lot more information.

Sequential Change Units: These are the CUs that the Basic CU can influence through one or more events when triggered. Sequential CU utilizes ‘AND’ operator principles. The CES states are maintained within the Basic CU as well as sequential CUs to form ECES. For example, to prepare a cup of tea, one needs to put the tea bag in a cup, fill the kettle with water, boil the water in the kettle, pour boiled water into the cup and add sugar to the cup. These are the sequential steps in the preparation of tea.

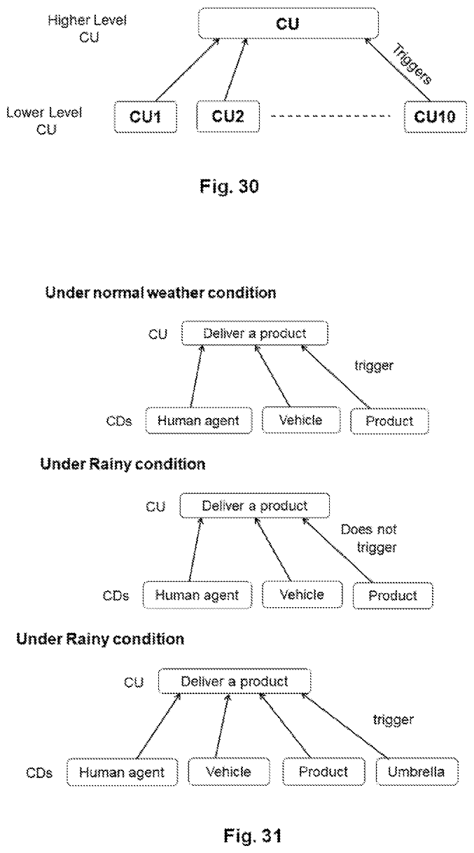

Embedded Change Units (eCUs): These are the CUS within a CU. Embedded Change Units are part of vertical differentiation. They trigger only on the trigger of the higher-level CU—either the basic CU above or the Embedded Change Units immediately above. When there are several levels of Embedded Change Units, they are referred to as Primary, Secondary, Tertiary, and, so on, similar to the way levels of attributes are defined. At every Embedded Change Unit level there can be any number of connected Embedded Change Units. There are two kinds of Embedded Change Units—1. Sub CUs 2. Recursive CUs. Whether it is ‘recursive or sub-CU’, the nature of the function is just the same. Embedded CUs break up the function of the higher-level CU into several steps through connected smaller CUs. For example, the higher-level CU could be dealing with moving from one end of the city to the other end. Embedded CUs could break up the function into crossing of 10 connected streets till one exits the city. Entry into the city triggers the Embedded CUs of CU1 and exit from the last street triggers the higher-level CU, placing the ‘exit from the city’ event at higher level CU2. In other words, the GSI of the Embedded CUs triggers the higher-level CU, causing it to generate an event in the next CU. There can be any number of layers in Embedded CUs. The GSI of the lower-level CUs triggers the higher-level CU is represented in FIG. 30.

Sub CUs: When a CU is segmented into several underlying smaller CUs, each of these CUs become Sub CUs. For example, an activity (a basic CU) that takes ten minutes can be broken into several smaller change units made up of minute or two segments called tasks. In the absence of a sub-CU, a basic CU (CU1) could place the output in a sequential CU (CU2). However, the solution designer has a choice to ensure that the activity is driven methodically through steps laid down in smaller CUs (Sub CUs) connected with it. He could introduce one or more connected Sub CUs. When the basic CU (CU1) triggers, it relies on the Sub CU set sitting in the primary Embedded CU level. The Embedded CU set has its own Embedded GSI. On triggering that GSI, an event would now be caused in the basic CU2, just as it would have happened if the Embedded CUs did not exist. This process could occur to any depth with respect to more levels (secondary, tertiary, etc.) of Embedded CUs being present. Secondary CU services the respective individual CU in the primary level (each task) through its GSI. That is, Sub CU1 (task 1) at the primary level is serviced by the secondary level GSI and causes an event in Sub CU2 (task 2) at the primary level. This process can continue to any number of levels. NSL provides the ability for each task to be serviced by any number of sub-tasks at the secondary level. Each of the several tasks at primary level can have its own secondary levels individually, with any number of tasks that can be accommodated at each of those secondary levels. This is how the differentiation tree built through the Embedded CUs branches out. At the principal level, there is no difference between the way differentiation happen with respect to attributes and the differentiations as caused by Embedded CUs.

Recursive CUs: There are no fundamental differences between Recursive CUs and Sub-CUs. Both are subservient to the basic CUs or higher levels of either Recursive CUs or Sub CUs. The main difference between them is that Recursive CUs deal with recurrences and, therefore, numbers and mathematical constructs; Sub CUs involve unique entities and unique transformations. For example, each of the series of tasks embedded in an activity would be unique in Sub CU instances. Washing a dish involves tasks such as bringing the unwashed dish from the dining table to the sink, opening the tap, cleaning the sponge wet, applying soap to the sponge, cleaning the dish, etc. On the contrary, Recursive CUs involve recurrences in space and time. In the case of Sub CUs, with respect to washing a dish, The Basic CU1 would have triggered, and all the tasks are performed at the level of Embedded Sub CUs. The outcome would be that the GSI at the level of Sub CUs place the washed dish at the Basic CU2 as an event it has caused. This would have happened anyway (Basic CU1 placing the clean dish in CU2) if the solution designer chose not to impose a standard operating procedure in the system by way of primary level tasks. In case the solution required is that the dish has to be washed ten times before it is placed in the Basic CU2, Recursive CUs are important. The tasks performed are not unique but repetitive. The Recursive CU1 will place in the next Recursive CU the dish that is washed once, the second one will place in the third the dish washed twice, and so on. The last Recursive CU, which is also the GSI where the tenth wash has happened, will place the dish that is washed ten times in the Basic CU2. The change drivers (CDs) in each of these Recursive CUs would be the same agent and the same dish with the attribute values of the dish changing progressively. In the first Recursive CU, the dish would have an attribute ‘washed 0’, in the second ‘washed 1’, in the third ‘washed 2’, and so on.

Nested CUs (nCUs): Inherent in every change unit is a playout of a fractal-like SSA cycle. In the presence of agents, senses detect things in the environment, the mind makes an appropriate selection from several possibilities; and the body provides the requisite energy to complete the change cycle. Nested CUs are additional layers of CUs added to a Basic CU to give the power of more information at the transaction level. It is like an SSA cycle within an SSA cycle of the Basic CU. NSL does not have a limit on the number of layers of SSAs or change units. Depending on the desired solution, the solution designer has the flexibility to add as many granular SSAs as required, within a basic change unit Nested CUs can cause one or more events in one or more CUs including the Basic CU that they belong to or their higher-level Nested CUs. For example, a nested CU can convert the ‘reality of Basic CU intent’ to potentiality and thus disable it under certain circumstances. Events that Nested CUs cause are always in the context of the Basic CU to which they are attached, while their trigger could be independent of the trigger of the Basic CU or a higher-level Nested CU. The CDs of nested CUs could be independent entities or attributes of basic or higher-level CU entities (such as the probability of the reality state of an entity or a CES). Nested CUs can also convert ‘Conditional Potentialities’ to potentialities in one or more CUs, including themselves. For example, rain can convert a conditional potentiality of a raincoat in the basic CU to a potentiality making trigger of the Basic CU conditional to the availability of a raincoat. Nested CU is euphemistically called Nested mind. Embedded CUs breakup a coarser CU into more granular connected CUs. On the contrary, nested CUs apply greater contextuality to the contextuality existing at the higher-level CU. For example, the higher-level CU contextuality could be to deliver a product provided there are CDs such as a human agent, vehicle, and the product. The implied condition at the higher-level CU is that the weather is normal. There could be nested CU created that brings in the contextuality of ‘rain’. The higher-level CU continues to function as though the nested CU did not exist till such time it did not rain. On the condition of the rain being fulfilled, the behaviour of the higher level could change. It could result in stopping the trigger of the higher-level CU and abandoning the transaction or it could create a conditional potentiality of introducing an additional CD such as an umbrella. This example is represented in FIG. 31. If the probability of CD arrival is low, that context could influence the behaviour of the higher-level CU. For example, if the probability of the doctor's arrival is quite low, the patient can be asked to come later. There can be one or more connected nested CUs. There can also be any number of levels of nested CUs—contextualities within contextualities.

Entangled CUs: This construct is introduced in NSL to address frequently encountered mathematical expressions such as formulas and equations. Entangled CUs always coexist with properties of being able to influence each other conditionally. The behaviour of entangled CUs is synonymous with entangled particles that determine the value of their counterparts when their values are determined. In other words, there is an inextricable dependency on each other.
a. Formulas: These are defined as ‘general constructs of relationships between quantities.’ These qualify to be viewed as supersets. For example, ‘A’ is more than ‘B.’ These are expressions that contain the possibility of equations but could extend to other general formulas.
b. Equations: These are defined as ‘statements that assert the equality of two expressions.’ This is similar to the value of a ‘subject’ being same as an ‘object’ with a special property of being able to determine the values of each other unlike a normal sentence where the ‘subject’ determines the behaviour or the ‘object’. This should be seen in the context of mathematics where there is a place for only identical entities and their relationships with respect to sets that they form.

Connected CUs: All CUs and entities in the ecosystem are related to each other. This is similar to how humans have relatives in the form of first, second, or third cousins. Connected CUs are those that belong to the ecosystem of a particular GSI. There can be several connected GSIs, but when one of them gets fulfilled, the other connected GSIs disappear, based on the selection done by events. For example, to fulfil a customer's global intent of carrying a file and a lunchbox to reach a destination, two agents can supply those entities (file and lunchbox) into the connected CU system. The example of Connected CUs is represented in FIG. 4.

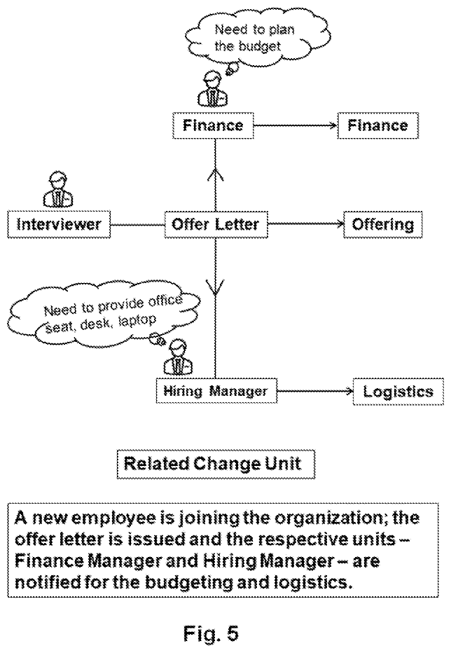

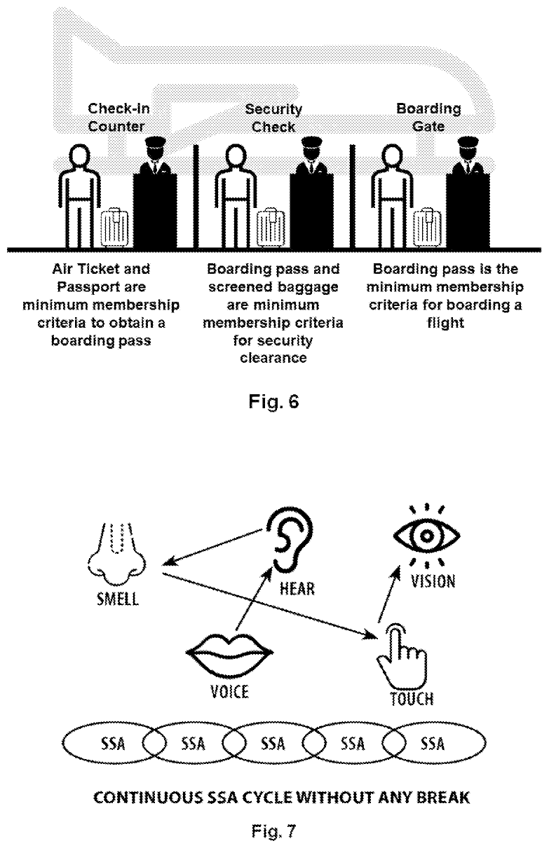

Related Entities and CUs: The term ‘related entities’ refers to all entities that belong to the solution ecosystem, directly or indirectly. Even the entities that arrive into and exit from the solution ecosystem are included. These extend to all classes and all transactions. Related CUs are those which may not be connected to the same global intent. A connected CU ecosystem is, in some ways, a subset of a related CU ecosystem. Example of related CU system: When a final offer letter is made to the candidate, both the Finance Manager and Hiring Manager are notified. The Finance Manager must do the budgeting, the Hiring Manager must arrange for logistics for the new joiner, and the interviewer must move ahead with the interviewing formalities. The example of related CU is represented in FIG. 5.

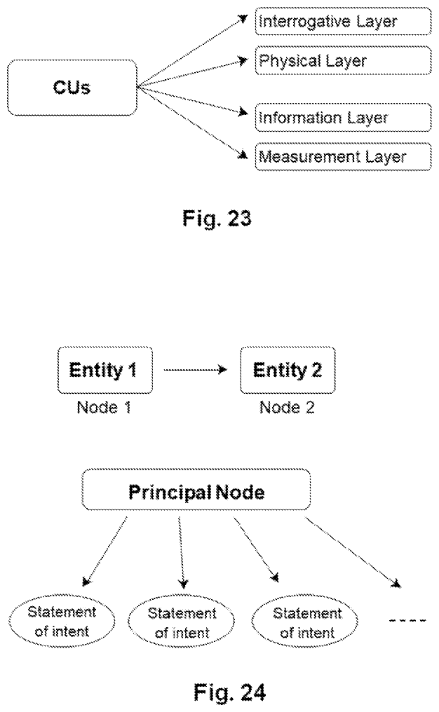

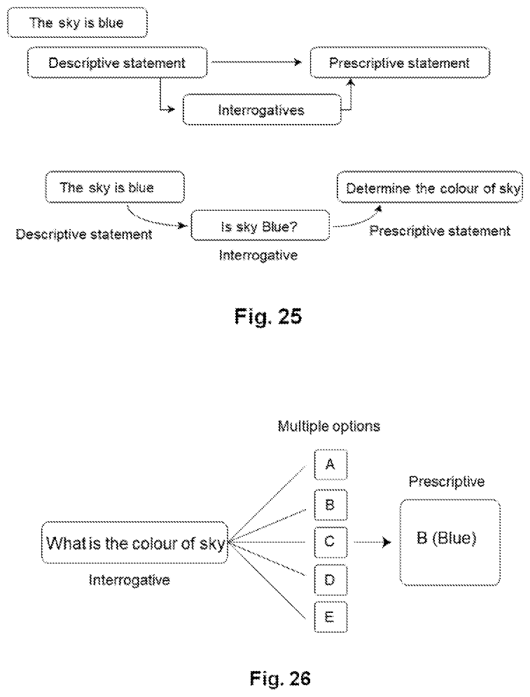

Four Layered CUs: Everyone has learnt from the way the world works principles as established by 400 years of science. In the presence of agents there are some principles that come to the fore.
i. Agents are constantly seeking solutions for their survival.
ii. All solutions arise out of controlled and directed change.
iii. Agents are driven by purpose as controlled by SSA cycles.
iv. In the case of human agents they are designed through the evolutionary process. In the case of machine agents they are designed by human agents to beat complexities and infinities.
v. Agent systems are driven by discrete/distinct states out of necessity.
vi. Discrete states pertain to objects, their attributes, and any kind of change.
vii. Any change is driven by cause and effect principles as experienced by Change Units, with SSA cycles being inherent to them.
viii. Any discrete/distinct state that is unique can be represented by natural language.
ix. Any discrete/distinct state that is identical can be represented by a number.
   In NSL, a CU is a local network of nodes. The principal node represents the local network in the form of an ‘LSI’ or a CU name. There are two types of layers in the local network of nodes—Physical and Informational. There are two more layers implied or inherent in each of the local network of nodes. One of them is the ‘interrogative layer’. This represents ignorant agent(s) posing questions and seeking answers from the agent(s) sitting in a CU(s) that are knowledgeable. To perform functions within a CU, it is a given that the agents in a CU are knowledgeable. Depending on the Information and Decision Rights of the agents posing questions (interrogatives) knowledgeable agents are obliged to provide or not provide answers. The other implied layer is the ‘measurement layer’ (referred to as exclamatory sentences in natural languages). Measurements have the following properties: (i) They are the highlighted portions of the physical or information layers. (ii) Typically, the highlighted portions are further differentiated by attribute values to bring greater focus to things. For example, if the highlighted portion is the ‘delivery of a product to a customer’, the differentiating attribute could be delivering the product in less than 30 minutes or more than 30 minutes. (iii) The third property of a measure is a view taken by an agent on the status of the highlighted portion with given differentiated attributes. These are referred to as norms. For example, a product delivered in less than 30 minutes is good and more than that is bad. This example is represented in FIG. 22. NSL considers CUs to be four layered and the same is represented in FIG. 23. The four layers of CUs are as follows:
1. Interrogative Layer: This layer is latent and is invoked when ‘ignorant agents’ pose the questions. The ignorant agents are provided with answers by empowered agents possessed with information rights and decision rights (IRDR) sitting in the respective CUs.
2. Physical Layer: It is same as imperative or prescriptive statements in natural languages.
3. Information Layer: It is same as descriptive or declarative statements in natural languages.
4. Measurement Layer: It is same as exclamatory statements in natural languages.
   Interrogatives help converting descriptive statements to prescriptive statements. There could be a descriptive statement such as ‘the sky is blue’. This could be converted into a prescriptive statement by posing the question or interrogative ‘is the sky blue?’. The qualified members of this prescriptive statement are in a binary state of being blue or not being blue (‘yes’ or ‘no’). FIG. 25 represents interrogatives helping convert descriptive statements to prescriptive statements in a binary state. When there are several options, the interrogative statement generated ‘prescriptive statement’ takes the form of multiple-choice questions. For example, ‘what color is the sky?’, the options provided would be A, B, C, D, and E with the ‘blue’ being one among them. Only blue qualifies to be a member in it. FIG. 26 represents interrogatives helping convert descriptive statements to prescriptive statements with multiple options.

Multi-Layered CUs: Multi-layered CUs, also, interchangeably, referred to as multi-NSL-stacked CUs, extend the capabilities of CUs from the four layers (functional, informational, UI, and measurement layers) to other layers that provide depth and breadth to the functionality of CUs. In the context of multi-layered or multi-NSL-stacked CUs, a layer or an NSL stack is a set or a system of attributes having some common properties that bind them. An NSL stack for a local statement of intent (a CU) is linked or integrated with said local statement of intent (said CU) to generate data, where the generated data is to: (a) provide a predefined functionality to said local statement of intent (said CU); and/or (b) provide a predefined functionality to one or more other local statements of intent (other CUs); and/or (c) perform data analytics. Examples of layers or stacks include, but not restricted to, the following:
A. Languages Layer or Language Stack: NSL not only provides the ability to switch from one natural language to another, but also provides the ability to personalize the natural language at every agent level. Multiple users can develop and transact in any language of their choice simultaneously. This is made to happen through the Language Equivalence Matrix, where each language is at a given column and the unique BET ids preserve the functional integrity. The Language Equivalence Matrix is a database that stores language equivalence across multiple natural languages. For example, when the information displayed, while building or execution of the solution, is in a first natural language, a user may provide an input to select a second natural language which is different from the first natural language. In response to selecting the second natural language the equivalent words in the second natural language, which are equivalent of the words in the first natural language are fetched from the language equivalence database and displayed by the system.
B. Machine Learning (ML) Layer or ML stack: The CES sitting in this layer is different from the functional layer. The CES in this layer absorbs information from the transactions and continuously reassess the CES for optimal efficiencies and insert themselves into the main stray functional layer on some conditions being fulfilled. One of the extreme cases is that it will delete the CU itself when it is no longer serving the purpose it was originally intended to serve. This is akin to cells in a biological system committing suicide under certain circumstances. In an example, the machine learning stack is linked to a local statement of intent to generate data which provides the predefined functionality of assessing and/or modifying and/or disregarding and/or recommending at least one of user inputs and outputs, during the building or the execution of the solution. The predefined functionality of assessing and/or modifying and/or disregarding and/or recommending may also be associated with the local statements of intent, the entities, the attributes, the agents, the distinct relationships, the NSL stacks, etc. The predefined functionalities recited herein are provided based on one or more machine learning techniques and/or one or more machine leaning databases, associated with said local statement of intent and/or with one or more other local statements of intent. In Machine Learning, extracting relevant or important features and neglecting or discarding unimportant/irrelevant features, that is, feature engineering is done automatically by algorithms. In deep learning, convolutional layers are used to find relevant or important features in images or objects to the next layer to form a hierarchy of nonlinear features that grow in complexity. The final layer(s) or stack(s) use all these generated features for classification or regression depending on the problem. NSL uses various techniques of ML to continuously assess transactions and provide recommendations/insights on various aspects such as trends, efficiencies and so on based on the parameters defined by the solution designer.
C. Blockchain Layer or blockchain stack: Many aspects relating to security, integrity of information in distributed environments, issuance of non-fungible tokens (NFTs) at CU levels, personalized crypto tokens and other blockchain related features are blended with NSL constructs to provide a dramatic effect. The inventive elements can thus be enhanced multi-fold. Blockchain is a combination of Cryptographic keys, peer-to-peer network containing a shared ledger and a means of computing, to store the transactions and records of the network. NSL provides the ability to secure information within a solution using the techniques of the Ethereum Blockchain network. In an example, the blockchain stack is linked to a local statement of intent to generate data which provides the predefined functionality of: securing of at least one of user inputs and outputs, during the building or the execution of the solution, based on one or more blockchain techniques, for said local statement of intent and/or for one or more other local statements of intent; and/or issuing of non-fungible tokens and/or personalized tokens for at least one of user inputs and outputs, during the building or the execution of the solution, based on one or more blockchain techniques, for said local statement of intent and/or for one or more other local statements of intent.
D. BET Analytics Layer or analytics stack: Akin to the measurement layer, this layer can add to the NSL special features and advanced features primarily driven by statistical functions. As a rule, whenever there is additional information or class, several pathways of potentiality are created. For example, consider a set of 4 classes—ABCD. Assume adding an additional class E creating a new set—ABCDE. In the first set of BETs, there are 2\hat{ }4 CES states (16) and in the second CES set, there are 2\hat{ }5 (32 ) states. It means that an addition of one BET or class has created 16 additional states or pathways. Analytics is about dealing with this additional information and choosing information elements or pathways that matter. Generating all possible pathways on account of additional information and choosing the ones that really matter is called insights. It is observed that all the insights should lead to actions now or later adding a significant value. Action can happen at transparent levels as captured by CES or ECES. But insights can also lead to best practices or actions within opaque trigger states as performed by agents. For example, a delivery person may be delivering by walking to a place or by the use of a bike. The insight could be that it is more efficient to deliver using a bike. If the solution in general has not specified the way, these actions are opaque to the system as it only deals with things from one frame to another. Between the frames actions are not captured at a system level, rendering them to be opaque. In an example, the analytics stack is linked to a local statement of intent to generate data which provides the predefined functionality of data analytics of at least one of user inputs and outputs, during the building or the execution of the solution, based on one or more statistical functions, for said local statement of intent and/or for one or more other local statements of intent. The data analytics performed by the analytics stack is as described above. Further, the analytics stack can perform any kind of data analytics based on the information gathered for building and executing the solution.
E. Knowledge Layer or knowledge stack: While a CU demands a certain knowledge of the function for an agent to perform, the real knowledge of specific agents may vary substantially. With the knowledge layer added, the knowledge levels of agents can be captured at the level of each CU and the same can also be influenced at a systemic level. This is a powerful tool.
   The knowledge layer has following features
Knowledge base (KB): The Knowledge layer shall have a knowledge base which deals with real facts of the world and updated by the knowledge level of agents that are captured with each transaction. It is a mixture of sentences which are explained in knowledge representation language.
Inference Engine (IE): It is a knowledge-based system engine used to infer new knowledge in the system.
Actions performed by an agent: Inference System is used when one wants to update some information (sentences) in Knowledge Base and to know the already present information. This mechanism is done by TELL and ASK operations. They include inference that is, producing new sentences from the old sentences. Inference must accept needs when one asks a question to KB and answer should follow from what has been told to KB. Agent also has a KB, which initially has some background knowledge.
In an example, the knowledge stack is linked to a local statement of intent to generate data which provides the predefined functionality of: determining the knowledge score of the agents associated with said local statement of intent or one or more other local statements of intent based on a predefined set of questions and answers, during the building or the execution of the solution; and storing the knowledge score of the agents in a knowledge database. Further, in an example, a prompt is generated by the system to change one or more agents of said local statement of intent or one or more other local statements of intent based on their respective knowledge scores.
F. Integration Layer or integration sack: NSL not only creates new solutions, but it can also integrate seamlessly with existing systems through the NSL APIs, and adapters placed at the intersection of a given CU and external system bridge levels. In an example, the integration stack is linked to a local statement of intent to generate data which provides the predefined functionality of enabling integration of one or more NSL application programming interfaces with the system during the building or the execution of the solution.
G. NSL Reserved CUs: NSL follows a cardinal rule that BETs existing in DSD will never be recreated but only cloned. The reserved BETs or cloned BETs get inserted into the system at the right CU level through a catalytic role this layer plays.
H. Internet-of-Things (IoT) Integration Layer or IoT integration stack: AI products are driven by the SSA cycles. The middle ‘S’ stands for ‘Select’ which is same as NSL intelligence layer. This layer inserts the intelligence into AI products that have sensing and actuation capabilities. IoT is about sensors implanted into machines, which offer streams of data through internet connectivity. All IoT related services inevitably follow five basic steps called create, communicate, aggregate, analyse, and act. The value of the “Act” depends on the penultimate analysis. In the SSA cycle, the ‘A’ stands for Act, which does the action based on the analysis. The analysis step is done by the Analytical Engine present in the NSL. IoT integration layer can help in aspects such as the predictive maintenance of machinery that is, anticipating machinery failures and server breakdowns in advance, better risk management, boosting operational efficiency, triggering new and enhanced products and services, robots in manufacturing, self-driving cars, retail analytics, etc. Machine learning (a subset of AI) in IoT devices helps to identify patterns and detect any faults in data collection through extremely advanced sensors. In an example, the IoT integration stack is linked to a local statement of intent to generate data which provides the predefined functionality of enabling integration of one or more IoT device interfaces, and/or one or more sensor interfaces, and/or IoT application programming interfaces, with the system during the building or the execution of the solution.
I. Metaverse Layer or metaverse stack: Elements of virtual reality, augmented reality, mixed reality and holography can be contextually placed at this layer in preparation for the shape of things to come. NSL uses three categories of virtual reality namely non-immersive virtual reality, semi-immersive virtual reality, and fully immersive virtual reality. The virtual reality technology generally consists of headsets and accessories such as controllers and motion trackers, and proprietary software or apps. Virtual reality hardware includes sensory accessories such as controllers, headsets, hand trackers, treadmills, 3D cameras, 3D mouse, optical trackers, wired gloves, motion controllers, bodysuits, and even smelling devices. The sensory accessories used in the virtual reality are part of the SSA cycle, wherein the first ‘S’ stands for ‘Sense’ in the NSL. The software includes virtual reality software development kits, visualization software, content management, game engines, social platforms, and training simulators. A few apps allow users or players without headsets to connect to the same environment and interact with one another in virtual reality. The middle ‘S’ in SSA cycle stands for ‘Select’ which is same as NSL intelligence layer, which inserts the intelligence into the products. In NSL, virtual reality is used for training, gaming, support to sales, healthcare, retail, architecture, data visualisation, marketing, and advertising etc. Augmented reality is the technology that expands our physical world, adding layers of digital information onto it. Augmented reality technology combines virtual information with the real world. The technical aspects include multimedia, 3D-modelling, real-time tracking, intelligent interaction, sensing, cloud computing and more. Its principle is to apply computer-generated virtual information, such as text, images, 3D models, music, video, etc., to the real world after simulation. In NSL, there are 4 types of augmented reality: (1) marker-less augmented reality; (2) marker-based augmented reality; (3) projection-based augmented reality; and (4) superimposition-based augmented reality. Augmented reality can be displayed on various devices namely screens, glasses, handheld devices, mobile phones, head-mounted displays. The accessories used in the augmented reality are part of the SSA cycle, wherein the first ‘S’ stands for ‘Sense’ in the NSL. The middle ‘S’ in SSA cycle stands for ‘Select’ which is same as NSL intelligence layer, which inserts the intelligence into the products. Augmented reality involves technologies like S.L.A.M. (Simultaneous Localization and Mapping), depth tracking (a sensor data calculating the distance to the objects), and other components, namely cameras and sensors, processors, projection, and reflection. In NSL, the augmented reality is used for training/education, gaming, healthcare, broadcasting, data visualisation etc.
Mixed reality depends on the evolving relationship between humans and machines. Mixed reality uses a series of cameras, sensors, and AI-enhanced technology to process data regarding space and use that information to create digitally enhanced experiences. The sensory accessories used in the mixed reality are part of the SSA cycle, wherein the first ‘S’ stands for ‘Sense’ in the NSL. The middle ‘S’ in SSA cycle stands for ‘Select’ which is same as NSL intelligence layer, which inserts the intelligence into the products. When, for instance, a user puts on a set of mixed reality glasses, the cameras and sensors in those glasses connect to a software program which collects as much information about the environment as possible, essentially creating a virtual map of the real world. Using that map, the mixed reality technology can add holographic images and content into the world using image projections. Computer processing in the cloud, advanced input sensing, and environmental perceptions allow mixed reality solutions to successfully merge the real and virtual worlds to go beyond the basics of augmented reality technology. In an example, the metaverse stack is linked to a local statement of intent to generate data which provides the predefined functionality of enabling integration of one or more virtual reality device interfaces, and/or one or more augmented reality device interfaces, and/or one or more mixed-reality device interfaces, and/or holography device interfaces, virtual reality application programming interfaces, and/or one or more augmented reality application programming interfaces, and/or one or more mixed-reality application programming interfaces, and/or holography application programming interfaces, with the system during the building or the execution of the solution.
J. Value Layer or value stack: This layer will capture the value of each BET in monetary terms. Every BET contains a value that can be expressed in monetary terms and the combination of the BETs also generate a value. The value generated at a CES state is either based on time or based on the change of state of an entity. NSL provides solution designers the ability to input the unit cost at a BET level and the method of computation of the value at a CES level. As transactions happen, the value layer performs the computation and generates instant values for transactions based on the rules set by the solution designer. Instant reports can be extracted from the system based on such computation, thereby eliminating the need for any separate financial systems or records. In an example, the value stack is linked to a local statement of intent to generate data which provides the predefined functionality of: receiving a monetary value of at least one of each entity, each attribute, and the agent, associated with said local statement of intent; and generating, based on the received monetary value, a total monetary value for at least one CES, from amongst the set of CESs, associated with said local statement of intent. The total monetary value may be generated is during the execution of the solution and upon changing of the at least one CES into the state of reality.
K. Energy Layer or energy stack: The energy layer will capture the energy consumed by each BET. Every BET contains an energy that is directed, and the combination of the BETs also requires energy. The agents that own those BETs act as catalyst to drive energy. At any vantage point, the energy consumed by each BET can be reported by NSL. In an example, the energy stack is linked to a local statement of intent to generate data which provides the predefined functionality of: determining energy and/or storage space consumed by at least one of each entity, each attribute, the agent, and each CES, associated with said local statement of intent during the building or the execution of the solution. In an example, the energy and/or storage space consumed may be determined upon changing of the respective entity, attribute, agent, and CES, into the state of reality. In an example, the energy may be determined in terms of the frequency of communication of signals, the speed of data processing, power or energy consumption by the system, etc.

Further, the network of nodes operates in the following way with respect to layers and sublayers within a CU:
Each layer is subservient to only the functional layer of the CU. Therefore, the principal node pertaining to each layer hangs directly from the principal node of the functional layer. Each layer has a one-to-one relationship directly with the functional layer. A sublayer of any particular layer will have a one-to-one correspondence with the layer above. If there are more sublayers within sub-layers, they will have corresponding relationship with the sublayer above. Each node will have a distinct id revealing its status in the nodal ecosystem of the solution. There will be an id for each CU and a corresponding id for the layer the node represents. For example, functional layer could potentially have ‘layer distinguishing id’ such as the nodal number starting with ‘F’. Blockchain layer could have a nodal number starting with ‘B’. It is up to the designers to exercise the right kind of id assignments that they find convenient. All the nodes and sub nodes will get distinguished in that manner.

Additional Layers or additional stacks: In addition to the multi layered CUs, here are a few more layers described below:
a. Substrate layer or substrate stack: The details of this layer and its properties are described later in the description herein in paragraph “Substrates and their properties”. In an example, the substrate stack is linked to a local statement of intent to generate data which provides the predefined functionality of determining a medium of at least one of user inputs and outputs, prior to the execution of the solution. In an example, the medium is at least one of text, audio, video frames, images, and gestures.
b. Security layer or security stack: Each BET at all vantage points is either an independent one or a set with its own properties. This readily lends itself to making all BETs individually and collectively highly secure. In fact, security of BETs can be personalized contextually to any desired degree. In an example, the security stack is linked to a local statement of intent to generate data which provides the predefined functionality of providing security to at least one of user inputs and outputs, during the building or the execution of the solution, based on one or more personalization techniques and/or one or more encryption techniques.
c. Privacy layer or privacy stack: The privacy of BETs can be dealt with equal ease or flexibility as ‘security’ due to the uniqueness of BET structures in the NSL paradigm. The privacy enhancing technologies used in NSL are cryptographic algorithms such as homomorphic encryption, secure multi-party computation, differential privacy, and zero-knowledge proofs etc. Data masking techniques include obfuscation, pseudonymization etc., and other machine learning and artificial intelligence algorithms such as Synthetic data generation, Federated learning etc. In an example, the privacy stack is linked to a local statement of intent to generate data which provides the predefined functionality of providing privacy to at least one of user inputs and outputs, during the building or the execution of the solution, based on one or more one or more cryptographic techniques and/or based on one or more encryption techniques.
d. Masking layer or masking stack: This is same as derecognizing information as needed for contextual optimization. For example, the CEO of a large conglomerate, while entitled for all information in the ecosystem, could choose to mask most of the transactional information such as delivery place, time and details of delivery person. The CEO captures information such as the number of transactions for a given period, maximizing the value of information with least effort. In an example, the masking stack is linked to a local statement of intent to generate data which provides the predefined functionality of masking at least one of user inputs and outputs, during the building or the execution of the solution.
e. Implied layer or implied stack: In every CU, there could be many important entities present and yet consciously not recorded in the functional layer or any other layer, that could help in drawing deep insights or ones that could lead to meaningful actions. This could be the case with respect to the intent (principal node) or with respect to each of the entity, or attribute making up a CES in a CU, or it could be with respect to a process behind trigger state. The possibilities are endless. Here are a few examples:
   i) If the intent is to write a letter, a table and a chair are likely to be involved. Those can be placed in the implied entities layer. Note that the presence of the implied entities need not be certain but probabilistic. The table or chair could be placed in the implied entity layer with an attribute value of 90% probability.
   ii) If a pen is used, it is implied that a cap or a color is associated with it.
   iii) If a CU cycle time is few milli seconds, it is implied that the agent is a machine. If a CU trigger is involved in crossing a busy street, it is implied that the traffic light was green at that time.
It may be noted that all implied entities enable the ecosystem system to access more meaningful information. With every additional information, there comes an additional opportunity for more actionable insights enriching the quality of solutions. In an example, the implied stack is linked to a local statement of intent to generate data which provides the predefined functionality of adding one or more implied entities, and/or one or more implied attributes, and/or one or more implied agents, to the said local statement of intent, during the building or the execution of the solution.
f. Voice layer or voice stack: This is the counterpart of the default text layer for user interfaces.
g. Image layer or image stack: This is a counterpart of the default text layer further supported by text.
h. Gaming layer or gaming stack: This layer attempts to make solutions a fun activity and potentially throw up solutions as by-products of gaming. In an example, the gaming stack is linked to a local statement of intent to generate data which provides the predefined functionality of enabling integration of one or more gaming application programming interfaces with the system during the building or the execution of the solution.
i. Parent-Adult-Child (PAC)/behaviour determination layer or behaviour determination stack: The discipline of psychology has transactional analysis as a well-accepted way of classifying personality traits. Each CU driven by the human agent, and consequently, the general behaviour of human agents can be classified in this manner. This helps to develop the right behavioural traits among the human agents. In an example, the behaviour determination stack is linked to a local statement of intent to generate data which provides the predefined functionality of determining behaviour of the agent associated with said local statement of intent or of one or more agents of other local statements of intent, based on analytics of user inputs, during the building or the execution of the solution.

Sublayers: As there could be any number of sub-attributes or sub-embedded CUs or sub-nested CUs, there can be any number of sublayers below the CU layers. It is for the drivers of these layers to discern the true nature of their layers through the identification of sublayers and their properties. For example,
a. Substrate layer could have sublayers such as physical, life forms, natural language, and metaphors.
b. Knowledge layer could have a learning assessment layer that assigns a given maturity of learning to leaders.
c. Natural languages and programming languages could have sublayers for each language expressed in the form of columns in the two-dimensional matrices.
d. Blockchain layer could deal with NFTs and internal crypto tokens as associated sublayers.

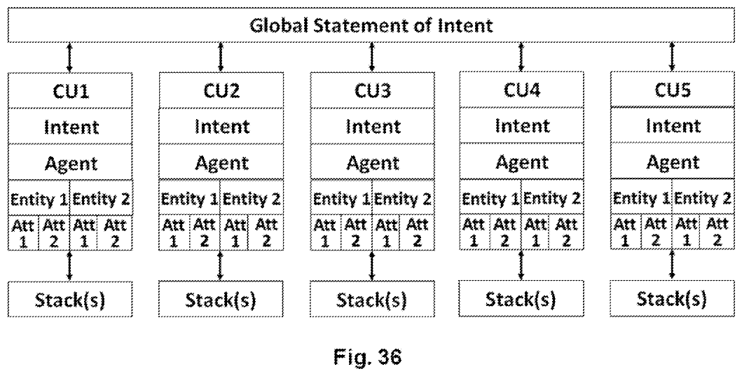

Multi-layered CUs in Solution development: Each of the multi-layered CUs described above, are in-built layers developed and integrated into the NSL system. At the time of solution design, the system provides the flexibility to the user to choose one or more multi-layered CUs based on his/her requirements for the solution that is being designed. While the description in the previous paragraphs, talk about the functionality of each multi-layered CU and what system does to achieve the functionality, below is an explanation of how a user can select a multi-layered CU and what effect it gives to his/her solution:
During the solution design or building, the system prompts to the solution designer, whether the designer needs one or more of the multi-layered CUs or multi-stacked CUs for that solution. FIG. 36 represents Multi-layered or multi-stacked CUs in NSL.
When the designer selects the language layer or the language stack for a CU, the designer can select any of the multiple natural languages displayed by the system. Based on selection of the natural language, the solution design screen and the solution transaction screen shall get converted into the selected natural language by the system.
When the designer selects the machine learning layer or the machine learning stack for a CU, the system reads and absorbs information from the transactions and continuously reassess the CES for optimal efficiencies and inserts themselves into the main stray functional layer on some conditions being fulfilled, such conditions have to be inputted by the solution designer.
When the designer selects the blockchain layer or the blockchain stack for a CU, the system provides secured information within the solution using the techniques of the Ethereum Blockchain network. The level of security can be chosen by the solution designer.
When the designer selects the analytics layer or the analytics stack for a CU, the system adds the NSL special features and advanced features primarily driven by statistical functions for analysing the features. The system prompts to the designer to choose one or more such statistical functions required for the analytics.
When the designer selects the knowledge layer or the knowledge stack for a CU, the system captures the knowledge levels of agents at the level of each CU. The system infers the knowledge of each agent at the CU level and enhances its knowledge base so as to provide real time updates. For example: “The maximum marks a student can achieve in Geography is 90% as no student in the past has got marks exceeding that”. If, in a transaction, the student marks in Geography is inputted as 92%, the knowledge base gets updated with “the maximum marks a student can achieve in Geography is 92%”.
When the designer selects the value layer or the value stack, the system receives a value of each BET in monetary terms and generates a final value for the combination of the BETs. The value generated at a CES state is either based on time or based on the change of state of an entity. This layer receives a unit cost at a BET level and computes the value at a CES level. This layer performs the computation and generates instant values for transactions based on the rules set by the solution designer as transactions happens. This layer extracts instant reports from the system based on such computation, thereby eliminating the need for any separate financial systems or records.
When the designer selects the integration layer or the integration stack for a CU, the system allows for seamless integration of the solutions with the existing systems through the NSL APIs.
When the designer selects the IoT integration layer or the IoT integration stack for a CU, the system integrates one or more IoT devices to a defined CU for prediction, identification of patterns, detection of any faults etc., based on the information generated in the transactions at run time.
When the designer selects the metaverse layer or the metaverse stack for a CU, the system receives one or more elements of virtual reality, augmented reality, mixed reality and holography, wherein these can be contextually placed at this layer in preparation for the shape of things to come.
When the designer selects the substrate layer or the substrate stack for a CU, the system has its own set of constructs to equate the truth values of entities. Audio/Video/Image are some commonly known substrates.
When the designer selects the security layer or the security stack for a CU, the system provides security to each BET at all vantage points. This readily lends itself to making all BETs individually and collectively highly secure. Security of BETs can be personalized contextually to any desired degree.
When the designer selects the privacy layer or the privacy stack for a CU, the system provides privacy to each BET in NSL based on the cryptographic algorithms.
When the designer selects the sublayers or sub-stacks, these can provide any number of sublayers below the CU layers. It is for the drivers of these layers to discern the true nature of their layers through the identification of sublayers and their properties.
When the designer selects any of the additional layers or any the additional stacks, as described above, these can provide one or more additional layers based on the user requirements in NSL while building the solutions.

Multi-layered CUs are Contextual. As NSL interprets everything in the context of solutions, the functional layer with respect to solutions becomes the default principal layer. All the layers attached to it serve as contextual additional information. Each layer is a collection of BETs, which constitutes a system having systemic properties. For example, if the layer is a language layer such as English, the additional information passes through the filter ‘English language grammar’, before that information is contextually used. Each layer has its own properties and is capable of serving as a principal layer. For example: If the primary purpose of building a solution is to provide knowledge,, the knowledge layer becomes the principal layer and all the other layers including the functional layer becomes subservient to it and serves as a system, which furnishes additional information contextually. On creation of solution in NSL, all the layers appear in the potentiality state. Based on the type of solution, those layers which can turn into reality state can be selected as the principal layer. Every layer has its own properties. For example: The physical layer is governed by the physical laws. So, anything physical shall have weight, volume, color etc. In a multi-layered structure where each layer is being loosely joined and at the same time accommodating its own unique properties. One of the layers is the principal layer and the principal layer itself being contextual to set objectives of agents. A set of layers could potentially be tightly joined as mandatory and while any number of layers are permitted, they could belong to given groups such as new technology layers, functional layers and the like. In multiple sub-layers, each one is accommodating its own properties, which is also permitted. Each of the sublayers is potentially serving as a filter for the layer above.

Fractal CUs: Fractal nature of the CUs and BETs is not different. Events in BETs are caused by CUs. CUs behaviour is influenced by BETs. They both exist seamlessly in the symbiotic relationship. CUs forge relationships with other CUs that are horizontal or vertical in nature. The Horizontal CUs are 1. Sequential 2. Alternative 3. Parallel. The Vertical CUs are Embedded, Nested, and Super-ordinate. The Embedded Vertical CUs are Recursive and Sub-CUs. While operating within any one of the these CUs, we cannot differentiate the type of the CU as the fundamental structures are same. With reference to the CU relationships, we can differentiate a CU from another and determine its type. For example, viewing CU2 from the perspective of CU1, an agent labels it as sequential. Similarly, all the CU types are determined. Relationships between CUs also determine the direction of differentiation. For example, Sub-CU5 leads to Sub-CU6 (which could be embedded GSI) that would in turn lead to trigger of CU1 further leading to event in CU2. There is an order sensitivity between CUs. For example, when an egg falls from a table, it gets broken. There is no way it can be put back on the table in its original form. Similarly, when events flow in a particular manner, reversal of events is not possible-just as we cannot change the past. However, the effects of the past transactions can be ignored, and the new ones can be created in yet another transaction. Whether the relationship between CUs is vertical or horizontal, they are part of an unbroken chain of BETs.

Fractal BETs: All BETs are binary variables switching between potentialities and realities. The turning on or off these switches are called events. In a solution ecosystem, all events are controlled events. It means that there are agents behind each event. Every event involves three functional elements of the SSA cycle involving the respective agents. 1. Sense Agent: A machine or human agent that informs the information technology system about the arrival or departure of the event. 2. Select Agent: The agent that places the potentiality BET in place at a solution level or transactional level. 3. Act Agent: The agent that is instrumental in causing the event. The names and IDs of respective agents are duly recorded. In several instances, the Sense, Select and Act agents may be the same, but there are some exceptions to this as well. The footprints of the agents across the SSA cycle functions are captured and converted into non-fungible tokens (NFTs) using blockchain. This immutability of information in blockchain can serve as permanent record of value creation with respect to the agents. The functions around the SSA cycle are generally captured in the following manner: 1. Sensing is a UI attribute. 2. Selection is a functional logic BET. 3. Action is the preceding CU and the agent in it that would cause the event when triggered. BET as a value fractal participates in the ecosystem of BETs to accommodate flow of value in the context of set objectives. This system of value flow is akin to switches based on flow of electricity in the network of electrical wires or akin to a control valves based network of water pipes or akin to a system of lockers within lockers controlled by multi-digit combination keys or a network of roads leading to a destination with the right choice of turns at each junctions. Underlying each of the above is the fact that the world is filled with random combinations of almost infinite entities which unique combinations in the context of agents creating immense number of random contextual possibilities, from which agents attempt to derive orderliness by collapsing the possibilities through right selections to reach set objectives in a series of directed steps as driven and accommodated by BETs. The anatomy of the BET provides for the static entities and relationships being taken into its fold and it converts them into events consuming and events generating dynamic and animated system through conversion of entities and their relationships into connected binary entities (BETs).
Agent Effort: Efforts and contributions of all agents and team irrespective of their hierarchical vantage points are quantifiable or measurable. The contributions express themselves in the form of agent footprints either in solution BETs or transaction BETs without exception. Rewards and organizational actions in favour of or against agents can be determined based on such objective considerations. As every event is caused by one CU or the other (causation CU), the same should be duly identified. Causation CU trigger times such as start, end and period (event cycle time) will serve as associated information. An extension of this is spatial aspects of triggers such as at what place the trigger has started, at what place the trigger has ended, and the distance covered also counts as something of material importance. Events can also be caused by qualified agents from outside the solution ecosystem. It may also be of value to assess the cycle times between transactional BETs. A BET can be both an input BET and an output BET based on the context. For example, if CU1 placed pen BET in CU2, from CU2 perspective it is an input for its own trigger. From the perspective of CUI it is an output BET. An event is also one that could have happened in the connected ecosystem (same transaction), or it could be one that happened with respect to some other (related) solution stream, or in a different transaction. The structure of the BET is the same irrespective of the vantage point. It is a switch between the potentiality and reality.
Multi-agent BETs: Every BET is driven by an agent who acts as a catalyst of change. Agents are driven by OSSA cycle (Objective Sense Select Act). In the NSL ecosystem, there are multiple agents pertaining to each layer who drive the layer through the OSSA cycle. Multi-agent system accommodating agents for each Objective-sense-select-act (OSSA) cycle function and with the SSA always being subservient to the objective function contextually and this OSSA cycles being applicable individually to both the potentiality and reality states. For example: Testing layer will be driven by the Testing agent whose role is specified for that layer, Knowledge layer will be driven by the knowledge agent, IR/DR layer will be driven by the IR/DR agents who apart from having rights to view all the information, shall also have rights to derecognize information as required. With respect to OSSA cycle connected with potentiality, events happen in a batch mode spread over different space-time instances preceding real time transactions. OSS events in potentiality in the batch mode get stored through ‘A’, the act of storage. It is all this stored info that is retrieved at the time of real-time transaction execution as additional information for the transaction execution being a more informed one. Potentiality represents intentions, expectations and anticipations in the context of objectives. Reality represents status at transaction levels with respect to potentialities based on qualification criteria. In many cases agents execute potentialities. But sometimes potentialities undergo changes based on feedback from shades of potentiality, shades of reality and all the input and output events. Potentialities and realities feed on each other.

The world of Agents and BETs: Agents classify things into distinct and discrete for convenience. This observed distinctiveness from the agents' perspective is information or entities. When dealing with entities from the perspective of a solution, the layer of entities occupies a principal position. The dual nature of entities in the context of agents are perceived entities (potentialities) and experienced entities (realities), which give rise to binary entities (BETs). In the world of agents, there is only the existence of agents and BETs. Agents perform OSSA (Objective Sense Select Act) cycles for survival. The OSSA cycles result at each stage in ‘controlled reduction of possibilities (classifications) to move towards an ultimate possibility that is desired (objective). There are external agents who are humans. There are digital agents, which are artificially created by humans to unburden themselves with solution and transactional level OSSA cycles. There are inner agents in the dual capacity of questioning agents and answering agents. Human agents are engaging themselves by way of interactions with either agents or BETs. Inner agents can represent the inner voices of both Q (questioning) and A (answering) agents. These inner dual agents seem to feed on each other's BETs. For example, consider two half portions of a wheel. If one of the portions is placed on the floor, it will swing back and forth, but will not move forward. Each half represents a ‘Q’ or ‘A’ agent. If the two halves are joined together, only the holistic functioning of the wheel can be observed. The ‘Q’ half of the wheel leads to the ‘A’ half of the wheel, and the ‘A’ half of the wheel leads to the ‘Q’ half. This results in a positive feedback loop making the wheel move forward until the destination is reached. In other words, until the answer is fully grounded, each turn of the wheel is like a CU. The destination is the GSI. These inner agents have properties of storing, processing (create, delete, or modify), and retrieving BETs. The senses (ability to see, hear, smell, taste, and touch) equip agents to collect BETs from the environment. The ability to communicate and interact with other agents gives agents the additional capacity to exchange BETs. Agents gather BETs of value from wherever they can access. The inner agents interact between themselves and with the external human agents and further with the digital agents.

Knowledge transfer in the agent systems: Knowledge is the possession of entities and their relationship status in the form of representational entities holding truth values. The knowledge transfer takes place when agents possess the same relay. The status of entities (entities and their relationships) through representational entities (most often through spoken languages such as text or voice) that hold truth values are to be registered by agents that provided access. Knowledge is also acquired when agents seek it through interrogates being posed to agents that possess the knowledge and are willing to share. There are a set of interrogatives that target uncertainty resolutions of given types such as Why, Who, Where, When, What, How, Which, Whom, Who else, and the value fractal captures all these at the microcosm level itself. The interrogative ‘Why’ is the objective seeking (the Effect Entity) interrogative. The interrogative ‘Who’ seeks the owner of Driver of Change Driver CU (the causation CU) or the Effect CU. The interrogative ‘Where’ seeks the Place Entity. The interrogative ‘When’ seeks the Time Entity. The interrogative ‘What’ seeks other Participating General Entities and Attributes. The interrogative ‘How’ seeks the Trigger CES and its Pathways. The interrogative ‘Which’ seeks knowledge of Effect CUs or Causation CUs (Is it CUx or CUy?). The interrogative ‘Whom’ seeks possession status of General Entities (for example, who does the pen belong to). The interrogative ‘Who else’ seeks to know about additional agents with access rights of information right or decision right (IRDR).

Knowledge and all solutions are agent centric: Any controlled change is agent centric. If there are no agents, there is no knowledge and there are no solutions. The matter expresses itself in the form of entities and their relationships in the context of knowledge and solutions for agents. Agents classify and define entities to convert all things encountered into discrete states from continuities. When such a classification is done for all the entities (including functions thereof), an agent is faced with a one in a million situation, that is, only one out of a million entities with their relationships matters. The million represents disorder or chaos and the one represents order. It is like finding the right combination (or the equivalent of password) for a six (6) digit (xxxxxx) combination or a million possibilities combination locker. Having the right entities and their relationships is like having the right password. Evidence is same as opening all lockers of value through the right combinations and checking. The billions of knowledge components and solution components are called BETs, and these BETs are passwords of value.

Interrogatives define uncertainty classes and act as useful tools for establishing certainties and orderliness. Human agents reflect on different possibilities in determining the right potentialities, as aided by interrogatives. Interrogatives are not just aids to self-reflection, but also help in extracting knowledge from other collaborating agents.

BITs vs. BETs: In NSL, anything distinct is information. Agents can identify or create distinctive things from their perspective. Information technology has come up with a self-serving model of representing anything in the world using binary digits and connecting the same to controlled electromagnetic forces. If there are enough 0s and 1s, all distinct things in the world can be represented through these binary digits. In NSL, all distinct things in the world that matter in the context of solutions can be called entities. Bits have the power to represent not only entities but also their relationships and even relationships have distinctiveness associated with them. From the information technology perspective, since a set of bits can represent an entity effectively, that set becomes equivalent to the entity it represents. Taking a set of bits that represent an entity and freezing those bits together will give the entity a status of maintaining integrity. Once frozen together, the ‘bits set’ attains a unitary status. That unitary set has a binary nature to it. It can either exist or not exist, but no intermediary state would be permitted. Once the equivalence of this kind is established between bits and entities, one could not only quantify solutions but also quantify the information with respect to them in bits.
A ‘BET’ is only a natural extension of an entity as it arises in the context of solutions. Solutions require anticipation of an entity in the mind (potentiality) first to match with reality entity through actuator functions. This is the way entities get animated as potentiality and reality, and at any point, only one of the two states can exist as controlled by events. The BET model permits the count of bits behind every BET. This can easily be accomplished as a separate layer, which can be created for every BET with respect to the bits it consumes such that the count of the bits can also be kept from storage, processing, and communication requirements perspective.

Directionality: This is about moving up or down the differentiation tree based on addition or deletion of entity values. As one can add new entity values, one would be moving in the positive direction of differentiation. By deleting values, one would be moving in the negative direction of differentiation—that is, in the direction of ‘un-differentiation’ or ‘generalization’ or ‘integration’.

Quantification of Solutions: Just as information is quantified in Information theory as ‘bits’, NSL quantifies solutions through the identification of distance between entity relationships. (a) Binary events: The distance between entity relationships can be measured in terms of the minimum number of binary events it takes to get from one CES to another. For example, if entity 1 is ‘A’, entity 2 is ‘AB’ and entity 3 is ‘ABC’, the minimum number of binary events required to happen to get from entity ‘1’ to entity ‘3’ is ‘2’. The principle is that differentiation when ignored or recognized, either will result in a merger or the two entities become identical. NSL eliminates the difference between the structure and the process and what counts is only the directionality of the differentiation. (b) Space: Because each CES is either explicitly stated or implied, and operates in space, how much distance has been covered can be computed. (c) Time: Since there is stated or unstated time associated with each CES, the time could potentially be assessed and hence the distance can be measured in time.

Dynamic Natural Language: Solutions are prescriptive information being acted upon. NSL, contains much more contextual information than natural language, in the form of all the subjects, objects and the desired transformations (verbs or action words). NSL uses the fundamental principles of differentiation to identify the uniqueness of every entity, by attaching adjectives (attributes) to nouns (entities) and adverbs (attributes) to change units (statements of intent or steps for achieving a purpose or goal). NSL is thus equivalent to Natural Language+.

Change Unit (CU) Clocks: By the nature of things in NSL, all things exist either in potentiality or reality in CUs and, more specifically, in CU components. The differentiation with respect to CUs proceed from a class level to many levels of subclasses until the transactional level is reached. It would be valuable to keep track of the birth and death (deletion) of any entity in the solution ecosystem and, by extension, the period and the age of existence of an entity. All entities coexist in time, which means that time is always a part of every CU's CES. Time could be sitting in the CU either as a Change Driver (CD) in the functional layer or as an Information Driver (ID) in the information layer, but more often, it is treated as an implied entity. The way “Air” is an implied entity for humans, “time” is an implied entity for change units. It is not required to be mentioned separately. At a ‘syntactic level’, that is as a fundamental solution support level that caters to all situations and scenarios, the coexistence of every entity with time shall be provided. At the ‘semantic level’, it is for the solution designer to use or not to use that property and take ‘time’ as an implied entity. The usefulness of keeping track of time could extend to a wide range of things extending from analytics all the way up to drawing inferences. For example, imagine a CU with a pen and 3 other variables. As there are four variables in the CU, it could potentially have 16 different CES (2\hat{ }4 states). If the pen is the first to arrive, the CES number 1 could change from potentiality to reality. The system tracks the time of that potentiality and the time when that potentiality is deleted or eliminated, since that potentiality is replaced by ‘reality CES 1’. When another entity arrives, that CES becomes potentiality, and another CES, say CES number 5 becomes a reality. The system could also keep track of individual entities also (not just the CES) as NSL provides for loosely coupled, and yet unitary entity states. When the ‘trigger CES’ is reached, one can also track the lag time between its reality state and the extended CES arising out of the trigger CES. There is always a lag time involved between the trigger and one or more events that trigger causes. Having this information is of great value for the users of the solution in varying contexts.

Time Derivatives: One could derive periods of existence of BETs at all vantage points based on their time of birth or death. The start of a trigger and the end of a trigger state with respect to each of the events it produces can be captured and lapse time can be derived. For a CU, the proportion of the time-it is in an idle state and the proportion of time-it is in trigger state could also be calculated. Proportion of time-an entity was idle (not participating in a trigger state) vs active can be established. Correlations established between ‘events and periods’ at various vantage points creates humongous opportunities for analysis and action. Combinations of time and spatial coordinates take these opportunities for analysis and action to yet another level.

Change Unit (CU) Spatial Coordinates: Both ‘time’, and ‘space’ are ubiquitous. All entities exist in space irrespective of the substrate they belong to. Whether overtly chosen or not, ‘space’ always exists implicitly with reference to any entity. Just as the system at the syntactic level provides for tagging time related attribute values to every entity, the system also provides for tagging spatial coordinates to every entity. These could be two dimensional or three dimensional. Since every entity is physical and at the same time informational, their existence and interactions are bound to spatial coordinates. When an entity triggers, the altered states that the trigger creates is also expressible in terms of distances. For example, when John travels from place A to B on the occurrence of a trigger state, the distance can be measured in terms of number of meters travelled. This is same as measuring the lapse time. The attribute values of space and time are equally applicable to machine agent functions, as they are to human agent functions. Further, in NSL, all entities exist in binary states (BETs). Each state change is an event. All events happen in time and space. Therefore, all entities have attached time and space attribute values (timestamps) indicating ‘coming into existence’ and ‘going out of existence’ along with spatial coordinates, respectively. This is same as a person's birth time and death time along with birthplace and death place, respectively. This applies to potentiality states as well as reality states. The end of potentiality is the beginning of reality and vice versa. This rule applies at all vantage points.

Spatial Distances: Distances covered, while providing a solution, could be derived by cumulating the distance covered by each of the CUS. Such distances can be calculated based on the actual distances traversed or theoretically as a crow flies. These measurements can be for any CU to any CU among the connected or related CUs with reference to a particular solution.

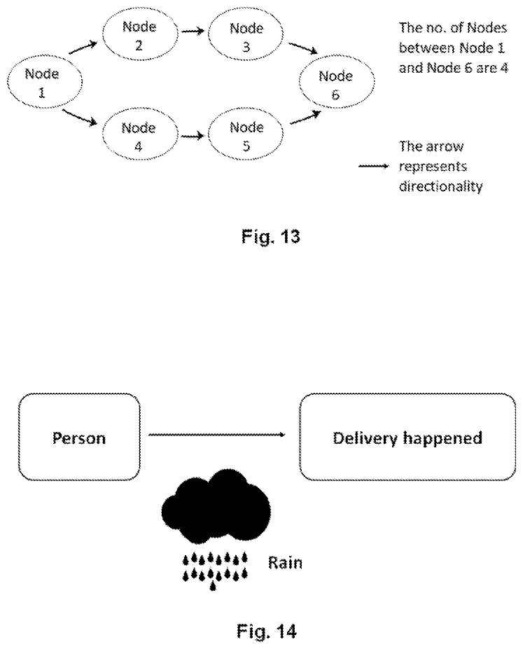

Functional Distances: NSL is modelled after a network of nodes spread in three dimensions connected by lines that have directionality associated with them. NSL has an ability to normalize any type of database makes ‘polyglot persistence’ possible. All entities reside-either in potentiality or reality—inside the nodes. Each of those entities can take many avatars in the form of ‘identity, language/number, image, and the like’ sitting in the respective substrates. Crossovers from one substrate to another is permitted, provided the principles of equivalence and truth values are preserved. Equality applies between classes, between classes to members (a deductive process), and members to classes (an inductive process). All nodes are connected to each other following the nearest neighbor principles. Nodes in the same transaction are called the connected nodes. All nodes in the same solution ecosystem are called the related nodes. As NSL is governed by the network of nodes, all things in the solution ecosystem are relative in nature. Just as the ‘cosmological principle’ in science, any chosen node or vantage point becomes the central reference point. In other words, there are no absolute reference points-all things are relative. Since the lines connected to the nodes have a directionality, there is a directionality to information flow or differentiations in general. Network of nodes provides for all degrees of freedom. Hierarchical models arise out of specific choices made with respect to information and decision flows, but they are not fundamental. In this background, it is possible to choose any two nodes and measure the functional distances. To measure the functional distance, one has to count the number of nodes that exists between the selected nodes. This helps to judge the closeness of the relationship between two nodes, among other things. The Functional Distances example is represented in FIG. 13.

Masking: Masking is same as derecognizing information as needed for contextual optimization. It is in this background that one has to approach the process of optimally ignoring or ‘masking’ in the following way:
The fundamental structure of a BET is that there is a node to which a BET hangs and the node has a unique identity. That node has a sub-node ‘pen’ in potentiality hanging to it. The potentiality pen also has a unique identity attached with it arising out of adding to the nodal identity ‘potentiality specifying’ letter such as ‘P’. Additionally there is this label ‘pen’ attached to it. Further, the ‘pen’ in potentiality could have sub-node ‘pen’ hanging to it (a member of the potentiality ‘pen’) with a unique id arising out of letter ‘R’ added to the nodal id. It would also have label ‘pen’ attached with it. The labels are natural language or number theory specific ones. For example, ‘Pen’ is in English which could dynamically change based on the language chosen. But the number ‘9’ that specifies the number of pens is universal and does not change with the change in natural languages. Solutions are nodal identities driven. Like an ‘object characteristic’ remains the same irrespective of the different words labelling it in different ways in case of each language. It is for this reason, NSL is able to accommodate instant switching between languages. It also accommodates different human agents engaging with the solution simultaneously in the language of their choice. In this background, the process of masking or ignoring information operates the following way:
Every BET has this unique nodal-set structure. If one ignores the labels, the nodes with their ids remain; if the nodal ids are ignored, only the node remains; if the node is also ignored, only the higher-level node with its identity remains; If the id of the higher level node is also ignored only the higher level node remains. The word ‘ignoring’ is synonymous with the word ‘masking’. When only the nodes remain, one can count the number of nodes within the area of focus; which is same as counting the number of BETs. Following the same principles, one can establish the distances between BETs. In case of transactions, all transactional information is ignored, including the nodes of the CUS; only the GSI node remains to be counted. The connectedness of nodes does not stop with a GSI. There is always an ownership of a CU (individual or a team); whoever owns that CU, which is the culminating CU called the GSI also owns the GSI. A transactional agent keeps track of all the GSIs he/she is responsible for. In doing so, he/she creates a node with its own identity that is the superset of the GSI node; and all the GSIs hang to it. A supervisor who has information and decision rights (IRDR) over given transactional agents has a superset node that consumes all the transactions of all the agents that report to that person. It is on account of this procedure, all the nodes in the solution ecosystems are connected throughout, forming an unbroken chain of nodes; and by extension, all the BETs.

The following are a few examples qualified to be called as a BET: i) any snapshot of the ecosystem is a BET. ii) Any chosen vantage point is a BET. For example, if the chosen vantage point is an attribute of an independent entity, it is a BET. iii) If the chosen vantage point is that of an independent entity without an attribute, it is a BET. iv) If the vantage point chosen is a CES, that set is a BET. v) If the vantage point is a GSI, that is also a BET. vi) A BET is contextual to what matters in a given situation. vii). A BET is a microcosm or a macrocosm or anything in between them based on what is contextually relevant. viii) If the BET is in the form of CES or ECES, the potentialities could contain many shades of potentiality and degrees of freedom. ix) If it is at the most granular level, there may be no shades of potentiality. For example, Attribute value color red is either there or not there.

Nested SSA and Residual Information: Nested SSAs make use of the meaningful information and act on it. On some occasions, a lot of information gets accumulated over time which may not find any value in the form of SSA cycles. This is termed as residual information as shown in the FIG. 19. The nested mind is to be viewed as any number of layers of nested SSAs. If information cannot be acted upon, it sits in the informational layer of the last layer of the nested CUs. Any action emanating out of nested SSA can be added to the solution class as a CU. The addition of a CU adds more information or generates more information in the form of transactions. Residual information can remain at every nested SSA cycle levels.

Normal Probabilities: Probability is the quantification of the likelihood of occurrence of an event. NSL is an entity-based model where entities can switch between potentiality and reality as driven by events. NSL provides the ability to apply statistical methods to BETs at all vantage points. Probability is defined as the ratio of favourable outcomes with respect to possible outcomes. It is based on observation of past events. For example, delivery of a product may be considered favourable if it happens in less than one hour. Other things remaining the same, across 1000 instances of that product delivery, it could have happened in the stipulated time 800 times. Then the probability that the product would be delivered next time would be 80%. In NSL, all transactional classes sit within the ‘solution classes’ above. To calculate probabilities all, one has to do is gather transactional information with respect to a given solution class. These calculations can be done in a batch mode in NSL, in most instances, if the probabilities are not likely to vary significantly with every recent transaction. The use cases for the application of probabilities are straightforward and plenty. For example, what is the probability that the doctor will arrive in the next hour? If the probability is 80%, then it might be worthwhile for the patient to wait. The applications of probability extend to Advanced Planning and Optimization (APO), Analytics, Robotic Process Automation (RPA), introduction of conditional potentialities, Machine Learning, and the like.

Differentiated Probabilities: A case can be made for many variations in calculating probabilities. The Probabilities can be assigned to various vantage points of differentiations tree. For example, what are the chances that a criminal is in a particular Country, or State, or City or Locality? What are the chances that the first event would happen in a particular LSI within a GSI? What are the chances that this alternative CU will trigger first vs. some other alternative CU?

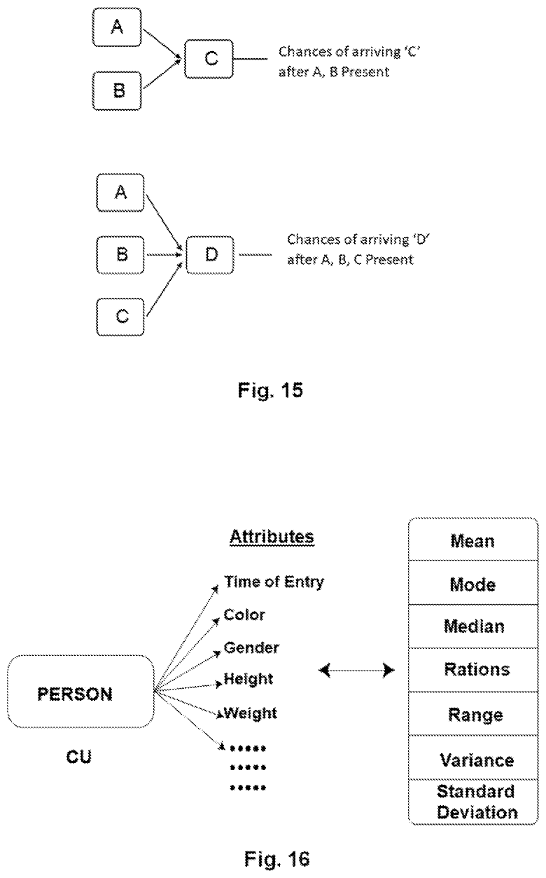

Bayesian Logic: Bayesian logic has been gaining in importance with reference to machine learning. This is about probability of an event based on prior knowledge of conditions that may be related to the event. This is also closely connected to ‘conditional probabilities.’ Examples: What are the chances that ‘C’ will arrive, given that A and B are already present? What are the chances that ‘D’ will arrive, given that A, B, and C are already present? This example is represented in FIG. 15. The NSL framework provides for ‘Contextuality’. That is, it provides for the arriving or departing entity to be put in the context of the environment into which it arrives which is same as existing CES or ECES being influenced by the arrival or departure of an entity. In NSL, ‘conditionality’ is nothing but the existence of a certain state based on which an action can be performed. Change propagates across the solution ecosystem based on nearest neighbor principles. Given that these fundamental properties exist in NSL, Bayesian logic or ‘conditional probabilities’ can be dealt with at all vantage points naturally.

Conditional Potentialities: There are several entities in the universe of the solution ecosystem. All those existing in the universe are possibilities. A solution designer picks up those possibilities from the universe as potentialities. Between the universe of possibilities and potentialities, NSL provides the ability of creating an intermediary state, where in possibilities can be stored as reserves and can be converted into potentialities upon fulfilling certain conditions called ‘Conditional Potentialities’. Conditional Potentialities are a special class of potentialities that convert themselves to potentialities only on fulfilment of certain conditions. These are potentialities that could exist at the level of attributes, all the way up to paragraphs or even books as a whole but are triggered only on certain conditions being fulfilled. Otherwise, they are like shadow potentialities that are ignored for the purpose of determination of trigger properties. For example, raincoat may exist as ‘conditional probability’ in a basic CU. But it may not be considered for the purpose of the trigger of the Basic CU, till such time the ‘conditional-potentiality’ becomes a ‘potentiality’. It is essential for an entity to be in potentiality for it to become a reality. This is a powerful construct in NSL as the entire solution ecosystem can alter its behaviour dynamically as the environment may dictate. The flexibility that this introduces ranges from an attribute, all the way up to the highest vantage points in the solution ecosystem. The exercise of this power is only limited by certain conditions being met—and the application of information rights and decision rights of agents.

Solution Class: A solution architect defines classes and subclasses and creates potential level paragraphs. Events arrive at member level, and they select the appropriate class. It always starts with a desire being formed, and the change drivers and agent being selected. It is important to separate out the entities that are at the vantage point of solution logic from entities at transaction logic. In the solution logic, the variables are ‘Any LSI’, ‘Any Human Agent’, ‘Any Pen’, ‘Any Paper’, etc. that lay out the principles of entity relationships. All classes have implicit or explicit membership determination criteria. At one end, it can be just a binary state, such as ‘light being there or not there’. At the other end, it could be ‘person’ as a class entertaining any of the 7 billion people in the world as its members. In such instances, the rule is that the class admits any of the 7 billion people, but only one at a time.

Sub-Solution Classes: There could be any number of sub-classes between the solutions in the lead up to the ‘Transactional Class’. For example, if the world is a class level entity, the USA could be its sub-class, and California could be its sub-sub-class. It is to be noted that the sub-classes are the members of the class.

Transactional Class: The transaction class is a member of the solution class. When a transaction is carried out, the user can select from different possibilities and options that the solution class allows, and which are in potentiality state. It is at the transactional class that transactions playout. It requires the stated transactional change drivers (CDs) to be in place at the physical layer of a CU. For the transaction to playout, ‘minimal membership criterion’ should be met. Example, When the CU specifies the information of a human being, and if a dog arrives, the minimum criteria is not met.

Differentiated Transactional Class: This is one where there is a lot more information that the transactional class entities shall be carrying, going well beyond meeting the ‘minimum membership criterion’. For example, the pen that has arrived may be carrying with it additional information such as its color, its make, the time of its arrival, and the place of its arrival.

Sub transaction Class: The solution designer as a part of the solution creation defines the transaction class without mentioning the specifics therein. The agents arriving at the Transaction class has the liberty to create sub classes of transactions which are called Sub transaction Class. For example, the solution designer defines the CU for writing a letter, but the agent writing the letter chooses the style and contents of the letter. This feature empowers every transaction performing agent to be a solution designer at the transaction level. This is made possible using the same solutions environment applying Information and Decision Rights. Through the introduction of creation of classes within classes, NSL converts every transaction performer and a user into ‘planner and designer’. This is predicated upon the fact that when limiting the degrees of freedom as per planning. It helps agents at the transactional levels to carve out their own destinies. One scenario is to be confined to the constraints laid down by solution designers. In such a scenario, one could act as per the constraints laid down, but one cannot plan and design within the confines of higher level design in the existing solution environments. For example, what if the flexibility to plan and design a transaction is given to the transactional agent? The system level constraints laid down could be that the transactional agent has to make 10 deliveries in a day to any of the hundred houses in a colony. Within the degrees of freedom available, a transactional agent can use the same design system that the solution designer used to plan. One can plan to deliver to ‘x’ house in the first hour, to ‘y’ house in the second hour, and so on. All planning or algorithms are about laying constraints that make sense. While there are millions of possibilities, the agent places some constraints based on some criterion and plans. Metaphorically, the current systems are comparable to the evolution of designing animals that can react to the environment based on sensual information. But the animals cannot plan as they lack the prefrontal cortex that can perform high order cognitive functions. The introduction of transactional sub-classes is same as equipping an animal with prefrontal cortex and making it human. Now here is an animal that can think and plan. Sub-transactional class is akin to this. It is that powerful and a great way of empowering people.

Minimum Membership Criterion: The Minimum Membership Criterion deals with class level differentiation. Membership is defined in the form of constraints attached at the class level, which mandate the criteria for a member's arrival. While a member arrives with multiple layers of information, for admittance, only the bare minimum relevant information is considered, while all other information is ignored. For example, when a passenger arrives at an airport terminal for travelling, at the check-in counter, his air ticket and passport are the minimum requirements for issuing him a boarding pass. At the security check level, the boarding pass and the screening of baggage are the minimum criteria for security clearance. Finally, for boarding the aircraft, the stamped boarding pass is the minimum criterion to board the plane. There are various things that can be checked, such as Driving License Id, employee id, phone number. However, for the purpose of each stage of checking, only the Minimum Membership Criteria are checked, the other details are ignored. This example is represented in FIG. 7.

Variability: When an entity enters a class as its member, it only fulfils the minimum membership criterion. For example, if a person is a member of a club, the person will be allowed to enter the club provided he/she carries the membership card. After fulfilling the minimum membership criterion, each qualifying member carries a lot more information. For example, a member carries with oneself the time of entry, one's gender, height, weight, color, and tons of other information. As the transactional size increases, the quantum of information also increases which is called data. Such data can be plotted and interpreted in many ways to discern meaningful information. The variability of data or information is assessed in many ways statistically. There are established ways of identifying the mean, median, mode, ratios, range, variance, and standard deviation and the like. The usefulness of these in analytics and drawing inferences cannot be overstated. This example is represented in FIG. 16. NSL provides the ability to perform statistical analysis at all vantage points of BETs. In addition, it also takes advantage of the connectedness of all BETs through their nearest neighbors. On top of it, data visualization techniques can be better deployed using NSL.

Reserved Entities and Reserved CUs: Every solution created in NSL is curated and stored in a library called the Dynamic Solution Dictionary (DSD). Each such solution stored in DSD, along with the BETs contained in the solution, can be reused by any solution designer instead of recreating or redesigning the same again. NSL minimizes the redundancy in building solution logic by providing the ability to use existing BETs at various vantage points. These reusable entities are called the Reserved Entities. If the entire CU is reusable, it is called the Reserved CU.

Dynamic Solution Dictionary (DSD): DSD is the single central repository of all the solutions and solution components in NSL. Every conceivable solution shall stay in the DSD as contributed by different sources. Entities at all vantage points will exist in DSD—right from the lowest level of an attribute to the highest level of a book or a library. The DLD engine would be attached to this DSD so that any solutions that are not existing can be built in no time and contributed to DSD. DLD can even self-generate GSIs and enable them through LSIs during idle time, constantly enriching DSD. This shall be based on a ‘point system’ based on the points assigned to effort and outcomes. This is akin to business functions that are led by principles of revenues, costs, and profits that are based on assigned values. In being able to self-generate GSIs, the nested SSA cycles would only emulate how human agents think and operate. All solutions or their components can be visualized as available in the departmental store of NSL. The departmental store would be attached to machine agents driven assembly lines that would assemble any product that is not available in the store in no time. Entities can exist at all vantage points with their own unique IDs. Each entity at a different vantage point is like a snapshot taken from that vantage point existing in a binary state. The entities are string together through the concept of nearest neighbors. The DSD shall have a dynamic user interface from which the users engage with the world of solutions.

Substrates: Any self-contained system with its own set of properties and rules, containing enough member entities to establish equivalence with entities in other systems, is a substrate. The ‘rules’ referred to above are synonymous with: (a) Constraints (b) Properties (c) CUs (d) Principles (e) Potentialities (f) Laws (g) Algorithms or any other synonymous names. For example, the physical substrate has its own qualities of being made up of atoms, operating in a three-dimensional world having mass associated with its entities. Likewise, the English language is a substrate made up of alphabets of a particular kind. Just as entities can be expressed or implied, substrates also can be expressed in a solution ecosystem or implied. All substrates and entities belong to ‘physical reality’ and are expressed in space and time without exception. Every entity must exist in some physical form and be embedded in space and time. As everything physical has a distinctiveness associated with it, it is also informational by definition. In modern physics, the boundaries between physical and informational aspects of reality have vanished. Entities move from one substrate to another across the solution. Implied substrates refer to the fact that the NSL solutions are stored by default in one substrate or the other, even if is not explicitly stated. For example, a solution designer may create a solution on the NSL platform. The creation of a solution using the user interfaces is only possible when the data is stored physically in databases.

Substrates as ‘Classes of Classes’: Substrates are ‘classes of classes.’ Each of the substrates is a system containing a large number of entities at solution class levels. Entities contained in a substrate are subservient to the properties of the substrate they belong to. That is, the constraints or rules pertaining to the substrate will apply to each of the entities in the substrate. For example, ‘the rock’ in the physical substrate would be heavy as dictated by the fundamental laws pertaining to nature's physical laws. The ‘word rock’ in the substrate of natural language will be governed by the laws of natural language, which is same as natural language grammar. Just as humans have the ability to recognize many entities in the environment, they also have the ability to recognize multiple substrates.

Substrates and their properties: Substrates are mediums utilised to observe, record, and communicate. There are multiple substrates which are available for Humans. Audio/Video/Image are some commonly known substrates. Each substrate will have its own set of constructs to equate the truth values of entities. There is some commonality in properties when it comes to substrates. For example, all statues made of brass will possess similar properties. The brass statues can represent any individual. However, the same individuals can be represented through their pictures or images. The properties of images will again have similarities. Each substrate has its own unique properties. A three-dimensional representation will be vastly different in terms of composition to that of a two-dimensional representation. Similarly, a written text on a piece of paper representing an entity will vary a lot from an image representing the same entity.

Substrate Tagging and Substrate Crossovers: Every entity can reside in multiple substrates. Every entity is physical and informational in nature. An entity can have multiple representations and the representations can exist in multiple substrates. Each substrate and its constituent representations carry their own properties. For example, a statue of a person has its own set of properties. It may be heavy, made up of iron or brass, takes time to be moved from one location to the other and so on. Whereas an image of a person has much different properties. Its lighter, easily movable, consumes much less space, packs in much lesser information, has a two-dimensional form and so on. For solutions to play out, one needs to define the determination in which form (substrate) or representation it matters. Sometimes a doctor is needed in-person to perform a surgery. In some cases, a doctor can call and consult to provide a solution. The substrates also change when the representations change. It is therefore important that every entity and its representations along with the substrate in which it resides becomes important from a solution perspective. The electromagnetic form of representations moves at a much faster pace as compared to physical entities. Substrate crossover and substrate tagging can potentially have a powerful impact in building the most efficient solutions. The dynamism imparted by NSL coupled with seamless substrate tagging and crossovers can truly change the solution landscape and usher in path breaking solutions for the new era.

Equivalence Principles: Equations in mathematics operate by the equivalence principle when A=B=C=D, they become interchangeable. Likewise, many substrates can have their equivalent entities in other substrates, or within the same substrate. For example, ‘Rama’ in the physical substrate can have an equivalent entity in the language substrate—‘word Rama’, in the images substrate ‘image Rama’, in the perceptual substrate (in the brain) as a set of ‘molecular arrangements they are equated to Rama’, in the same substrate as the ‘statue of Rama’, and so on. NSL treats every entity in the world, including substrates as existing in the physical world. By the same token, it also treats every entity in the world, including its substrates also as informational, because everything distinct qualifies to be an entity. All entities in each substrate must be informational. That does not mean that all equivalent entities across substrates carry the same information. Information asymmetries exist between the same entities residing in different substrates except for the cloned entities. For example, when a letter is electronically copied to 100 people. All that the equivalence principle requires is the ‘meeting of the minimum membership criterion (MMC)’. What MMC looks for is the minimum required information such that the membership criterion is met any additional information is welcome, but not mandatory. By looking at an A in a substrate, if one can identify another entity in another substrate or in the same substrate as being the same, the requirement of equivalence is met. It may be the case that ‘physical Rama’ carries 10\hat{ }50 bits of information, ‘word Rama’ carries 32 bits of information, and the ‘image Rama’ carries 10\hat{ }7 bits of information. The information content between equated entities can be different. When crossovers happen across substrates, following the equivalence principle, it is incidental that the truth values have to be preserved. Example: The truth value is preserved when ‘physical Rama’ is equated with ‘word Rama’. Truth value is not preserved when ‘physical Rama’ is equated with ‘word Krishna’.

Bundled Substrates: When there is a lot of affinity between substrates, they are bundled together. For example, in Information technology the layers of abstraction are equivalent to substrates in NSL terminology. Those substrates can be controlled by the electromagnetic forces, the bits of information, the symbols, the databases, the logic and functional layers, the UI, and so on. They are bundled together as they have a symbiotic relationship. This bundled behaviour also applies to many other substrate groups. For example, the brain entertains many substrates in it, wherein a substrate that captures information, a substrate that stores information, a substrate that processes information, and so on.

Related Substrates: There can be many substrates within substrates that are related with small variations. For example, if Hard assets is a category of substrate, there are two branches within it called the fixed assets and the inventory. These are substrates within the broad substrate of hard assets. Similarly, if Natural language is a substrate, there are 7000 natural languages in the world which are layers of it. Similarly, inanimate things in the world are related to living beings as they both belong to the same physical world.

Hierarchical Substrates: There are instances where a substrate is defined more broadly or narrowly. One could define a substrate as ‘hard asset’ or one could descend down the vantage points of substrates and narrow it down to a ‘fixed asset’ substrate and a ‘variable asset’ substrate. The principles of differentiation that apply to independent entities through their attributes also applies to more differentiated substrates.

Physical Continuum: The principles of Physical Continuum deal with the basic premise that solutions are informational, and that information has to be physically stored in one substrate or the other and that the SSA cycles play out continuously. The principles of Physical Continuum maintain a continuous thread and exchange of information between substrates by preserving the discrete states and truth values. The principles of Physical Continuum deal with information being stored in different substrates while preserving the truth values and discreteness without breaking the physical chain of continuity. Since there is a continuous transition from a problem state to a transition state, each state is combinatorial in nature. A move from one state to another also must be viewed as a transition from one combinatorial entity state to another combinatorial entity state. NSL can store the continuum of states. NSL has the model to capture all the states and connect the substrates, even when the entities are explicit or implicit. While the platform has the capability to store the minimal information important enough to capture the truth values, not all substrates carry the same amount of information. For example, a visually impaired person may sense more information through the ears, smell, and touch. People have varied ways to assimilate information. If a person is in a dark room, then vision may not serve the purpose. The SSA cycle is constantly turning and each SSA cycle is a change unit which is discrete. However, events happening in reality are captured by one substrate or the other. There is a constant substrate crossover that preserves the truth value to communicate the reality accurately. The flow of energy from the problem state to the solution state is continuous. Hence, the SSA cycles find their representational counterparts in any substrate, and each of it is physically stored. The principles of Physical Continuum deal with information being stored in different substrates while preserving the truth value by having sufficient constructs to equate representations. This example is represented in FIG. 7.

Symbiotic Substrates: Whether it is a human agent or a machine agent, physical continuum that leads up to solutions cannot be accomplished in isolation. Seamless transitions or crossovers between substrates is a necessity to maintain the physical continuum and the progression towards a solution. For example, in case of IT, the physical continuum cannot be maintained in the absence of the user interface, which is a place where the inputs are presented to the bundled substrates and outputs are taken from the same.

Labelling of Substrates: All entities are embedded in the reality coexisting with ‘space and time’. This reality of nature does not classify things. In ‘nature’ everything is continuous tending towards infinities. It is the agents that create discrete entities and classify to overcome complexity. Agents have limited capacity with respect to sensing, selecting, and acting (performing SSA cycles). Therefore, of necessity, agents must optimize entities that they deal with. Such classification, as explained previously, can be with respect to both substrates and the entities embedded in them. As substrates and entities are inseparable, it is as though they are constant companions and two sides of the same coin. Therefore, one way of dealing with them is to express every substrate as an attribute of an entity. An entity can be labelled for the substrate to which it belongs to. The substrate is also differentiated by the properties of the substrate that cuts across all entities in that substrate. For example, in a physical substrate, entities have mass or weight associated with them. They can be further differentiated by the properties that are specific to it in the context of the substrate to which it belongs. An entity in the physical substrate may be a solid or a liquid. Such labelling can be done in an automated way by the machine agents for the most part. The extent of automation depends on the predictability or recurrence of substrate attribute properties. Where automation is not possible, the solution designers or the users shall help in labelling the substrates accurately.

Substrates as Attributes: In NSL, all things are relative, that is, relative to the direction, relative to what matters, relative to what the intent is. When anyone looks at things from the perspective of an entity, its substrate becomes its subset or attribute. If anyone looks at things from the perspective of a substrate, then its constituent entities become its attributes. This is same as oneself declaring to be an Indian—where India is an attribute. From the perspective of ‘India’ as a country, each one in India would be its constituents and thus becomes its subsets or attributes.

Substrates Library: All things are informational from NSL perspective, irrespective of the substrates they belong to. An entity can exist in many substrates simultaneously. An example of carrying varying amounts of information irrespective of the substrates is shown in the FIG. 33. The equivalence principles and truth values should however be preserved. There will be information asymmetry with varying quantities of information in each substrate. The existence of ‘minimum qualifying information’ is sufficient to establish the ‘equality of entities’ in different substrates. For example, by looking at the ‘word pen’ one can establish its equality with the ‘physical pen’. Though the quantum of information in the ‘physical pen’ is significantly higher (as it has enormous amount of discrete/distinct states), few bits of information in the ‘word pen’ is sufficient to establish its equivalence. It has met the ‘minimum qualifying information’ criteria. All substrates are mental constructs of the agents. They are classes of classes. For example, a pen by itself is a class and it could be sitting in the physical substrate. It so happens that the ‘physical substrate’ is also a class. When the ‘pen class’ is in the physical substrate, NSL encounters a situation of a ‘class within a class’. This example is represented in FIG. 28. Everything in information technology is ultimately dealt at a representational level of a language. The additional information in the physical substrate is captured by expressing that additional information in the form of attribute values hanging to the ‘class of physical substrate’ expressed in language terms. The superset of all substrates is the ‘physical substrate’ as nothing can fall outside of space and time in which this substrate resides. The physical substrate is a superset because the information in it is maximal, as all distinctive states must be captured in it. NSL has a substrates library that focuses on i. Physical Substrate ii. Lifeforms Substrate iii. Language Substrate iv. Image Substrate v. Metaphor/Proverb/Idiom Substrate. FIG. 29 represents the five identified substrates in the substrate library. The substrate library deals with the following:
1. Establishes all the additional information with respect to every entity by way of structured attributes.
2. Establishes a process for subjecting those entities to the constraints pertaining to their respective substrate.
3. Establishes constraints with respect to the interactions those entities can possibly have with other entities individually or in combinations.
4. Feeds into the predictions that can be made and inferences that can be drawn.
5. Makes the machine agents draw inferences similar or better than the human agents.

Functional Asymmetry: Functional asymmetry refers to sufficient SSA cycles not being available for the machine agents. Information asymmetry refers to sufficient information not being available for the machine agent. Humans can read the lines and read between the lines. Read in between the lines refers to contextual information that humans can relate to. Along similar lines, there are cases of asymmetries even in human understanding. A Nuclear scientist may be better placed than a policeman to understand Nuclear Physics. A view taken by an experienced detective on a crime scene may be far better than a view taken by a Chemist who may not relate to the subject so well. NSL embarks on a mission to disband asymmetries to empower machines like never before. This asymmetry is systematically eliminated by introducing the Inference Engine and the Analytical Engine. Machines may only read the lines but may not have the capacity to read between the lines as much as what a general human can do. NSL provides the unique potential to empower the machine. Machines are far superior in comparison to humans, when it comes to information storage, information retrieval, processing a large quantum of data and response times. Machines can tilt the scale of inference in their favour, if the informational and functional asymmetries are bridged between the humans and the machines. Machines should be provided with the purpose and anticipation, just as humans. They should have a third eye to read between the lines and have a sense of purpose to play out the SSA cycles. They should be provided with anticipation and planning, as well as a lot of contextual information.

The nature of information: Anything distinct is information. The distinctive things that matter for the solution are called entities. In agent's environments, entities are taken and converted to BETs. It helps to visualize BETs as hanging to nodes with assigned identities and labels. These BETs are loosely joined with other entities resulting in CES and are dealt with through lines connecting them with directionality implied or indicated through the lines. When entities are joined, the combinatorial entities attain a unitary status and have their own nodes to which they hang. Since everything distinct is an entity, the node is a standalone entity that denotes a universal entity that declares the presence of an entity without any other established properties. One can systematically ignore information, that is, the labels and identities, resulting in only a node remaining as a standalone. If anyone can further ignore even the node's existence, the higher-level nodes will only remain. As one ignores information, the system tends towards the creation of identical entities to be represented by numbers. Ignoring information contextually results in concentrating or condensing information that serves the agent objectives optimally and often dramatically. There are a few synonyms that have been used for conveying ignoring of information such as ‘de-recognizing’ or ‘masking’ information.

Information Asymmetry: NSL benefits from 400 hundred years of progress in science. It reinterprets the ‘Way World Works’ (WWW) in the background of technology solutions. While it has not discovered anything new about the ‘way world works’, it has invented a way of dealing with technology solutions. One of the most significant conclusions drawn by NSL is that everything in the world is physical, embedded in time and space. At the same time, everything in the world is informational, making the differences between physical and informational only notional. Going a step further, it treats both time and space also as entities-making those also informational. All entities in the world undergo continuous change as driven by energy. Agents capture only those static and dynamic entities that matters to them. Agents (both human and machine) control the entities and their behaviour through directed energy that they provide. An implication of this is that all ‘directed actions’ are same as ‘acting upon information in a directed way’. In this world that consists of many substrates and entities embedded in them, there exists a reality where one entity may have its counterparts carrying reciprocal information. Reciprocal information is one where one could look at one entity and deduce information about some other entity. NSL calls these entities representational entities. These representational entities can reside in the same substrate or across different substrates. For example, a person and his statue are in the same physical substrate and could represent each other. It is more often the case that representational entities are in different substrates. Physical Rama could be in the physical substrate, the word Rama could be in the language substrate, and the image Rama could be in the image substrate representing each other. The crossovers from one entity representation to another in a different substrate can happen abiding by the equivalence principles as established by truth values. It is these equivalence principles that preserve the maintenance of physical continuum from the ‘start CES’ to the ‘end CES (GSI)’ following the physical laws. If entities can possess reciprocal information, and thus acquire the quality of being able to represent some other entity, what qualifies to be called a real entity among these representational entities? The answer to this is simple and straightforward-it is relative to the desires of the stakeholders (GSIs) and the choices made by the solution designers. Information asymmetries exist between the human agents and machine agents. When reading a sentence, human agents read between the lines and thus possess a lot more information than the machine agents. For example, in a sentence, ‘Elephant is walking in the wood’, a human agent is generating a lot more information than the machine agent. The human imagines the size of the elephant, the nature of the wood, and the landscape in his own way. Similarly, there is information asymmetry between the human agents as well. For example, when two friends meet a third common friend, they draw the same conclusions about the friend. But at a more differentiated levels their views about that friend would be quite different. This kind of asymmetry between human agents can be called as ‘between the ears asymmetry’. It is these principles that apply with respect to information differences at the level of ‘vertical CU differentiations.’

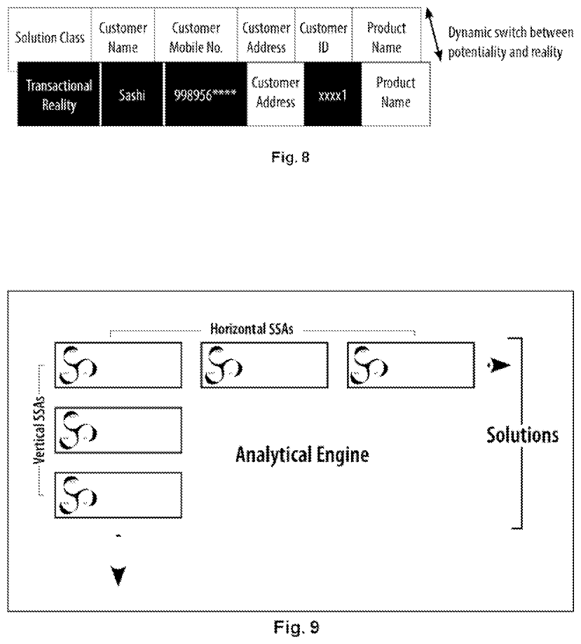

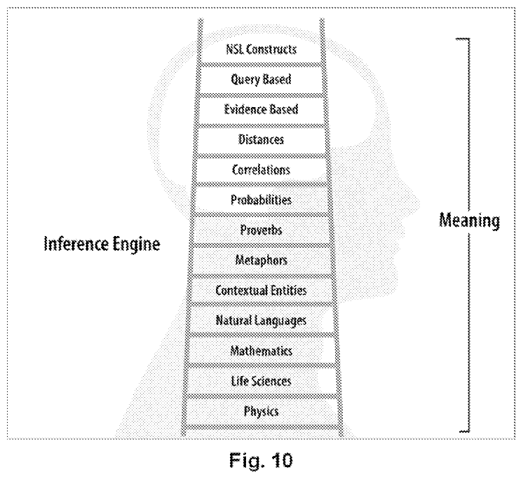

Dynamic User Interface: NSL provides for a platform to develop solutions using natural languages. NSL makes the development of any solutions using natural language and mathematical constructs possible and it is agnostic to any of the thousands of natural languages being used. NSL makes the solution logic transparent. In line with the vision of democratizing solutions, NSL has developed dynamic user interfaces (CDUI), which move away from the old paradigm of graphical user interfaces to interfaces that house dynamic text. Every solution presents itself as sentences and paragraphs. FIG. 8 represents an example of Dynamic switch between the potentiality and reality. Further, User interfaces shall be self-configurable, driven contextually, and dynamically. Dynamism and contextuality go together. Dynamic Solution Dictionary (DSD) adjusts itself dynamically to provide a distributed and secure access to solution ‘BETs’ individually to its stakeholders (human agents). Access privileges are governed by Information and Decision Rights (IRDRs) possessed by each of the stakeholders.

Solution Mining: Solutions exist in many substrates. Programming language, videos, Standard Operating Procedures, flowcharts, images, audio files are some of the substrates which house solutions. Solution mining refers to translation services. Solution mining helps to extract information from all the substrates and translates the same to Natural Solution Language.

A POTENTIALITY ENTITY: It is a potentiality class that collapses degrees of freedom in a directed fashion in the context of an objective. The collapse of possibilities or degrees of freedom happen through the SSA functional cycles within the scope of the specified objective. A series of collapses of local degrees of freedom with respect to the local objectives continue till the global objective is realized. This is like a wave particle duality i.e., whether a quantum entity is a wave, or a particle remains undetermined till such time an interaction of a quantum entity with another entity results in the collapse of the wave function and then the quantum entity attains the status of a particle.

Developer Less Development: Most of the solutions in the programming world are dealt at the equivalent of Basic CU (including their Embedded CUs) levels. The central dogma of NSL reduces all solutions to ‘entities and their relationships’ in the context of ‘agents and their purposes (wishes)’. Relationships are either static (CES) or dynamic (ECES). NSL treats ECES as a special class of information, thereby eliminating the need for a ‘process’. Every agent is an entity (with some special properties) and every purpose is a chosen CES by an agent. A ‘CES’ or ‘ECES’ are about relationships of entities. When entities combine, each combination is a result of loosely coupled, but a unitary entity qualifying to be called an entity by itself. Thus, all entities, including their most complex combinatorial forms also exist only in binary states. This means that the vantage points can change, but their fundamental nature of being binary entities would not change. Entities at all vantage points are connected or related to each other through their nearest neighbors. For example, if Tom's friend lives 5 houses away, then Tom can go there without crossing the other four houses. Entity relationships are the contextual-coming-together-of-entities with respect to solutions. A solution is the fulfilment of a wish, which in turn is a ‘chosen CES’. DLD contextually connects all entities to the chosen CES (GSI) automatically. This automated selection of potentiality entities in the context of GSI (Global Statement of Intent) follows a structured three stage process:
a. Contextual Selection of LSIs (Local Statements of Intent)
b. Contextual Selection of CDs (Change Drivers)
c. Contextual Selection of DCDs (Drivers of Change Drivers).
   DLD can do contextual search and identify the right kind of contextual entities that meet the objectives set by a GSI. In the process, DLD stitches together all the contextual entities. DLD uses machine learning techniques to make the automated process of building a solution more efficient. The NSL Framework lays the foundation for efficient creation of real-world solutions. The DLD engine uses NLP, ANN, Nearest neighbors' techniques/components for processing the solution content. The NLP technique includes named entity recognition, word disambiguation, and entity synonymising components. The ANN technique includes probabilistic models, sentence encoder, and Deep learning components. The DLD engine uses the probabilistic models for the various permutations and combinations to make predictions.

Analytical Engine and Robotic Process Automation: There can be any number of levels of Nested SSA Cycles added to a Basic CU. The only requirement is that there is additional differentiated information worthy of being acted upon. Even partial information available at the higher level can also be acted upon. For example, if Rama brought vegetables, the Nested SSA Cycle can place the ‘vegetables’ in the physical layer. Rama can be placed in the information layer of that Nested SSA cycle as ‘residual information’. If the outcomes of Nested SSA cycles are fed to the respective CUs in the ecosystem in the form of analysis and insights at the information layer level, then it is equivalent of powering the solutions with the analytical engine. Alternatively, if the outcomes of Nested SSA cycles are powering CUs owned by machine agents at the physical layer, then it would relate to Robotic Process Automation (RPA). If there are no actuators involved at the physical layer, RPA would be of the software bots' kind—influencing things in the computer substrates. If there are associated actuators, depending on their sophistication, RPA could extend to influencing the objects in the ‘physical substrates’. The Analytical Engine processes the data using descriptive statistics and/or inferential statistics techniques. The Analytical engine performs descriptive, diagnostic, predictive and/or prescriptive analytics on the data (Big data) by using Artificial Intelligence techniques, Machine Learning techniques, Natural Language Processing techniques, Deep Learning techniques, and other known techniques. FIG. 15 represents an example of the Analytical Engine. Further, NSL provides a very powerful analytical engine. This is enabled by the fact that entities and CUs can be made as granular as possible to process information at the very source. The Embedded CUs and nested CUs provide for even greater granularity to consume information and generate meaningful insights. The differences between analytical engine functions and RPA are quite marginal in NSL. The Analytical engine generates insights for self-consumption or propagation across the solution ecosystem as needed. RPA is just one additional step away. The insights are placed in the ‘physical layer’ to be acted upon. Such actions are driven by machine agents to minimize human effort and enhance the quality of solutions.

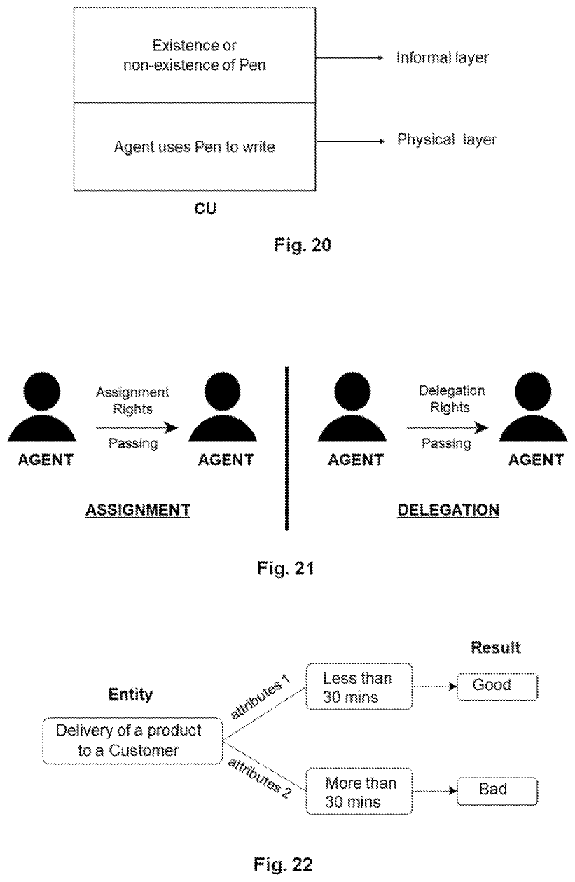

Information rights and Decision rights: Information rights, as the name indicates, provide access to information about the entity in question. For example, an agent has access to knowing ‘existence or non-existence of a pen’. When there are only information rights for an entity, these entities are available in the information layer of the CU owned by a given agent. In case of decision rights, an agent is empowered to influence the entity. For example, in case of the ‘pen’, an agent is empowered to use it to write or do what the solution design provides for. These entities are available in the physical layer of the CU owned by a given agent. The examples of Information Rights and Decision Rights are represented in FIG. 20.

Assignment or delegation of IRDR: The solution designer can assign or delegate IRDR to agents within the solution ecosystem. Assignment pertains to an agent having information rights to pass on that right to other agents within the constraints laid by the solution designer. Delegation pertains to an agent having decision rights to pass on that right to other agents within the constraints laid by the solution designer. These constraints can pertain to letting assignments or delegations happen to limit the number of agents for a limited time. It can even be event-based assignments or delegations. The Assignment and Delegation of IRDR are represented in FIG. 21.

Conditional Potentialities with respect to IRDR: The Solution designer can also provide for conditional potentialities. In given instances, IRDR of agents can change contextually. This will prove to be a unique feature that provides for a highly versatile solution design.

Inference Engine: NSL recognizes solutions to be a special class of information, centering around differentiated classes, that can be acted upon. The word ‘information’ is being used in the limited context of information available in the substrate of natural languages. Natural languages are ‘meaning centric’. NSL is solutions centric. NSL is a subset of natural languages as it is a special class of it. Natural languages dealing with everything in the world and are neutral to whether they lead to solutions or not. NSL only deals with solutions. NSL selects those entities in the natural language (numbers and mathematics are implied) that matter to solutions. NSL heavily relies on ‘information’ and the ‘meaning that it carries’ as it is constantly looking for information to be acted upon. The inference engine, using the tokenization methods, Rule based POS tagging methods, Stochastic POS tagging methods, Markov model, Hidden Markov model methods, specializes in drawing the right meaning with respect to information and thus plays, an extremely important role. Information resides contextually in large number of substrates. ‘Physical, biological, images’ are just a few of the several possible substrates one can easily identify. Each substrate has its own properties, principles, and constraints by which it is guided. Entities are also bound by the properties of substrates to which they belong. The constraints and principles that each substrate is led by are clear. Each such substrate principle is equivalent of static differentiated class level entities. For example, all bodies are bound by the force of gravitation. Only those bodies that fit this class level specification will qualify to be members. The inference engine attaches Nested SSA cycles to each of the applicable substrates in which an entity resides. All solution classes or classes in general are equivalent of NSL entity potentialities. Whenever an SSA cycle plays out at these substrate levels, it checks for the fulfilment of membership criteria. FIG. 16 represents an example of Inference Engine.

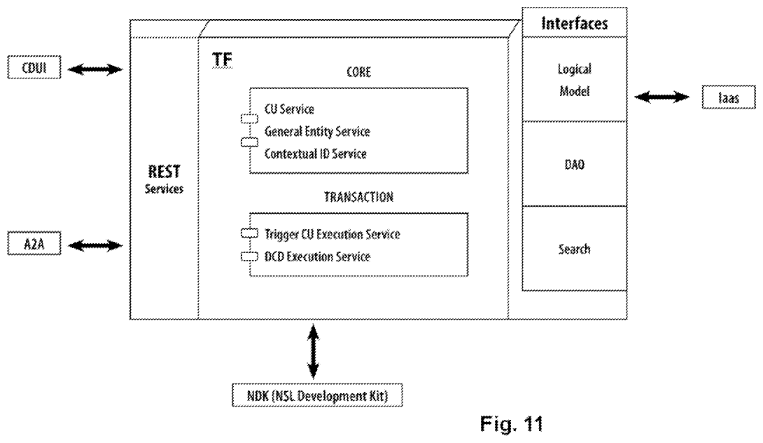

Natural Solution Language-Technology Framework (NSL-TF): NSL-TF is responsible for the design and implementation of NSL runtime environment. NSL-TF is developed using Java and Spring Technologies. It consists of multiple modules designed with distributed microservices. The multiple modules present in NSL-TF are responsible for providing the capabilities to design all constructs present in NSL such as Entities, various types of CUs, Transaction Classes, Reserved CUs, Natural Language Translations etc. In NSL, general entity creation, updating of entity by adding a new attribute, updating an entity by adding a new sub-entity, updating the entire entity, creating a basic change unit, updating a basic change unit, updating a CU by modifying the participating items (for example, attributes) in its layers, updating a CU by modifying layers, creating a GSI, updating a GSI, adding a recursive CUs, adding alternative CUs are done by using JSON (Java Script Object Notation) schema and other known ways or methods. NSL-TF architecture comprises a Core and Transaction. The Core comprises a CU Service, a General Entity Service, and a Contextual ID Service. The Transaction comprises a Trigger CU Execution Service and a DCD Execution Service. In NSL-TF, Databases hold information in all forms. The NSL platform provides for polyglot persistence. Polyglot persistence refers to the co-existence of multiple databases to support the runtime of the solution ecosystem. For messaging and other asynchronous use, TF uses Kafka and/or MQ (Messaging Queue) related technologies. For user authentication and authorization IAM (Identity and Access Management) technologies like Key cloak and Spring Securities are used. The NSL-TF architecture is operatively connected to multiple modules as represented in FIG. 11.

Animating Natural Languages: This is a process that enables any solution to be built in less than 1% effort as compared to conventional ways. Even complex solutions can be built using NSL paving the way for elimination of programming code completely.

True nature of entities and combinatorial entity states (CES): In NSL, entities are categorized into either independent entities or attributes. All events happen at one of these levels altering the CES, creating a loosely joined but a unitary environment. Sometimes, there are local tightly joined situations between independent entities and attributes. With that exception, when entities or attributes consume events, they do so at a standalone level. These events happen based on qualifying criteria. Such fulfillment of qualification settles reality at one or more shades of reality level. When the standalone entities come together, they create a CES. Just as standalone entities have their properties, the CES also have their own properties and identities. This logic applies equally to the extended CES also. All CES are like portions of video films consisting of many frames. Interestingly, there could be CESs within CESs. Such sub CESs are ignored for the purpose of simplicity as they do not alter functions. For example, the vantage point is an independent entity, i.e., a pen. In one instance, the pen may have two attributes, ‘color red’ and ‘material plastic’; both are at the primary attribute level. In this case, the sub CES from the vantage point of the pen is itself and the two attributes at the primary level. In another instance, the pen may have ‘color red’ at the primary attribute level and ‘color deep red’ at the secondary attribute level. In this case, the sub-CES from the vantage point of the pen is two attributes at two different attribute levels. In both these instances, the sub CES is taken as implied and disregarded as there is no material difference it makes for the trigger function of the CU. In this conceptualization, the vantage points of non-trigger CES, trigger CES, extended CES, and the GSI will treat all the lower vantage point attributes, independent entities, and CES as their attributes. Contextual to any chosen CES vantage point, all the subservient attributes, independent entities, and CES that are required to turn to a state of reality for the contextual CES to turn to a state of reality are considered that contextual CES attributes.

The Magic Mirror: ‘Animating natural languages’ is one powerful way of explaining the true nature of NSL. Another equally powerful metaphor is the visualization of NSL as a magic mirror. Thousands of natural languages have been tested for their ability to represent all things in the real world effectively for thousands of years. In one sense, natural languages are mirrors of entities in the real world. One thing about a mirror is that it captures all physical images accurately. But it is just a mirror. The entities in the mirror reflect, and are influenced by, entities in the real world. But for all practical purposes, mirrored entities do not influence the entities in the real world. It is a different story when it comes to the magic mirror. This magic mirror is made up of controlled electromagnetic forces. Such control is obtained by many levels of abstractions in the ‘information technology’ mirror. By coupling these controlled electromagnetic forces with many levels of abstractions, and the natural languages, NSL makes a magic mirror a reality.

Different levels of abstraction that lead to the functioning of a computer: Abstraction is an old paradigm terminology, which is same as different levels of representations and equivalences in NSL terminology. All computer logic is ultimately translated to binary code of zeros and ones. The language that directly imparts logic to the computer through binary code is called the machine language, which is also called as machine code, object code, low-level language. There is yet another low-level programming, which is called assembly language. Assembly language is intended to directly communicate with the hardware. Compilers are themselves programs that help translate any program code to machine readable and executable code. Operating systems manage all other computer application languages. The application programs make requests to the operating system through APIs. The application programs are called higher-level programs, which can perform specific functions for end users or, in some cases, other applications. While there are many programs/language types, the ones listed above provide a broad computer logic imparting framework. All computer languages, other than application programming languages, have been standardized to the effect that they come integrated with the computer most of the time, and they remain the same irrespective of any kind of customized applications for the users since all those standardized and low-level programs are capable of being replicated without much human effort as these have also got commoditized. Application programs being unique to every kind of user requirement, millions of those are developed to meet the unique requirements of the users or there are standard products based on application programs still requiring heavy customizations. Other than technology hardware, application programming constitutes the bulk of the expenditure that the world incurs every year, which runs into trillions of dollars. NSL provides a way of standardizing and commoditizing any kind of application programming. It reduces the application development effort and adds value addition. In addition, it democratizes all applications by empowering people. This is accomplished through a few systematic steps. Firstly, NSL replaces programming languages with spoken languages through its inventive binary entity (BET) framework so that development time is reduced to less than 1%. Secondly, the NSL new paradigm seamlessly integrates itself with a rich BET library containing billions of solution BETs catering to every kind of application and solution scenario. Thirdly, it connects these billions of BETs to an exhaustive set of interrogatives coupled with answers. The result is NSL's ability to completely remove asymmetries between the human agents and machine agents.

Contextuality and Conditionality: Every entity is unique, and it has its own properties. In agent systems, entities are those that matter for the agents as they seek solutions. At the vantage points of agents, entities are mostly macroscopic. These entities are already made up of trillions of atoms and particles of different types. Innumerable discrete/distinct states contribute to contextual differentiation of the properties of entities. For example, a pen has a property of being able to write or a paper has a property of being written upon. Agents rely on such entities to meet their objectives. For example, a person needs only an apple to satiate hunger. In this case, trillions of discrete/distinct states in the form of atoms may have come together (combinatorial discrete/distinct states) to form an apple. But if the same person needs to write a letter, that person would now need a pen and a paper to write the letter. Just as ‘apple’ produces an event of ‘satiating hunger’, the combination of ‘pen and paper’ can produce an event of ‘written paper’. Note that entities in NSL paradigm operate with the principles of excluded middle. That is, the entities are either there or not there-in binary states. In any environment where solutions are already designed, classes are first created to facilitate arrival of members. In the above case, the apple class was first there (in potentiality) before the real apple arrived. Intermediary states such as ‘half an apple’ or a ‘quarter apple’ are not provided for. When the apple arrives into the class, it is known as an event that would have turned the ‘class apple’ to reality. If the apple departs, it is also an event. The ‘class apple’ is now devoid of its member, turning the situation to potentiality again. Two entities—pen and paper—are required to produce a desired event of writing a letter. NSL theory requires that the combination of ‘pen and paper’—that togetherness—itself has its own property. Since there are two entities in the form of binary variables, the combinatorial states from a solutions perspective can be in four different states.
1. Both pen and paper are in potentiality (Only the classes exist).
2. Pen has arrived as member hanging to the class pen, therefore, pen is in reality state and the paper is in potentiality.

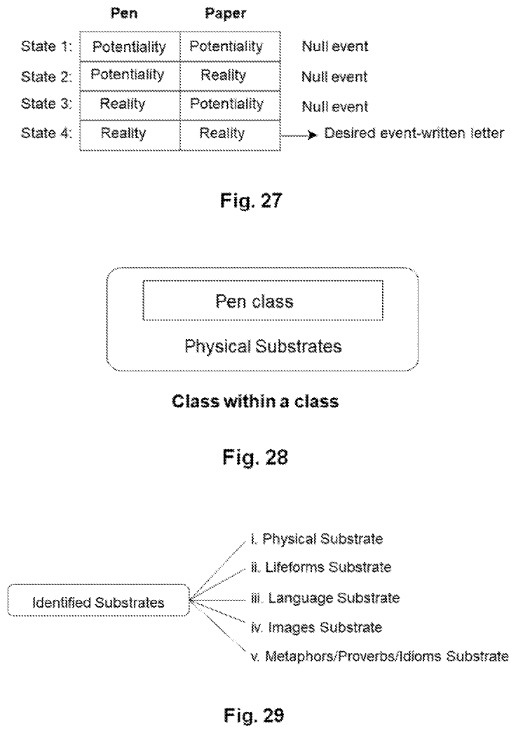

3. Another possibility is that the paper has arrived turning its state to reality, but the paper is yet to arrive.
4. The fourth combinatorial state is that both pen and paper are in reality.
   It is only the fourth state that has the ability to cause a desired event of ‘written letter’. That is, only that combination meets the condition of generating the desired event. The rest of the three combinations result in the production of ‘null-events’ (no events). The desired event and null events using pen and paper entities is represented in FIG. 27. The difference between a single entity model and a combinatorial entity model is that the events can happen individually with respect to each entity present in the combination. In other words, CES behaves like an independent entity but for the fact that it is made up of many loosely coupled entities and attributes. For all practical purposes, a CES made up of two or more entities operates as though each of the entities contained within it are its attributes. If one switches the vantage point and looks at things from the point of view of a GSI, all CUs and the entities contained in those together become attributes of the GSI. All combinations are contextual and relative that is, an entity with respect to others. But only the presence of all entities involved in the combination fulfil the ‘condition’ of triggering an event. If there are 10 entities in binary states, possible combinations are 2\hat{ }10 (1024 ). But only the 1024th combinatorial entity state fulfils the condition of triggering desired event(s). This is the primary difference between contextuality (CES or ECES) and conditionality. A conditionality is that contextuality that has trigger properties. Incidentally, if entities are in a state of ‘constancy’ (member always present in a class), the number of possible combinatorial entity states reduces accordingly. If nine out of 10 entities are ‘constants’, there would be only two combinatorial entity states, the 10th entity being in potentiality or reality and all others are present in any case. There are implied entities whose presence is taken for granted and are not stated. For example, one may take a table and a chair as givens with respect to writing a letter. The pathways of change are clearly laid down with respect to ‘machine agents’ such that when a condition is fulfilled, actions are automatically performed. In case of ‘human agents’, when the trigger conditions are fulfilled, it is generally supposed that the performer of a role can direct the change as needed.

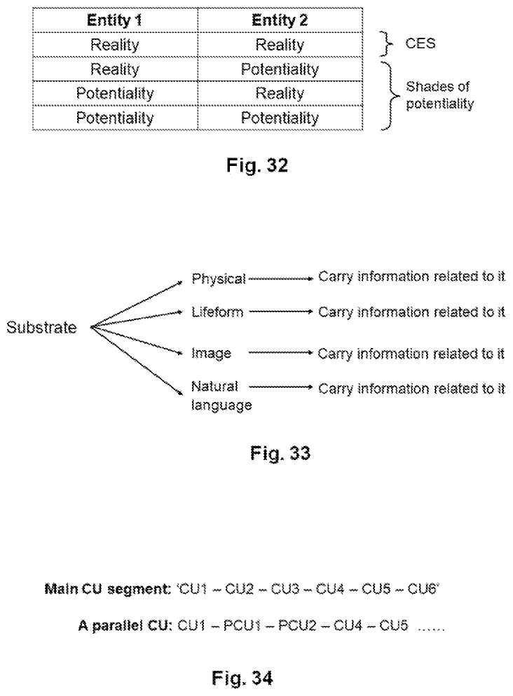

Shades of Potentiality Theorem: In NSL, a series of connected ‘BETs’ lead to a solution (fulfilment of a wish). BETs are connected as they are part of a CES in the physical layer of a CU or they are part of ECES (Extended CES). ‘BET’ stands for binary entity. ‘BETs’ toggle between a state of potentiality (where only a class exists) and reality (where the class has a qualified member sitting in it). This is synonymous with ‘bits’ (binary digits) in information theory where the binary variable accommodates either a ‘0’ or a ‘1’. The number of binary entity CES that the physical layer of a CU accommodates is governed by 2\hat{ }b formula where ‘b’ is the number of BETs in the CES. Example: If there are 6 CDs (change drivers) where BETs sit in the physical layer, there are 2\hat{ }6CES (64 CES). Of which only the 64th CES shall be in a state of reality (where all the CDs would have arrived) with respect to triggering and realizing an objective. An example of shades of potentiality in a combination of two binary entity model is shown in the FIG. 32.

Alternative CUs: One can call the CUs that belong to the same GSI ecosystem as connected CUs. If they influence things outside the GSI ecosystem, the influenced CUs are called ‘related CUs’. If the connected CUs belong to the same paragraph, such connected CUs are called sequential CUs. These are governed by the ‘AND’ function. The shades of potentiality theorem apply to these connected CUs. But it applies equally to all the GSI ecosystem connected alternative paragraphs (generated due to the influence of alternative CUs) also. Alternative CUs provide alternative pathways to GSIs, to be governed by the ‘OR’ function. NSL has already established a process for the count of number of pathways in the context of a GSI. The shades of potentiality theorem can be applied squarely to all the existing GSI pathways.

Parallel CUs: Connected CUs are those that belong to the same GSI ecosystem. The GSI ecosystem includes the main GSI or those that accommodate alternative CUs and alternative GSIs (different scenarios relating to the main GSI). For example, deliver with ‘cash payment’ or ‘credit card’ payment. It is sequential CU (AND) functions that lay down the pathways all the way up to GSI, and alternative CUs (OR) and sequences connected to that lead to the same or alternative GSIs. Each alternative GSI is a separate paragraph, but one that belongs to the ecosystem of connected GSIs. If the events generated by a CU cross the boundary of connected paragraphs and influences events in other paragraphs, those events are called related events. In this background, NSL assesses the qualities of ‘parallel CUs’. An example of the Parallel CUs is shown in FIG. 34. Parallel CUs have two characteristics: 1) The trigger of these CUs is independent of triggers in the corresponding CUs. 2) For the GSI as a whole to be realized, all the parallel CUs should also have triggered. This is how parallel CUs distinguish themselves from ‘alternative CUs’. In case of alternative CUs, once one path is taken, the other path loses its significance. But in case of parallel CUs, the branch to which they belong to also persists for the GSI to be realized. Parallel CUs belong to the main or alternative paragraph of the same connected GSI ecosystem. Parallel CUs are branches of the main or alternative paragraphs wherein they run parallel to given segments of the main or alternative paragraphs.
1. Parallel CU branches: These are made up of one or more CUs.
2. Main CU Pathways: The segments that belong to the main or alternative paragraphs with respect to ‘parallel CU branches’ are called ‘main CU pathways’.
3. Parallel CU Branch Emanating CUs: These are the CUs from which the parallel branch emanates.
4. Parallel CU Branch Culminating CUs: These are the CUs into which parallel U branches culminate.
   Example: Assume that ‘CU1-CU2-CU3-CU4-CU5-CU6’ represents a GSI. There could be a branch emanating from CU1 that has a characteristic of being a ‘parallel CU branch’ corresponding to a ‘main CU segment’. It could flow in the following manner. CU1-PCU1-PCU2-CU4-CU5 . . .
   Wherein PCU stands for ‘parallel CU’. In this example, ‘CU2 and CU3’ represents main CU segment, PCU1 and PCU2 represents ‘parallel CU’ branch. This parallel CU branch emanates from CU1 and culminates in CU4. This example is represented in FIG. 34. Shades of Potentiality Theorem in the Context of Parallel CU Branches: Standard ‘shades of potentiality theorem’ is as follows:
((2\hat{ }(b−c−e))×(2\hat{ }(b−c−e))+(2\hat{ }(b−c−e))×(2\hat{ }(b−c−e))+(2\hat{ }(b−c−e))×(2\hat{ }(b−c−e))+(2\hat{ }(b−c−e))×. . . (all the way up to the final CU) . . . (2\hat{ }(b−c−e))+(2\hat{ }(b−c−e)))−1
   The ‘parallel CU branch’ creates a new pathway with respect to the GSI. In those instances, two pathways come to exist. One pathway is with the ‘main CU segment’ in it and another with the ‘parallel CU branch’ in it. The ‘parallel CU branch’ is CU1-PCU1-PCU2-CU4-CU5 . . . In this example, the path culminates in CU4. Parallel CU branches contribute additional shades of potentiality to the ecosystem of a GSI. The theorem for the additional shades of potentiality is exactly the same as what ‘shades of potentiality theorem’ dictates. One needs to use the theorem's mathematical segments for each PCU and the culminating CU, right after the culminating CU.

Shades of Reality: The shades of reality addresses the question of what qualifies to be a member of a potentiality BET. If the color red is the potentiality, then only the red color qualifies to be its member. But if potentiality BET is an even number, there can be infinite even numbers that would qualify as a member. In this case, the shades of reality are infinite. BETs can allow any number of shades of reality depending on degrees of freedom in a given context. From the system perspective, both the shades of potentiality and reality are traditionally called data. NSL provides an ability to perform analytics on the data in the various shades of reality using all known statistical applications. Since the shades of reality has the possibility of providing data at the smallest vantage point i.e., at attribute levels.

Life Cycle of an Entity: Every entity in the solution ecosystem also has a lifecycle associated with it. Solution level entities tend to live for longer as compared to transaction level entities. Some solution components (say, given CUs) may last for a long time as compared to others. Every entity (solution entity or a transactional entity) will have a date of birth (creation time) and date of death (deletion time) associated with it. Deleted entities can persist in repositories as may be determined by the designers. When an entity is modified, the old form is dead (deleted) and the new form is born (created). A transactional CU lasts only till such time the transaction is completed. Not all entities are equally active. This applies equally to solution class entities and transactional class entities. Some entities are used extensively. If an entity is participating in a trigger state, it is active—otherwise idle.

NSL APIs: The success of NSL significantly depends on its ability to coexist with other solutions environments. Its ability to seamlessly integrate with other solutions and solution components such as webservices, is vital for its success. NSL contributes to other solution environments and equally benefits from them. NSL APIs preserve the purity of the NSL framework by using only natural language constructs in the process.

NSL Grammar: The objective of NSL grammar is to lay ground rules or constraints or limitations that would animate natural languages for the purpose of dealing with solutions. NSL grammar is a grammar within the natural language grammar. In other words, NSL grammar is about rules or constraints or limitations within rules or constraints or limitations. For example, NSL grammar shall respect the natural language grammar while it overlays its grammar on top of it. The sentences formed by NSL shall still be grammatically correct from the natural languages' perspective. There are some permitted liberties that NSL takes within bounds for the sake of dealing with solutions effectively. NSL is predicated on the belief that natural languages (in conjunction with mathematical constructs) are also a form of code. Every person is familiar with this from a very young age. This is the reason NSL uses the word ‘natural’ when it refers to these languages. Programming languages that are artificially created, and are another form of code, have dealt with ‘solutions creation’ right from the inception of information technology. However, they have alienated human agents from machine agents. NSL corrects this anomaly. It makes solutions fully transparent and many times effective. NSL and NSL grammar take natural languages and convert the parts of speech into BETs. In so doing, NSL animates natural languages to develop solutions of any complexity in any of the natural languages.

Turning the Dial: In NSL, the teams have put the toggle from fat to flat sentences on a firm ground. In NSL, there is a process to convert ‘fat sentences-to-programming-languages’ and ‘programming-languages-to-fat-sentences,’ for all languages. NSL intends to turn the dial so that one can build solutions in natural languages directly (flat sentences) and toggle them to network of nodes structures (fat sentences). It is established that NSL grammar-based solutions will accelerate the process of developing solutions to a significant degree and solution development is more intuitive and fun.

Asymmetries between human and digital agent interactions: Agent interactions are not confined to external agents alone. For all practical purposes, there are dual mode internal agents are present in NSL as well. One is the questing agent within NSL. Another is the answering agent within NSL. The NSL uses these internal dual agents quite extensively. For example, these dual agent interactions happen in a batch mode in the following manner:
a) A questioning agent asks oneself, ‘What shirt shall I wear today’?
b) The answering agent says, ‘Let it be a white shirt’.
c) The questioning agent will further ask, ‘Is it the new one or the old’?
d) The answering agent says, ‘The new one’.
   The matters may settle there or go on in batch mode for a long time.

### Process vs. Structure

There is no fundamental difference between a process and a structure. They are about connected classes or constraints. Connecting more classes leads to further differentiation.

Consider the example of 10,000 square meter tiles of equal area covering a hectare of land. The tiles are numbered from 1 to 10,000. Consider the tile number 4535. It is surrounded by eight tiles. The objective is to find the shortest path between the 4535th tile and the 10,000th tile. This can be achieved by repeatedly choosing the correct neighboring tile leading to the 10,000th tile. Each step taken has a previous tile connected with it and a desired next tile connected with it. The approach used in this solution is referred to as a process.

An alternate method to reach to the 10,000th tile is to label the start segment. The destination tile is labelled as the end segment. The 10,000 tiles are divided into 100 segments of 100 square meters each.

In this approach, the solution can be reached in 6 to 7 discrete moves by choosing the correct segments. This method of arriving at a desired solution is called the structured approach.

In the case of a process, each step must be connected and the direction of change must be right. In a structured approach, only the direction of the movement is considered. In both cases, there is prevalence of classification.

In a process, the classes are connected with each other underlying the cause and effect principles. In a structure, the classes are coarser and many cause-and-effect movements are taken as implied. The manner of arrival at the destination is also ignored.

In both cases, connectedness of classes results in directed differentiations leading to a solution.

SCUBET: Our universe is composed of entities. Entities are distinct and discrete. Anything in distinct/discrete state that is unique can be represented by natural language and anything in distinct/discrete state that is identical can be counted and represented by numbers. Therefore, discreteness is a subset of distinctiveness. Consider a universal set of pens. Three color of pens, red, blue, and green, can be considered as a subset of the superset of pens. Within each color of pens, the number of pens, say four blue pens, five red pens, and three green pens will form a subset of red, blue, and green pens. All entities exist and interact in space and time. If the space surrounding the entities is conceived as a cube, the interactions of entities within the cube give rise to different transformations in BETs, leading to the realization of an intent. The cube that encompasses the space and time is called the SCUBET, where S stands for space and T stands for Time. SCUBET can be divided into several smaller cubes at nano-levels, and pico-levels depending upon the objectives of observed states and vantage points. Each change arising within the cubes at different levels can be captured by the SSA cycles. For example, in Genome mapping, the physical distance between known DNA sequences (including genes) are worked out by the number of base pairs (A-T, C-G) between them. Three sets of such base-pairs are mapped into one of the 20 amino acids. Such techniques are used in DNA finger printing. NSL SCUBET can scan through a 3-dimensional environment for interactions and connections at different levels of depth from the nano to pica levels; select members that matter to the solution; act in a directed manner to accomplish the wish of an agent. NSL SCUBET reimagines solutions embedding both the space and time into the solution with measurements at the source.

SCUBETs: SCUBET stands for a spatial cube with time. SCUBETs are conceptualized to act as four-dimensional CUs. In NSL, CUs have been viewed as two dimensional nodes with interactions in two dimensional surfaces. Space and time entities in CUs are implied as there is difficulty in generating transactional values for them on an ongoing basis. Through SCUBETs, NSL brings the true nature of space and time to play. Space-Time is a four-dimensional structure with three dimensions of space and an additional dimension of time brought together in line with Einstein's determination. The BET structure provides for four-dimensional space-cubes-and-time (SCUBETS) i.e., three dimensions for space plus time with permitted drill down to any level. The advancements in the digital world with the concept of metaverse contemplates to create four dimensional digital spaces. Metaverse layer creates three dimensional cubes of any size adding time inside them. It can be achieved through CCTVs or marking spaces through point clouds. For example, imagine three-dimensional digital meter cubes being kept in place. This can serve as a digital representation of the four-dimensional real world. All the entities present in these SCUBETs have the digital versions of all the physical entities. Agents can control change in four dimensional CUs. Space and time are no longer implicit, but are active participants in creating solutions as explicit BETs. Through this model, it is possible to make solutions leap out of the two-dimensional screens and seamlessly blend the physical and digital representations. The digital representations can be real participants in the functional CUs, and the physical entity counterparts can be their representational counterparts. The lines between the digital and physical is blur, as the lines between the real and the representational only have a contextual relevance. When the truth values between the physical and digital are tightly established, there can be an emergence of machine agent dominant world. Machine agents track changes first at higher vantage points of SCUBETs and then do a deep dive as needed. For example, if there is no change at a meter cube level, there will be no need for a deep dive. If a change is noticed, the machine will deep dive into the decimeter cubes (as there are thousands of them within a meter cube) to understand the true nature of the change. If a change is noticed in a particular decimeter cube, the machine can further deep dive into the centimeter cubes within the decimeter cubes (where there are thousand cubes within). Effectively, the granularity of administered change can increase a millionfold throwing up unprecedented opportunities for drawing inferences and directing actions.

BETs creation and operation: BETs creation and operation are important. For example, if a switch is on, it is a reality BET. If the switch is off, then it is a potentiality BET. BETs creation includes BETs connections. These conditions lead to one or more events and can be termed as solution-level BETs creation at a centralized level. For example, the central switching station of an apartment. Every connection is an event. NSL environment has BETs creation and BETs operation. BETs operation is based on reality. This lies within a potentiality stream. The potentiality stream consists of solution maintenance, operation, and planning.

The operational BETs are part of the solution BETs. The type of solution depends on the type of species. There can be more or fewer transactions. If things remain same, then one can produce the maximum number of transactions. These are transactions of value. The stakeholders benefit from it and will reciprocate. This is the source of revenue and profit. The costs concerning the solution stream get absorbed by these transactions and produce revenues. One can have an opportunity to reduce the fixed costs, enhance revenues, and profits.

One can develop solutions without creating new BETs. If anyone is creating new, then the cycle time for creation and the costs are more. In the NSL environment, everything is accounted as BETs. One should account for solution BETs. The transactions create value. BETs feed each other. For example, one can consider the BETs account for the benefits and not miss something. If one may miss something in a value sense, then BETs sellers do not take these BETs into account. One can balance the books from a value perspective. One can identify things that exists with reference to value, not with reference to BETs. These identified things make the BETs complete.

If one does not see the BETs, it does not mean they do not exist. One can predict things about the BETs based on the available information or on the study of the past. Whenever anticipation is grounded, the principles are well understood. One can handle the process for the machine agents.

The BETs are in a binary state. For a vantage point, the attribute is at the last level. At the lowest level, it is in a binary state. One can move up the vantage point to a CES, which is made up of many BETs. A number of these loosely coupled BETs transform themselves into reality states. The CES should be in a reality state. There are large number of shades of potentiality that have to cross. The NSL system is primarily based on conditions based on CU or at GSI level. At the higher vantage points, the zone points are driven by aggregates. This is connected through nearest neighbors. The connection starts at the attribute level and entity level. A CU first triggers and then aggregates. Aggregates arise out of the differentiations being systematically derecognized. The new information comes in the form of potentiality or reality. If one can systematically recognize it, the nearest neighbors will become identical. The systematic things are derecognized, and the identical things are represented through numbers.

A word is an abstraction and representation of unique characters. A number is a representation of identical characters. Recognizing the information systematically from an agent's perspective is important. One can generate the aggregates and recognize the information. Once GSI is completed, a transaction is completed. One can recognize a principal node that is in reality state and with no information. Any information counts as one transaction is completed. If thousands of transactions are completed, one can count them as thousand transactions.

Aggregates are under the BET and can be individual or collective. The aggregate is expressed as in attribute. The attribute quality is not different. It includes color for a physical object. The color replaced with number aggregates is equivalent to less than 100, 200, and 300. The set is the equivalent of an attribute trim. The established color string leads to reality. This information is valuable. It generates insights and actions.

One can have different differentiations with given properties. The set is made up of aggregates and has its own properties. Aggregates hanging to given classes are same as the gates hanging to certain BETs as value. One cannot separate it out. There is an entity to assume, and aggregate is at the minimum. It is implied not to show one aggregate as an attribute.

There are cycle times associated with BET. Everything is in a binary state, except it is a constant. A BET is turn to reality or reality to potentiality and an event is necessary. An event is output. Trigger states coming from preceding have properties like cycle times. These things take minutes and hours. It is driven by machine agents that take a fraction of seconds. The objective is to maximize the number of BETs driven by machine agents. The effort is minimized, and the net value is maximized. The costs is low and realized value is high.

Cycle times are connected with BET. There is anticipation for the cycle times known as budgeting. For example, one can expect this to be done in 5 minutes, it took 7 minutes, which is the reality. The ideal times are both at solution levels and transaction levels. The solutions are at higher vantage points. For example, everything starts as a class at a country level, then descends to a state, city, street, and house. The House level is where the transaction gets conducted. The higher-level vantage points and the transactions are being grounded. There are combinatorial entity states. For example, one can have a state, city, and street level. The agents have roles and one can branch them.

Higher vantage point BETs come as a string of lower vantage point BETs: The higher vantage point BETs are so valuable, and these BETs take to the doorsteps of any new solutions. If the lowest vantage point is an image, higher vantage points are like Videos consisting of many lower vantage point frames. These frames are like attributes of independent entities.

BETs create channels of value at all vantage points: The way value channels exist at every cell level and the organ level, in a similar manner, Nature is filled with BETs, which are influenced by energy and create random channels of change. One of the millions of channels ends up delivering a value to agents. Agents attempt to control those channels of change to obtain a value for themselves.

Every BET has layers of natural languages and programming languages: Each of these BETs has sublayers of specific languages. Each of the BETs has a bundle of programming language code wherein one specifies the nodal structure syntactically, and another fills the nodal placeholders semantically to complete the flow of logic.

Every BET is a fractal of value flow: The BET structure is differentiated by the relationships it forges with other BETs. Depending on the nature of the relationship, the structure of the BET is a sequential, alternative, parallel, embedded, nested BET, or a BET belongs to different vantage points such as CU, GSI, and different superordinate levels. Each of these BETs is labeled with its unique properties (the way they interact), which are aptly provided for it. Likewise, every BET could have any number of layers and sublayers (a few sublayers have already been identified as IRDR, ML, Blockchain, etc.). The BETs in these layers have relations with the principal BET that they belong to, as well as the other BETs in the layer they belong to as the context demands. Each BET in each layer has its own property. All the BETs in the layer together have a collective property. Some of the layers together are labeled as Functional layer, UI, and IRDR. The conceptual groups are new technologies, support functions, and representations (natural languages, programming languages, and images). When the framework is provided for all the identified layers and sublayers, most of the layers could be switched off if the situation does not warrant their presence. Incidentally, voice as a layer can be attached to BETS immediately without much effort as it is NSL's determination, and the parts of speech are also BETs. All CES and ECES are only composites of such parts of speech or individual BETs. Take voice from the dictionaries that have pronunciations of each word and attach them as layers to each BET. It is enough if it is done for attributes and independent entities. The rest are composites of the same. All the millions of BETs in the BET library have their counterparts in voice. If there are mandatory layers connected to the chosen principal layer, the triggers will happen only when all the BETs in the mandatory layers turn to a state of reality. In other words, all entities in the mandatory layers operate in real-time. All other activated layers such as machine learning would operate in batch modes. On set conditions being fulfilled and on the occurrence of specified events, these layers would generate additional insights. Those insights can serve as additional information when pushed to the qualified agents for their use as needed, or at times, these insights would be automatically delivering additional value.

BET fractal emulates a neuron: The DCD (Drivers of Change Drivers) is like a neuronal cell of the body. The pathway of change that influences one or more CUs is like an exon. The event ending at the other CU is like a synapse. The potentiality state of the BET in other CU is like a dendrite that connects with the synapse of the connected neuron that fires when the action potential builds up in it.

In solution design, if the transaction happens at the house level, the region and space are at a lower vantage point. This applies to time and people. Transactional level BETs from a language perspective become bits. For example, a person versus the person and a time versus the time. When these things combine, the differentiations are large. In the case of space and time, together they never replicate. There is space and time in the universe lifetime. For example, a person is at some place at specific time because time is flowing all the time. There cannot be any other ‘same’ time and space. When one can combine with other loosely coupled entities, everything gets differentiated.

One can define things with degrees of freedom from country level to a street. There are degrees of freedom at the lowest level. For example, a house is a binary entity with employed classes in it. The house is in front, and the rooms are at back. There are degrees of freedom with a branch and are in a binary state. The system works in a range. If a subclass shows an error, then the system sets itself up for the new transaction. These are referred to as permitted values. They can arrive into the implied subclasses and are qualified values.

If the chain of BETs and value is unbroken, the transactions are settled and move to the past. A present is a construct of the solution designer. The NSL environment introduces past and future hours. If it is at the day level, then it is yesterday and tomorrow. There are cycle times involved in solution BETs. One can analyse transactional bits and the cycle time. One can observe the cycle time between two transactions. For example, if the first transaction happens at 10:00 hours and the second transaction happens at 10:30 hours, the cycle time is half an hour. There is a given variance that captures its statistical levels. With ideal times assessment, the BETs are driven by mission and human agents. For example, one has bought a pen rather than manufacturing it. At GSI level, the BETs are accounting, and value accounting.

Clarity is grounded in the normalization processes of grand reconciliation. Everyone wears the consumer hat with value creation. The human agent is consuming the mission. The value agent generates an output. With the input and output from the vantage point perspective, one can relate to how the system works. For example, a person is an agent wearing the hat of receiving inputs. The agent is split into two personalities-value consuming and value producing. One can hand over his/her output to someone in the next scene. One has generated the CU value and the structure is completed.

The functional layer generates events like trigger CES. A state change means there is a change in effect. There are differences. They generate null and signal events. For example, whenever a state changes from 1, one may not always move to two. When one moves to 1.1, the other one moves towards rounding of the system.

An event happens in the functional layer. In the presentation and measurement layers, the communication happens between the two. One can filter the information, whether it is in the functional layer, informational layer, or UX layer. For example, in cooked food, one can process the ingredients and then present it to consume it to satisfy hunger.

BETs have three kinds of relationships. 1)The first relationship is equivalence. For example, ordering and drinking water. 2) The second relationship is by virtue of coexistence. In a CU, if A, B, C, and D entities are coming together, they are all coexisting in that context. 3) The third relationship arises out of the interactions. Here, the properties dictate the nature of the interaction. All potentialities are realized as decided. Every switch at potentiality is a class. In an optimal solution, the last BET is fully established and making a complete solution. The three kinds of relationships are as follows:
a. Equivalence relationships: Agents have evolved to take advantage of established correlations between entities. There are advantages of establishing equivalences between a person, person's name and person's image. Each one of these correlated entities has the property of establishing an equivalence. It means that one can refer to an entity by examining the correlated entity. For example, if one asks who is John, only one out of 100 people would be accurately picked. Similarly, if one asks what the name of a specific person is, only one out of 100 names that were displayed reading John would be picked. Furthermore, entities that represent each other could have properties of their own independent of the property that established equivalence. For example, there could be a live person John and a correlated entity in the form of a statue of John. John has his own properties such as his own weight, 100 trillion cells he is made up of. The statue of John has its own properties such as its own weight, shape, and size. All correlated entities are physical. Nothing can escape the fact that all things have to exist in space and time and all things are made up of particles. While John has trillions of atoms that constitute him, the name John written on a piece of paper would have billions of ink related particles that are also physical. A real entity is defined contextually based on what matters for the CES placed in a given CU.
b. Coexistence of Relationships: These are non-trigger CES in the context of defined CUs.
c. Functions (Extended coexistences or Extended CES): Relationships arise out of trigger CES causing changes in CES in one or more CUs, including itself. Entities or CES leading to other entities or CES are also called functions. In spoken languages, these are equivalent of verbs.

The BETs are always in binary states, whether they reside in attributes, entities, Combinatorial Entity State (CES) or Extended Combinatorial Entity State (ECES). A solution stream includes the creation of solutions, maintenance of solutions, and planning for operations. All BETs reside in the same stream and more classes are brought together while adding one class with another. A class is selection of many or fewer possibilities. As one keeps on adding things, one can create an algorithm. The solution events are operational and transactional events.

If one starts at a higher CU vantage point, there can be many branches of the CU operating at different levels. The agents perform various tasks and are embedded in the CU. At the transaction level, one can recognize information based on different things. Recognizing information or ignoring information is also equally important. Identical things are represented differently through numbers, whereas unique things are represented through words, and therefore every transaction becomes unique.

At the solution ecosystem level, one can observe things from the organization's vantage point. One can measure environment inside and outside the organization. Therefore, any entity that comes into the environment is considered as an input. One can generate a profit and loss account statement by taking all the inputs from the external environment. For example, if a pen has come from an external environment, it is counted as an external input and it is classified as a consumable. If some machine is bought, it is considered as an external input and goes into the category as an input. If the organization buys software licenses, it belongs to the same category.

One can quantify the constants, variables and everything should be contextual. One cannot ask questions outside of the context. Everything is context driven with nested methodologies. The BETs are distributed over different functions and collectively express themselves at the solution level. The BETs capture knowledge at the solution and transaction stream level.

One can deal with horizontal and vertical enterprise grade solutions. One can have established sequences that exist between environments. One can currently make many intelligent systems within the NSL environment, for example, chat bots, analytics, and so on. One can hand over many functions to the machine agents. One can have to operate with the boldness of vision. If one can have clarity, then he/she can create logical extensions of the functions that can lead to the destination. All the interactions happen within MCC. At every trigger, the BET changes its status. In the NSL environment, MCC is customized to meet the requirements of every internal and external stakeholder in a web as well as mobile environment. All interactions happen in a transparent and contextual way securely based on IRDR.

The NSL and accounting come together with an accounting established system. A paradigm has BETs and values. The accounting brings these two disciplines together. One can account for BETs in a solution or transaction stream. BET is valuable and attached with the value. The value is attached to an exchange medium from a monetary perspective. One can attach rupees or dollars in the exchanger medium.

One can apply the search engine concerning reference trait. In the NSL environment, language is a trait. The NSL environment has mandated where additional information may rest and properties driven by it. Everything must be translated to the reference frame substrate, which is the natural language substrate. The judgments are made based on the additional information.

A blockchain layer connects with the given CUs. Every CU has a footprint of its own. The owner is an individual or a team. If it is between the CUS, a team like a delivery person, a supervisor, and a manager, connects the CUs at different vantage points. The footprints of the team and agents in all cases are recognized by the machine with timestamp. Those are solutional or transactional BETs. Within the organization, everything is connected to CUs and agents to another. No value is delivered without a given set of CUs having invoked. These occasions are not limited to those CUs that directly pretend to external stakeholders. The blockchain connects every CUs with an NFT. For every standard, there is a shadow blockchain system. At the operation level, blockchains consider everything that is secured and distributed. In the NSL environment, one can create a cryptocurrency and assign a token. These tokens can exchange rewards directly and attach the monitory value. The tokens are assured in a manner that if a standard work is done, several tokens can be issued.

In the context of agents, it is some of the distinct, discrete states are of great value. Some of them are formed from the point of view of evidence and proof. The information is on an evidence base is called knowledge. It is connectable to basic science. The structure for capturing the bets is established at a basic science level.

The next layer is the knowledge layer to the concept layer. The concept layer is inventions and innovations. It arises out of finding some applications that are creative and valid bringing them up to prototype level is equivalent to NSL.

The solution BETs are hanging to the concept BETs. The concept BETs are hanging to knowledge BETs. The concept BETs are superset of solution BETs. The solution BETs are superset of transactional BETs. Between the concept, solution, and transactional BETs everything is covered. Any action that leads to revenue has been addressed and the machine agent understands it. It can make engagements. Every BET is coupled with a value that is expressed by the way of financial or monetary values. The value and BETs are tightly coupled. A value represents the weightage. For example, there are two BETs. One is a car BET and another is a pen BET. Car BET has a weight of 10 lakh rupees and pen BET has a weight of 100 rupees.

In this century, the opportunities for creating values are centred around knowledge. The stalking trade is knowledge. The focus is on making sense of it by doing all things necessary to make machine agents fully understand. A conceptual framework drives the same through controlled and programmatic forces. For capturing knowledge BETs the world has provided access to expanded knowledge through scientific papers in the public domain in a well-tested manner. The solution has been provided by nature which is called life. One can capture all the knowledge that exists across the scientific papers. The system auto generates alternative pathways. Every correct path is the equivalent of tested knowledge through the five potential answers, out of which one is right. It follows core and fundamental things among many possibilities and only one or few being right.

Contextuality of BETs: NSL applies contextuality to BETs in the similar way of determining a type of CU contextually. In NSL, an attribute itself is contextual. For example, red color is an attribute of a pen. However, it can even be the case that red color is an independent entity, and it can be expressed as an attribute in the form of a pen or a pencil. Similarly, the independent entities namely pen, paper and person could lead to a combinatorial entity state (CES) which itself has its independent properties. All the independent entities in this CES contextually operate as though they are attributes of the CES.

Contextuality of Potentiality and Reality in BETs: In the context of solutions, potentiality BETs are those that matter for solutions; and reality is about the matter being realized. If the context is knowledge acquisition, the nature of the BETs changes accordingly. Here, potentiality becomes the knowledge BET (such as knowing that the sky is blue) backed by evidence. The reality status is obtained when a specified agent correctly understands (or registers) the true nature of the BET in the human brain. For example, if the agent considers the sky color to be brown, membership criterion is not fulfilled; if the agent correctly registers it as blue, membership criterion is fulfilled establishing reality of understanding. The contextual interpretation of binary potentialities and realities could be extended to all the layers of CUs including a machine learning (ML) layer. If a human agent expects a pen based on the given background information, the system considers it a potentiality. If the machine agent also correctly anticipates it, the potentiality pen attains a reality state.

Combinatorial entity states (CES) are always contextual. Coexistence of entities in solution environments are always contextual to what agents are seeking. What an agent seeks is a change contextual to one's own desire. Such change occurs when the conditions for that change is fulfilled in the form of desired combinatorial entity states (CES), where all the entities are in a state of reality. One can also call it a trigger state. When there is only one binary entity, and it is already in a state of potentiality, there is only one degree of freedom within the BET. This is the base level potentiality and reality relationship. If there is a CES consisting of 4 BETs, the number of states is 2\hat{ }4, which is 16. State sixteen, where all the entities are in a state of reality, is the CES reality state. All other combinations, 16−1 (the CES reality state), 15, are collectively the potentiality state. As there are potentialities that exist in different states beginning the base level potentiality, where all the BETs are in potentiality, one can call each of those potentiality states as the shades of potentiality. BETs can allow any number of shades of potentiality depending on degrees of freedom in a given context. An independent entity or an attribute's arrival or departure causes an event. Every causation event should result in an effect event. In a CU there are several BETs. Each causation event results in an effect event at CES level of a CU resulting in shifts in shades of potentiality. If CES state shift is a causation event, the causation CES event produces effect events that can be termed as null events in the case of non-trigger CES. Just as a ‘0’ (zero) is a number as any number in a number system representing nothingness. A null event produces an event called nothingness from a solution perspective. When triggers happen, those result in extending the combinations in the ecosystem of connected CUs.

The world is filled with several possibilities with respect to entities and their functions. Of that almost infinite set, a finite set of entities and functions are of a material importance for agents as they meet their desires or objectives. Agents have neither the processing power nor the energy to act upon what is processed with respect to all those almost infinite possibilities. Agents perform Sense, Select and Act (SSA) functions only with respect to entities and functions that matter. For example, imagine a combinational locker where there are six decimal digits. This gives rise to possibilities starting from 000000 combination, all the way up to 999999. Assume that only 999999 combination matters to a person. The remaining 999999−1 (999998) combinations represent chaos, and there is only one combinatorial number that represents order. 999999 is like a password to open the locker that delivers the wish. Only human agents, machine agents (as directed by human agents) and nature agents as directed by evolutionary processes over billions of years have come to overcome this randomness prevalent in nature. The independent entities and attributes are like individual digits in this combination locker. The CU represents the locker that is awaiting the right combination. Each BET is like a binary digit rather than a decimal digit. Connected CUs are like lockers within lockers leading all the way up to the innermost locker which is the GSI. These combination lockers are of varying sizes. For example, some with three binary digits and others with eight binary digits. NSL reduces all solutions to desired entities and their relationships.

An event is any change occurring in the solution ecosystem: An event pertains to either a change arising out of the creation or deletion of BETs in the ecosystem. The creation and/or deletion of BETs either pertains to Solution BETs or Transaction BETs. The events that pertain to the operation of transaction BETs also. The operations result in change either in the shades of potentiality or in the shades of reality. There are instances where the outputs at a GSI level could become an input constant for every transaction that depends on it. For example, a testbed preparation goes through both the solution creation stage and the operation stage, resulting in the test bed. Once the testbed is ready, it becomes a constant across many transactional BETs pertaining to the operations of the bed. This essentially means that one could use that test bed. These scenarios are also encountered in the manufacturing of machines. Once the GSI produces a machine, the machine becomes a constant across the transactions. The Solution BETs are direction setters. The Transaction BETs are those where the direction is specific to qualified transaction agents. The transaction agents are further narrowed down to the classes to fit their situations. For example, if the solution class specifies that deliveries are at home, the delivery person could self-impose that delivery will be only in the living rooms. The transaction agent has the liberty to do as he/she is not stepping out of the class of home. He/she is only creating a subclass within the class of a home called the living room. This does not cause any conflicts as the operations are within specified boundaries. The operations, on the contrary, are purely those that cause events to change the permitted shades of potentiality or shades of reality.

THE TWO WORLDS HYPOTHESIS: Human agents live in two worlds simultaneously. The two worlds are 1. The perceptual world 2. The real world.
1. The perceptual world: This world operates in a batch mode. In this world, entities and their relationships occur independent of time in a time-invariant manner. Lines between past, present and future are easily crossed. For example, human agents can pick up entities and their relationships from the past, transpose them with respect to entities in the present and anticipate the entities in the future.
2. The real world: This world operates in real-time. Everything is experienced in the present only. The entities and their relationships are here and now. The body as an actuator function only in this world.
Commonalities and Dependencies of the Two Worlds System: The OSSA cycles are common in both the worlds. Actuation in the perceptual world happens by way of a representational entity storage and retrieval. In the real world, transformations in entities happen as influenced by bodily actions. Both the worlds are mediated by the brain. There is a seamless exchange of entities belonging to both these worlds to beat dis-orderliness in the world and bring about orderliness directed towards realization of human agent objectives. The potentiality state in the BET belongs to the perceptual world and the reality state belongs to the real world. The emergence of a binary entity (BET) has its origins in the ‘Two Worlds Hypothesis’.

### Transitions and Transformations

Transitions: The changes within CUs are often known as transitions. For example, a pen is delivered from a store to a leader. In this kind of change, entities are changing their relationships with respect to space, time, and other entities. Incidentally, it is important that both space and time are also entities. One special quality of time is ever changing. The measuring tools of time are rhythmic. Given this intrinsic quality of time, even when the pen remains in the same place, one can talk about its existence using tenses—past, present, and future. For example, Pen ‘was there’, ‘is there’ or ‘will be there’.

Transformations: Transformations can happen when existing entities are created, deleted, or modified. When a letter is written, the white paper is deleted, and a written letter is created. All modifications involve the deletion of an entity and the creation of another entity. When the pathway of one entity is transforming itself into something else, that state is preserved in the system, and recording of that fact will give modification as a separate status.

Grounding of Solutions: Solutions can be grounded only at transactional levels involving transactional agents. This is predicated upon the fact that all solutions require directed change as mediated by agents and through the interaction of identified entities which are called as trigger CES. Space and time are also involved in all cases, whether implied or explicit. This proceeds from the fact that any change arises out of cause-and-effect principles. In this regard, a transactional agent and an operational agent are generally the same. A transaction creates a more granular transactional class required for the operation to take place for the creation of a transactional potentiality. The operation executes the transactional potentiality. The transaction potentialities are considered as transaction classes. The transactional classes are turned into reality as transactions.

All representational entities have their own properties: One of the properties is the property of establishing equivalence arising out of natural correlations (such as sunrise and daylight) or artificially prescribed associations (such as languages that associate a word pen with a pen). All representational entities occupy their own space and time. All representational entities have their own physical properties. For example, a person is made up of trillions of cells that in turn are made up of trillions of atoms. A person's representation, the name, say John, is itself made up of billions of atoms forming a pattern on a piece of paper. Such representational entities have their own unique properties like being erasable when written with a pencil. Among the representational entities with properties of equivalence, there is only one real entity as determined by the context.

Levels of representations or representations of representations or extended representations: Every entity can have one or more representations. For example, person, name, image, etc. Reality is through representations of representations that human agents are heavily dependent on. This is same as A being equal to B, B being equal to C, and C being equal to D. By extension, A is equal to D. ‘A’ needs to go through the transition representations in many instances to establish equality with D. One of the real-world examples is Light-reflecting-off-a-rock creates a representational counterpart of the light-reflecting-off-a-rock in the retina of the eye in the form of photoreceptors. Several other brain level representational transitions take place before the brain records the image as an extended representation in some molecular form. Representations of representations or extended representations are effective representational tools that human agents use contextually.

### Levels of Representations and Abstractions in NSL:

The levels of abstractions are stacked along these lines: Controlled electromagnetic forces either through different voltages or through regions of magnetization or demagnetization create two distinguishable states. These abstract states are tagged to 0s or 1s and are called bits. Once tagged to electromagnetic forces, bits acquire the magical properties of travelling at the speed of light or performing billions of functions in a second. A set of 8 bits is a byte. A byte represents a letter, a number, or a symbol. There is another attendant support, standardized and commoditized abstractions such as assembly languages, compilers, and operating systems. NSL Solution Operating System (NSOS) takes sets of bytes and equates them with the NSL constructs. These abstractions are contextually connected to a higher level abstraction in the form of millions of BETs in the NSL Digital Mind (NSL BETs library). The NSL Digital Mind attains a full-fledged agent status, ready to perform OSSA cycles. The asymmetry between the human agents and digital agents is fully eliminated. Interactions between the human agents and the digital agents can happen seamlessly as interactions happen between friends in the real world. Following the method of exhaustion, solutions can be grounded through an interactive QA (Question & Answer) session between a stakeholder seeking a solution and a representative of the NSL Digital Mind. A higher-level abstraction layer is added in the form of standardized QAs above the digital mind to establish human-like interactions with the digital agent. Each QA couplet progressively exhausts the uncertainty as the descent to the plateau of solutions takes place. Millions and billions of networked BETs in the NSL Digital Mind are analogous to a network of roads. Each BET is like a junction or a destination point (like a house). The lines connecting BETs are like roads following nearest neighbor principles. Each time an objective is born (like a desire to go to a destination point), uncertainty around realizing the objective is born. A series of QAs between informed agents determine potentialities for realizing the objective or the route to the destination. QAs are BETs, separated by higher level BETs like the highways, main roads, and sub-roads. The BETs grounded in CUs are like the inner roads and junctions closest to the destinations or the destinations themselves. It helps to imagine a well-directed question itself as aiding in reducing uncertainty. A ‘Q’ is like a choice at the interrogative crossroad, where the choice is to be made from Why, Who, Where, When, What, How, and Which. By choosing any of these interrogatives, the uncertainty is shrunk to a limited extent. For example, if the choice is ‘who’, all the other options are eliminated. If the answer to ‘who’ is ‘John’, then two classes are brought together as a CES, i.e., ‘Person John’. QA couplets repeat themselves till such time the BETs contributing to the solutions are fully grounded in the CUs.

Methodology of developing solutions: Interactions between the digital agent and stakeholders disambiguate all solutions in less than a few hours. This process can also be described as the descent from contextual uncertainty to solution certainties following the method of exhaustion of uncertainty through QA couplets. Relatively limited QAs, eventually through voice, will land a stakeholder at the closest BET. Last mile disambiguation shall not take more than a limited set of QAs to settle matters. When there is more than one contender as ideal BETs in the NSL Digital Mind, a rating system could be introduced to guide the stakeholders in their choices.

Every part of a speech is a BET: The parts of a speech get distributed contextually across layers. It is incidental that each of the interrogative words such as what and why are classes that define different kinds of uncertainties and serve as bridges to the resolution of uncertainties contextually.

Standardized solution development environment NSL Solution Operating System (NSOS): The old paradigm operating systems can be called as technology operating systems. In this new paradigm, the NSL runtime environment gets integrated with the NSL BET library that holds millions of BETs. These BETs are modeled after spoken languages that would provide for all conceivable scenarios and degrees of freedom around any solution development. This results in NSOS and getting standardized and commoditized like the technology operating systems.

Potency of natural languages or spoken languages is incredible: The languages as representational systems have stuck closely to the way world works principles. The fundamental structures across thousands of spoken languages remain the same. The English language classifies sentences into four types: prescriptive, descriptive (informational), interrogative and exclamatory sentences. NSL also uses interrogative sentences to complete a full circle with respect to spoken languages so that NSL becomes an effective representational system. NSL has accomplished by standardizing solution development, using NSL Solution Operating Systems (NSOS), which is placed on top of Technology Operating Systems (TOS) and (potentially) making billions of BETs to be placed on top of NSOS. NSL paves the way for democratization and commoditization of solutions by activating interrogative sentences. In so doing, NSL can ground any solution of any complexity in a matter of hours through agent-to-agent interactions. In the process, the asymmetries between human agents and machine agents are also eliminated. Agent interactions through question-answer-couplets address all solution requirements.

Agent interactions disambiguate solutions: In NSL, controlled electromagnetic forces are directly connected to structured spoken language parts of speech of NSL grammar. NSOS is a composite of NSL constructs based on the way world works principles. These NSOS constructs are classes of classes and are called BETs. By attaching the BETs library to NSOS, creating a digital mind that emulates the human mind and has a million times more solution BETs in it. Through the creation of the NSL Digital Mind, a digital agent is created, which can interact with human agents on equal terms. All the asymmetries between human agents and digital agents are eliminated. It is almost a fact that all solutions of human agents are obtained through inner agent (QA agents) interactions or external agent interactions (which include stored and documented knowledge about external agents). Similarly, all technology solution determinations can be done comprehensively through interactions between stakeholder agents and digital agents in a matter of hours. No other interventions are needed.

Human agents are controllers of electromagnetic forces to meet their end objectives: Evolution has influenced the development of human phenotypes. Digital agents also control electromagnetic forces to meet their end objectives as artificially created by human agents. In both human agents and digital agents, there are efficient agents and inefficient agents as against the context of an objective.

Words vs. numbers in NSL: Both information and solutions are contextual to agents. The entities are the creation of agents through a classification process. The language representations are perceived classes by agents. It is known that spoken languages represent entities in the real world. There are four types of sentences: prescriptive sentences, descriptive sentences, interrogative sentences, and exclamatory sentences. The descriptive sentences are treated as information sentences for convenience. Incidentally, NSL is doing away with the need for any new technology-based solution development by standardizing the process that is otherwise dealt with through higher level programming languages. It is the seamless combination of the NSL runtime with the extensive BET library, and this combination is called as NSL solution operating system (NSOS). The Operating Systems in the old paradigm shall be called the Technology Operating Systems (TOS) in this changed context. Just as assembly languages, compilers and TOSs are standardized and commoditized in the old paradigm, in the similar manner, NSL is doing the same to higher level programming languages as well by standardizing them and commoditizing them through NSOS. This technique is accomplished in NSL new paradigm through invoking the third type of sentence, interrogative sentences. NSL takes over the functions of higher-level programming languages and hands the same over to interrogative sentences. This method is called Solution Development Interactive Q&A Method (SD IQAM). There is a relentless interaction that occurs between the inner Q&A dual voices, supplemented by interactions with external people (whether those be friends, foes, or experts of the present or the past speaking through text or voice) until the satisfactory resolution to the problems is found. Through the Interactive Q&A Method (IQAM), NSL brings the digital agents also on the same footing and permanently resolves the problem of alienation of human agents from machine agents. NSL makes it possible for any stakeholder seeking any digital agent aided solution to come face to face with NSL digital agent and have a structure aided by a repository of Q&A and interactive Q&A Session (IQAS) following Interactive Q&A Method (IQAM). Each question and the ensuing answer will progressively shrink the uncertainty (following the method of exhaustion principles) with respect to the targeted solution. On all uncertainty being fully exhausted, the certainty of the solution shall stand realized. The fourth type of sentence, the exclamatory sentence, is same as a metric/measure in solutions parlance. All it does is to make the shades of reality with respect to any prescriptive sentence shrink and express a feeling around it. For example, a sentence such as, ‘it would be delightful if the delivery is done in less than 30 minutes. NSL has determined that all the prescriptive statements are animated, and will cater to any solution requirement. It is further supported by descriptive statements (information layer). If spoken languages are a combination of words and numbers, the words represent entities that are unique, and numbers represent entities that are identical. All solutions are a string of words or numbers following the framework as laid down by NSL. NSL first captures all solutions using spoken languages and calls those static sentences. It treats every part of speech as an entity and then structures these entities as belonging to different layers. NSL, thereafter, animates these entities by converting the same to BETs. The strings of words follow a hierarchy as a) Attributes: Attribute is the lowest possible vantage point. Its existence is not mandatory; b) Entities: Entity's existence is mandatory; c) CES: It is a combination or a set of entities and attributes and is same as a CU if it has trigger properties; d) ECES: It is made up of a set of CES; e) GSI: It is the ECES at the final solution or transactional destination; f) Modules: It is a combination of CUs or GSIs. The individual solutions and transactions happen in modules. In NSL, all things are contextual to chosen vantage points. If the vantage point is a CES, the entities within are its attributes. It means that all vantage point combinations ought to be assessed based on what it takes for those to be in a state of reality. Since it is mandatory for an entity to be in a state of reality for the CES to be in reality, it is automatically treated as its attribute. Based on this logic, CUs and their constituents become attributes of GSI. This is true all the way up to the highest vantage point. The direction of differentiation is set and unidirectional. For example, an egg can fall from a table and be broken, but a broken egg cannot jump to a table and become an egg again. In other words, the generalization and differentiation directions are set and absolute. If one looks from a certain general vantage point towards the differentiation direction, the differentiated node is many nodes away. If one looks from the differentiation node towards the general vantage point node, that general node is equally far. Words individually or collectively get converted to numbers when two or more of them become identical. Two entities could be identical by their very nature. For example, two white pens are on the table. The attributes and other vantage point BETs become identical when agents switch-off the differences between them. For example, when the colors of one white pen and one red pen are ignored, they become two pens. This type of switching off the information is called agents ignoring (masking/de-recognizing) information, which is done selectively and contextually by the agents. This technique is extensively used by agents to beat complexity, condense or concentrate information, minimize effort and maximize the utility value, based on principles of optimization. The extensive use of this technique gives rise to the dominant role of number play in everything. This technique has given rise to a very useful subject which is statistics. Since modules feed on GSIs, and group modules feed on sub-modules, the information overload is very high at these levels. Because of this, it is observed that the technique of ignoring information (not contextually relevant for getting to what matters effectively) and generation of numbers are being extensively used at these levels. This explains the dominance of numbers at integration levels.

NSL DIGITAL MIND: The abstraction (representation) layers in the computers are categorized as follows: a. Machine Language b. Assembly Language c. Compilers d. Technology Operating Systems. All the four representation layers are a form of code meant to instruct the computer on what to do. The last three representation layers (Assembly Language, Compilers, and Technology Operating Systems) use programming code, while the machine language passes on instructions directly through the binary code of 0s and 1s. All the four representation layers are standardized, which means if any new programming logic is built, which does not require changes to be made in any of the above layers. In this manner, commoditization of these layers of code has become possible. This is same as the way electronic transistors and circuits have been commoditized. NSL is standardizing higher level solution development by replacing higher level programming languages through the addition of three standardized layers on top of the four layers (Machine Language, Assembly Language, Compilers, and Technology Operating Systems) listed above. The Machine Language is NSL Solution Operating System (NSOS). The Assembly Language is the NSL Digital Mind, which is placed on top of NSOS, and it is seamlessly integrated with it. NSL Digital Mind is nothing but the NSL BETs Library having more than a billion BETs. The Compilers are a standardized repository of a set of Q&As, slated to eventually run into hundreds of thousands for comprehensiveness. These would get seamlessly integrated with BETs at various vantage points in the NSL Digital Mind. These Q&A would be connected to a network of nodes in the same fashion as the BETs are connected to a node-based network in the digital mind. The Q&A network and the BET network would be driven by nearest neighbor principles. With the integration of NSOS, NDM, and Q&A Repository, NSL commoditizes higher level programming-based solution development. It would take just a few hours of Interactive Q&A Session (IQAS), following Interactive Q&A Method (IQAM) between informed stakeholders and NSL Digital Mind representatives (NHAA). With each Q&A, the uncertainty around a solution will progressively shrink till the time a solution is fully grounded. NSL Digital Mind (NDM) will emulate the human mind. Its focus is not limited to interacting with just the internal and external stakeholders (agents). NDM would keep itself busy 24/7 in constant and relentless inner reflection, just as humans do. Both the inner-Q-agent and inner-A-agent will be busy performing both P-OSSA and R-OSSA cycles all the time. Potentiality OSSA cycles are performed in batch mode and Reality OSSA cycles are performed in real-time. Both feed on each other for continuous improvement. The P-OSSAs, in anticipation of future R-OSSAs, store, create, delete, modify, and retrieve BETs as the context demands. R-OSSA not only benefits from P-OSSA BETs but also contributes to P-OSSA by bringing in new reality BETs for future use by P-OSSA. There is a symbiotic relationship between P-OSSA and R-OSSA. The inner-Q-agent (IQA) and the inner-A-agent (IAA) are of a high order. In human agents, the IQA and IAA interactions happen throughout the wakeful hours. In the case of Digital Mind (Digital Agent), this interaction will be 24/7 as there is no need for it to rest. The digital agent is aided by new technologies like machine learning and deep analytics; the digital mind will continue to generate most magnificent insights, both in batch mode and real-time, in the form of reusable and actionable BETs. There is no reason why the inner debates between IQA and IAA cannot lead to the most unexpected and game changing BETs. The NSL digital mind is a dynamic and vibrant system ever evolving to create, delete and modify BETs for the good of itself and the stakeholders' services. The NSL digital mind not only houses the best BETs but also acts as a BETs exchange, like a stock exchange for the entitled stakeholders. The NSL Digital Mind cogitates all the time for self-improvement and benefits from insights that each of the trillions of transactions bring with them. The NSL digital mind is a NSL grammar compliant BET language model. It can be subjected to interactive question-answer methodology (IQAM) to ground solutions of any complexity in no time i.e., around 5 times more effectively than normal programming efficiency.

The digital mind emulates the human mind. The human mind adds, deletes, modifies, stores, and retrieves entities dynamically through the performance of P-OSSA cycles. The mind also collects entities from the external environments (through the senses), adds, deletes, and modifies entities (by directing the body to perform actuator functions), and stores or retrieves them through its R-OSSA cycles. The mind relies on the two inner QA agents and the entities within; multiple outer agents and entities to conduct its affairs. Normalization of human agent behaviour to NSL would be a worthy exercise and potentially yield rich dividends. A day in the life of an agent (human) will reveal that there are no more than a few dozen GSIs that get performed in a day carrying with them associated ECES, CES, entities, and attributes. The human brain will have a finite number of solution level GSIs accumulated over years of experience. The transactional GSIs and parts thereof will be commensurate with the age of the agents. Both solution BETs and transactional BETs feed on each other for continuous improvement of BETs. Not all transactional BETs get retained in the mind as evolution has equipped human agents to selectively ignore information or yield to forgetfulness. For example, there are only a limited number of solution BETs in the human mind. There are no more than a few lakh words in the English dictionary, of which an average person will have a vocabulary of no more than 40k words. One can expect the bulk of the memory to be consumed at shades of potentiality and reality levels with respect to transactions. If one sticks to solution BETs, there are unlikely to be any more than one million in a human mind. Compare the same to the NSL solutions level digital mind. The NSL digital mind will not be static. It would do the same kind of inner reflections that human minds do, learning 24/7 through relentless conversations with the inner and outer agents, deploying interrogative QAs, for continuous learning and the general good of itself; and all these agents that come in contact with it. In such an eventuality, the NSL digital mind is around 10,000 times wiser than the human mind.

Mirroring human agent functions onto digital agents: Knowing that the P-OSSA cycles are performed in batch mode, they started mirroring human agent functions daily for all transactional BETs. It is fully determined that for every transaction performed in a day in real-time, all the involved BET potentialities are put in place during the day progressively, or sometimes much before. For example, a decision to go to a movie may have been made in the morning, the specific movie decision may have been chosen two hours before and going to the theatre decision may have been made just an hour before. In all these batch mode transaction solution classes determinations, there is an implied space and time stamp. Storing the information in the digital mind, through appropriate entries, of all these facts as they happen at both P-OSSA cycle levels and R-OSSA cycle levels. The result is that all human agent functions are fully mirrored in the digital mind, eliminating the differences. NSL is the only established system that can mimic human brain functions. Incidentally, every change is a contextual event in NSL. NSL recognizes the opportunity for analysis of the cycle times with respect to trigger CES-the start of the trigger, the end of the trigger, and the period associated with it; similarly, the cycle times between events in successive transactions are also considered an analytical opportunity. For example, when has the pen arrived in the first transaction vs. second transaction? What was the time lapse between the two? In NSL, the contrast between the P-OSSA and R-OSSA cycles throws up yet another significant opportunity for deep analysis. For example, the time lapse between potentiality BET determination (deciding to go to a movie) and the reality status of the BET (actually going to the movie) maybe 12 hours. But some potentiality and reality cycles may 5 be short, like an hour or even one minute.

The NSL aims to tag the technology bytes directly to NSL constructs. These constructs are modeled after the way world works principles and, by extension, are directly connected to the parts of speech of a spoken language and numbers. Human agent qualities of performing OSSA cycles are observed in the digital systems also in the NSL methodology. Digital systems invariably have an objective for which they are set up. It is also the case that a digital system is required to repeatedly sense the environment, select things contextually, and act aptly. This is not different from the way humans operate. NSL gives a digital agent a full-fledged agent status and treats it not different from other human agents. One of the early discoveries was that the human brain played a role in first determining survival enhancing entities and their relationships before the body actuated the same. This duality of the brain and the body functions and the connected potentialities determination first before reality descended gave rise to an entity being converted to a binary entity (BET). NSL finds a way of breathing life into entities. NSL finds a way of making entities breathe in and breathe out events to generate transactions out of perceived entities. The cycles performed at P-OSSA and R-OSSA fractal-like with self-similar structures, where each of the elements of OSSA (objective, sensing, selecting, and acting) progressively brings about orderliness by overcoming disorder to assured defined objectives. Once the fundamental nature of all solutions and knowledge are determined to be entities and their relations, NSL can also normalize any body of knowledge quickly to benefit from it and improve upon it.

Reconciling the old and the new paradigms: It starts with everything being distinct information. In NSL, distinct information is considered with respect to agents and their objectives entities. It should be noted that out of trillions of distinctive things and their interactions, only one out of a trillion (treat the number metaphorical) things matter for agents. This is like having a password with respect to trillion possible combinations. The entity attains binary state (dual nature), or the BET status, on account of the fact that agents by nature create contrasting environments for entities that they desire. NSL has come up with a syntactic structure. NSL Solution Operating System (NSOS) is based on the way world works principle in NSL. This is in stark contrast with the syntactic structures that are based on stored procedures, keywords, and propositional logic on which higher level programming languages rely. NSL is further supported by the digital mind and QA layers to make interactive solution development possible.

The nature of the new paradigm and NSL Digital Mind: The digital mind is a unification of NSOS logic, NSL Digital Mind, and curated QA repository. The NSL Digital Mind takes away the differences between human and digital agents. NSL makes human agents and digital agents interact like friends and collaborating agents. The world of human agents and digital agents is a seamless world of entities and their relationships that matter for them.

The nature of the old paradigm: It is driven by higher level programming logic customized to each solution. All the logical functions and machine-driven solutions operate by principles akin to mathematics and propositional logic. This solutions logic is led by stored procedures and programming keywords understood by only experts like programmers. All solutions happen under the hood, with only the inputs and outputs surfacing at UI levels in the form of spoken languages. The old paradigm alienates the man and the machine. Agents, entities, and their relationships are foreign to the old paradigm, and their existence is unrecognized by it.

Human agents, evolution, and solutions: The universe is filled with two types of particles-Fermions and Bosons. Fermions are matter particles representing all of the matter. Fermions have half-integer spins. One can think of nouns when he/she thinks of Fermions or matter. Bosons represent the four fundamental forces of nature-strong nuclear force, weak nuclear force, gravitation, and electromagnetism. Bosons have integer spins. One can think of verbs (as they represent change) when he/she thinks of Bosons or energy. While there are four fundamental forces of nature, only electromagnetism matters for solutions for all practical purposes. Strong and weak forces relate to forces deep inside the nuclei of atoms. One can neither control them nor influence them in any manner. Gravitation is ever present, and one has no control over it. It is like a constant across transactions. Evolution has shaped human agents to control electromagnetic forces to meet their objectives. Evolution, for example, has shaped humans to recognize color. One has an ability to recognize various electromagnetic wavelengths between 400 to 700 nanometers as a range of colors which one can represent through the acronym VIBGYOR. Color is particular to humans, and it is ingrained as an experience. There is no way of describing color to a congenitally blind person. If there are extra-terrestrial aliens, it is most likely that the same electromagnetic wavelengths would be perceived by those aliens as different colors as the evolutionary processes would have been different. Evolution has also shaped humans to recognize entities and their relationships in unique discrete states. Given that human brains have limited storage and processing capacities, humans convert their experiences to discrete states for survival. The continuities and infinities in nature are not capable of being handled by humans or any life forms. Converting experiences to discrete states is analogous to videos comprising 30 frames per second. Evolution has recognized entities only at the relevant vantage points. While humans are composed of atoms, only in recent human history their presence has come to be understood. Recognizing entities and their relationships meant that the distinctiveness at both the level of matter as well as changes in the states of matter should be discerned. To recognize change, it is inevitable that transitions from one state to another need to be recorded. A minimum amount of change is representable by either a 0 or a 1. In mathematics, the smallest base number system is a binary. Logarithms of any base are composites of this binary base. Applying the same principle, NSL has converted every entity (by extension, relationships of entities) into binary states. Every binary entity (BET) operates as a switch accommodating events and transformations. All transformations are about moving from one CES to another and these controlled transformations lead to solutions sought and controlled by agents. These transformations come in discrete steps driven by nearest neighbor principles. All transformations are subject to the unique properties of entities and the way world works principles. Property of an entity is about how any entity interacts uniquely with any other entity in the universe. For example, if one throws a rubber ball against a wall, it bounces back. But if one throws soft mud at the wall, it will stick to it. While there could be infinite entities and their relationships, they fit into a limited set of classes as determined by the way world works principles. The constructs of NSL are these classes representing NSL Solution Operating System (NSOS) or NSL Grammar. This is same as a limited set of English Grammar rules guiding millions of lines of text. NSL has the NSL Digital Mind, which is placed on top of the NSOS and seamlessly integrated with it. This eliminates the differences between human agents and digital agents. Human agents can resolve any problem and obtain a solution by interacting in a QA format with other agents. The interactions between human agents and digital agents can ground any solution in a matter of hours. The interacting agents could be either inner QA agents or external agents. NSL eliminates the asymmetries between human agents and digital agents, marking a new era in solution development. In NSL, sets of bits that collectively represent entities are frozen to create an environment of the excluded middle, and those frozen sets are connected to NSL Grammar. In the old paradigm, bits are connected to ill-defined datasets and their transformations. These technology transformations completely ignore the presence of agents, entities and their relationships, and the way world works principles. The old paradigm has its own solution grammar based on mathematical and propositional logic expressed through higher level programming. Higher level programming relies on stored instruction sets as represented by keywords. Solutions are built by stringing together these stored programs to control the so-called data streams. The outcome is that solutions can only be dealt with by highly trained programmers, and they are 1,000 times more difficult to develop. The resultant solutions are at least five times inferior to NSL solutions. Furthermore, it is as though solutions have nothing to do with agents, entities and their relationships. In all popular computer science textbooks, there is not even a single reference to agents, entities, and their relationships.

The representational layer or the equivalence layer: All entities that are real (those in the functional or principal layer) have their representational counterparts in the representational layer. These could be text, voice, image, video, characters, statues, and so on. Some of them have sublayers such as the language layer having all languages as sublayers. To qualify to be in the representational layer, truth values need to be preserved. Some representations in the P-OSSA cycles can be in the principal layer ahead of time in anticipation-the transactional solution class. When reality is in the physical layer, it may have to wait to turn to reality. When the physical reality happens, the representational entities of those solution entities in batch mode also turn to reality. The existence of representational counterparts in the representational layer is a powerful tool for creative applications.

NSL Framework: NSL uses spoken languages including numbers and all the parts of speech in the context of solutions. The parts of speech are representational distinct entities. These are made up of a constituent implied distinct elements frozen together. For example, a word is made up of alphabets which in turn may be represented by a set of bits, or a physical entity such as a pen is made up of trillions of atoms operating with excluded middles. NSL takes these static parts of speech or representational entities and converts them into dynamic binary entities (BETs) with potentiality and reality states. These dynamic parts of speech in the form of BETs act as channels of change through the flow of controlled events leading to solutions. These dynamic parts of speech are not only guided by English grammar but also by NSL grammar that is called as NSL Solution Operating System (NSOS). NSL grammar is nothing but evidence based, backed by science, way world works principles. All controlled change is subject to the constraints of www principles and NSL comprehensive grammar that provides for all possible permitted channels of change. For example, all flow of change must respect nearest neighbor principles, or all change is about transformations or state changes in discrete binary entities. It is to these NSOS (NSL grammar) constructs that the controlled electromagnetic forces are tightly and seamlessly joined. These NSOS constructs, in turn, are loosely but contextually joined with billions of qualified BETs in the NSL Digital Mind. This effectively means that the parts of speech are made dynamic to act at the speed of light powered by electromagnetic forces. The asymmetries between digital agents and human agents in the NSL paradigm are eliminated as the dynamic parts of speech and BETs are common among them. This paves the way for any solution being obtained in a matter of hours interactively between digital and human agents. Each QA between them disambiguates solutions progressively till such time the solutions that are several times better are fully grounded.

Natural Language (NL) Grammar: In the context of technology solutions, NL grammar is not expressive enough to fully capture the Way World Works principles. The parts of speech in natural languages or spoken languages have been tested for thousands of years. Hence, they are supremely applicable and relevant to act as representational entities to build solutions. Human agents did not have the benefit of controlled electromagnetic forces as they are only a recent phenomenon over the last 80 years. Controlled electromagnetic forces have the power to move representational entities at the speed of light and perform representational functions billions of times per second. With the constructs, NSL grammar makes the Way World Works principles sufficiently expressive to fully deal with all the principles of mankind in the context of technology solutions. NSL constructs can capture the essence of the parts of speech in the NL in the most natural way possible. NSL can emulate human agent functions through the performance of simple Gedankenexperiments consistent with the Way World Works principles.

The agent behaviour is definable based on the principles of ability to perform Objective Sense Select Act (OSSA) cycles. Wherever the OSSA cycles get performed, there is a presence of agent(s). This qualifies the NSL Digital Mind to operate by the same principles of the human agents. NSL world is a world of entities, their relationships in the context of agents, and their objectives based on the Way World Works principles. The human agents are constantly interacting with the inner QA agents or the external agents in one form or the other to constantly shrink ambiguities and improve their solution or transactional BETs. NSL has been able to elevate the status of the digital agents to a level where the asymmetries between the human agents and digital agents have been eliminated. An exercise of mirroring a day in the life of a human agent has resulted in mirroring that reality into the NSL Digital Mind, establishing the fact that human agents and the NSL Digital Mind equally abide by the entities and their relationships model. The controlled electromagnetic forces have the power to move the representational entities at the speed of light and can store, process, retrieve, and exchange the representational entities at least a million times faster. On the contrary, the speed at which a human agent can think is only around one-tenth of a second. Both the human and the digital agents control the electromagnetic forces. The other three fundamental forces of nature, strong nuclear force, weak nuclear force, and gravitational force are not consequential as we have no control over them. One could take advantage of the gravitational potential energy, but to create that, one must depend on the electromagnetic forces. Evolution has shaped humans by controlling the electromagnetic forces. Humans, in turn, have created the digital agents artificially and made them even more powerful than themselves in many instances by taking advantage of the same electromagnetic forces. The digital agents' ability to power and manipulate representational entities is at least a million times faster, which has given the possibility of dealing with the representational entities (the parts of speech) by principles that go far beyond NL grammar. Until now, NL grammar was sufficient to generate existing literature. However, in a world where the controlled electromagnetic forces are needed to meet all the solution requirements of the world, NL grammar seems insufficient. A grammar that is more expressive to cater to all the solution scenarios while being fully compliant with the Way World Works principles is the need of the hour. NSL grammar fits the bill. NSL grammar reinterprets and uses all the NL grammar rules in one form or the other. NSL grammar has invented BETs so that the parts of speech could be made dynamic. NSL grammar, with its constructs, can cater to any kind of solution scenario. NSL grammar has ways of dealing with the shades of potentialities, the shades of realities, condensing information by selectively ignoring information, adding contextually relevant layers and sublayers, the transformations across horizontal and vertical CUs, and so on. NSL grammar, which is same as the NSL Solution Operating System (NSOS), is fully equipped to support the NSL Digital Mind. The NSL Digital Mind is capable of interactively grounding any solution in no time. To do this, one should connect the controlled electromagnetic forces (at 0s and 1s level) to the NSL grammar, consistent with the Way World Works principles and contextually enrich the grammar for a magical effect. In the 1940s, the builders of electronic machines thought only through the aspects of computation and mathematical/propositional logic in the context of solutions. This led to the birth of stored programming concepts, resulting in artificial programming tokens being connected to controlled magnetic forces. This unnatural outcome and the counterintuitive approaches involved in the solution building required complex specialist training. Consequently, common man was completely alienated from the machine. In the early stages of the computer, no one recognized that computers could emulate human behaviour based on the entities and their relationships model. NSL grammar takes away the anomaly in the old paradigm and is capable of building solutions a hundred times faster and several times better. NSL grammar shall mark a new era in solutions development.

Nature-made Human Agents: Nature-made human agents require Natural Language (NL) grammar for the exchange of language-representational entities. Consistent with the way world works principles, human-made digital agents, to become functional, require all the NL grammar constructs. This is because digital agents are driven by controlled electromagnetic forces and operate millions of times faster. The speed of human thought is 1/10th of a second. The speed of the ‘digital-agents-processing-of-representational-entities’ is a billion times a second. Furthermore, digital agents depend on other agents (both digital and human) to cover for their functional deficiencies compared to human agents. For example, human agents are self-contained with five senses, mental faculties, and bodily actuators. There are also other differences in the way digital agents store, process, retrieve, and exchange representational entities in seamless networked environments with other agents. All these differences called for an extended grammar with respect to digital agents in the form of NSL that is still consistent with the way world works principles. NSL encompasses all NL grammar constructs (directly or indirectly) and many more to meet the requirements of digital agent functions comprehensively.

Natural Languages (NLs) Grammar vs. Natural Solution Language (NSL) Grammar: NL grammar is about standardizing text based on a set of rules. NLs are composed of the parts of speech that follow a given grammar. The human agent can generate languages by associating artificial entities to the entities in the physical world. For example, objects such as a pen or the actions such as write are associated with language labels. As per NSL, anything that is distinct and matters for a solution is an entity. Some entities also have the properties of correlations or representations. For example, a physical object pen and the word pen are correlated and are, therefore, a representation of each other. Depending on the context, one entity becomes the real entity and the other becomes the representational entity. Each entity is a class by itself. Anything distinct is information. Entity is contextually relevant to agents. Entity involves a set of distinct things that can be brought together and frozen to be made as entities. Thereafter, the formed entity set operates based on the principle of the excluded middle. An entity either exists in potentiality or reality and does not have any other acceptable states. The dual state or binary state of entities (BETs) arises out of the fact that perception and reality cannot be separated in the agent world. In terms of NL, all parts of speech also attain the entity status and thus become BETs implicitly. NL grammar, with constructs and principles, acts as a class of classes (parts of speech are also classes). Since language labels are assigned to entities in the real world, the behaviour of the real-world entities has an influence on how the NL grammar evolves. In other words, NL grammar is always consistent with the Way World Works principles. If there is no such consistency, the assigned parts of speech lose their truth values and quickly get weeded out. The principles of NL grammar that get tested for thousands of years will always be consistent with the Way World Works principles. Natural Solution Language (NSL) grammar, with the constructs, makes the WWW principles sufficiently expressive such that all technology solution scenarios are fully dealt with and adhere to all the principles that shaped mankind through evolutionary processes. In other words, NSL constructs capture the essence of all the parts of speech of natural languages and more in the most natural way possible.

The NSL Grammar, NSL Solution Operating System (NSOS), and constructs (tokens) are tightly joined to the controlled electromagnetic forces, powering them millions of times. These remain constant across solutions except for the upgrades in the NSL grammar. This is different in the case of stored programming constructs. Stored programming constructs (tokens)-programming keywords, symbols, variables, and constants-are like building blocks that are uniquely knit together for each solution. Each programming-based solution is not only unique but highly effort consuming. On the contrary, the NSL Digital Mind (NSL BET library) is a constant, but for continuous upgrades. NSL solution variables are the disambiguating interactive QAs that lead to the solution with only a limited effort. New solution creation is a process of discovery of solution pathways. In other words, the existing BETs and their relationships are contextually chosen with additional creation or customization of BETs and their relationships as needed. Any such new creations and customizations become an integral part of the NSL Digital Mind, further reducing the solution effort. Every solution is a contextual discovery of the pathways to the destination. The NSL Digital Mind is like a road network, made up of a three-dimensional network of BETs waiting to be used or reused as the solution context demands. All solution pathways are automatically laid by the digital mind in the context of stakeholder objectives.

Process of converting an entity into a BET: Every entity is a class by itself as it is distinct with respect to the rest of the universe. It is like drawing a circle and saying that things are either within it or outside of it. NSL has effectively converted an entity into a class that admits given entities or events and does not admit others. In other words, BETs help to animate entities (make entities dynamic) in the context of agents and their objectives.

### Relationships of Entities:

1. Correlation: Correlation exists when there is mutual information between entities. When one can infer another entity while recognizing a given entity, the entities are correlated. These can also be called representational entities. Correlations can be established by mutual consent. For example, the spoken languages are of this kind. It is informed that at some point, the physical pen should be referred to as pen. When everyone in a community is on the same page, a language element is born. Correlations based on ‘causation’ can also occur when one observes a correlation between a full moon and a high tide. Correlations are based on association with respect to other entity classes. A classic example of it is Pavlov's dog behaviour. There is a presence of bellringing and food arriving within a given interval of time. The dog comes to associate the food with the ringing of the bell. Here, the reference class is time. This can happen with respect to every other class also. For example, if the spatial entity is a kitchen, one is likely to associate a stove and a gas cylinder as one can infer from another. Establishing correlations in the context of uncertainty and related probabilities will be dealt with as attributes in NSL.
2. Coexistence: Coexistence is particularly in the context of the arrival of entities progressively into a CU to accomplish an objective. This is same as non-trigger CES. As non-trigger CESes undergo transitions from one to another, each such event is considered to produce a null event. Physics demands that one must account for the counterpart of a cause, which is an effect. In these non-trigger events, the effects are null events. Just as a 0 is also a number, null events qualify to be events.
3. Co-Creation: Co-Creation is with respect to trigger CES causing one or more tangible events (non-null kind) in one or more CUs including itself. In mathematics and programming parlance, these are dealt with as functions. The summary statement here is that between correlations, coexistences, and co-creations (functions), all the entity relationships stand accounted for.

Levels of languages meant for solutions: Machine language is considered as a low-level language. Assembly language is considered as a mid-level language. Java, Python, C, and other programming languages are considered as High-Level Languages (HLLs). They are difficult to understand for the users. On the other hand, natural (spoken) languages are easy to understand. One can call natural languages (spoken languages) as HLLs. NSL has proven that HLLs can develop any complex solution and also do the following:
A. Make solution development agnostic to use any spoken language.
B. Eliminate asymmetry between human agents and digital agents and make conversations between them possible.
C. Make solutions completely transparent.
D. Enable development of solutions in 1000th of time-three orders of magnitude faster.
E. Ensure that developed solutions are at least 5× superior.

Way the NSL Digital Mind Works: Sets of stored instructions in the machine language layer will be directly and tightly coupled (now, they are indirectly coupled) with the NSL grammar constructs. NSL grammar, NSL Solution Operating System (NSOS), which is based on the Way World Works principles, acts as a filter in determining billions of qualified BETs in the NSL Digital Mind. It is best to visualize the NSL Digital Mind as a three-dimensional network of BETs in the shape of a sphere. As the NSL Digital Mind becomes richer in BETs, the density of BETs within the sphere increases concomitantly with the size of the sphere. This network of BETs is reminiscent of network of tightly packed neurons in the human brain. As the number of BETs in this network of the NSL Digital Mind grows, its wisdom keeps increasing. In comparison with the human mind, the NSL Digital Mind would be several orders of magnitude more knowledgeable. Not only are the number of solution BETs that the NSL Digital Mind carries dramatically higher, but also the quality of BETs is far superior. All the NSL Digital Mind BETs are highly curated, based on evidence, science, and expert interventions, rendering them to be highly dependable. Human agent solution BETs do not hold up to the same standards of free from prejudice environment in comparison with the NSL Digital Mind. Any new solution development is achieved through the process of stakeholders and the NSL Digital Mind interacting as though they are friends. Through a series of structured Q&As being dealt with between the stakeholder and the NSL Digital Mind, following the Interactive Q&A methodology (IQAM), any solution is grounded in a matter of few hours. This is possible because, for all practical purposes, solutions do not get created each time. Only the pathways to the solutions are being established contextually as a stakeholder seeks a new solution. This operates the same way as getting from one place to another in a city based on the destination sought and the current location of a stakeholder. IQAM progressively shrinks the uncertainty to lead to the certainty of a solution. Once the computer has attained a status of a digital mind (digital agent), eliminating the differences between human agents and digital agents, the rest is as intuitive as normal interactions between people. The crux of NSL's invention lies in the creative approaches taken by NSL to convert a computer into a digital mind. NSL had to first come to establish commonalities and differences between humans and computers (digital systems). Digital systems operate at the speed of light, while human agents move slowly and think at the rate of only 1/10th of a second. However, human agents are more self-contained in all elements of OSSA cycles. They can determine their own goals, sense things in the environment through all their five sense organs. They can make their own decisions contextually and act on things through their actuator organs such as hands and legs. To turn a computer into a digital agent requires NSL to recognize the need for a collaborative agent environment being created to maximize mutual benefits. It is as though there is an opportunity to bring 1 and 1 together such that they became eleven (11) rather than two (2). It is as though the speed of electromagnetic forces (operating billions of times faster) could be combined with all the elements of human solution OSSA cycles. Wherever there is a dependency on the part of a digital agent, collaborating human agents cover for it, and when there is an opportunity for the human agents to ride on the controlled electromagnetic forces, the digital agent responds. Elimination of differences between human and digital agent, while attractive, calls for a significantly extended grammar for communication between human and digital agents. Communication between human agents requires adherence to natural languages (spoken languages) grammar. There are 30+ constructs in English language grammar. For example, sentences must have verbs associated with them, nouns can be differentiated by adjectives, verbs can be differentiated by adverbs, and so on. If any of these grammar rules are violated, the text is considered not meeting the standards. Languages evolve by attaching labels to real world experiences. If 100 aborigines without a language are left on an island in isolation, 100 years later, they would have generated their own language. They would label a tree, a tiger, or an action such as fall or run to give expressions to their experiences or their understanding of the Way World Works principles. But human and digital agent communication in the context of solutions calls for a grammar far richer in scope to account for all experiences based on the Way World Works principles, contextual to the presence of digital agents. Going far beyond 30+ constructs in English language grammar, to fulfil the requirement in the context of digital agents, NSL has created an extended grammar with 100+ constructs to account for all the scenarios. These 100+ constructs included all the 30+ natural language grammar constructs also (in one form or the other) as they equally respect the Way World Works principles. For example, NSL has introduced a BET model to account for the need to animate text. Its nearest neighbor principle takes care of the cause and effect based event generation, its selective ignorance of information leads to needed condensation of information, and its CU types cover for transformations of any kind. Equipped with NSL, by performing simple gedankenexperiments (thought experiments), solutions can now be built in a matter of hours and 5× better. The alienation of the machine agent problem in the old paradigm is now fully addressed. It is now to possible to lay highways for realizing artificial general intelligence faster than any organization in the world. The world is no longer in the clutches of mathematical and propositional logic-based programming languages. NSL is giving the computer an agent status by converting it into a digital mind.

Selective ignorance (de-recognition) of information for condensing and increasing the density of information: In NSL, information is anything distinct. Sets of distinctive things frozen together can collectively become higher level distinctive things, which matter to agents. These entities and their relationships are in the context of agents and their objectives. Therefore, entities and their relationships become synonymous with information. For the purpose of constantly shrinking the possibilities in each of the elements of OSSA cycles in a directed fashion, and to get to the solution-destinations, agents have evolved to apply many principles as follows:
a) Equivalence Relationships: As per this principle, agents rely on correlations between entities.
b) Functional Relationships: As per this principle, agents rely on directed transformations, where sets of entities lead to one or more sets of entities.

c) Coexistence Relationships: As per this principle, agents rely on contextual coexistence of entities in given classes.

In addition to the above, there exists a powerful principle (that agents deploy) that arises out of selectively ignoring information. The world is filled with infinite quantities of information. Agents have limited ability to store, process, and retrieve information. The principle of selectively and contextually ignoring information is as important as storing information that matters for survival. Selectively ignoring information results in condensing information; thereby, the density of information increases to a substantial degree. While a lot of information may get lost quantitatively, there will be limited information loss qualitatively. This is illustrated in the following example: Imagine that there is information around ABCDE combinatorial entities across hundred transactions. Assume that A=Agent, B=Height, C=Age, D=Color, and E=Weight. If one ignores all the ranges of value with respect to heights, agents, colors, and weights, we will have undifferentiated attributes. If one ignores all the attributes also, as only agents (only As) mattered for delivery, the rest of the attributes (BCDE) also become immaterial. The differentiated agents (As) have become identical. Agents across all hundred transactions can be expressed in numbers as agent attributes—100. It is not hard to conclude that all the loss of information (quantitatively speaking) does not matter in the context of solution. What information mattered, from a solution perspective, was almost fully preserved from a qualitative perspective leading to enhancing the density of information or condensation of information. This is a principle that we extensively deploy across all solutions, providing opportunities for condensation of information all the way up to the highest point in the ecosystem, that is, across CUs, GSIs, work modules, modules, and group modules. Since every ecosystem is an unbroken chain of BETs (dynamic entities), the principle of information condensation is deployable at any time and at any vantage point. Thus, information condensation emerges as the fourth principle that agents rely on as needed, the other three being equivalence relationships, functional relationships, and coexistence relationships. The fourth principle is identical relationships. As per ‘identical relationships’ principle, agents rely on identicalness between entities. This is known as ‘ONE TO MANY’ principle in NSL.

### Additional Information Sources for NSL:

A. All Vantage Points: In NSL, every part of speech is converted to a dynamic BET, which generates events. Therefore, all vantage points at attribute levels, entity levels, every CU and set of CU levels, GSI levels, work module levels, and module levels generate a huge amount of pertinent information. Such additional information leads to significant insights, which in turn results in appropriate actions and establishes positive feedback loops, further leading to quantifiable value.
B. Shades of potentiality: Wherever there is a reliable information source, there are opportunities for significant gains. Shades of potentiality proliferate as the participation of more BETs in a solution generates several potential pathways. Some of those pathways may carry significant informational value for the stakeholders. It is in the hands of respective stakeholders to optimize the usage of information. A stakeholder is always driven by optimization principles and the cost of storing, processing, and retrieving information as against the benefits that additional information brings in. Therefore, falling prey to information does not cause an overload problem as each stakeholder has the power to control the information as he/she pleases.
C. Shades of Reality: It is the opportunity to use all the transactional data in the normal course, just as in the old paradigm.
D. Verbs: These are unexpected sources of information in NSL as the solutions are built around spoken languages. In the programming paradigm, functions that are ‘verb’ equivalents only deal with transformations from one state to another. For example, if there is water, lemon, and sugar, the same leads to lemonade in the programming world. The verb ‘prepared’, which is distinctive by itself does not figure. Similarly, if there is a chef and the needed ingredients, it results in a given dish being ready in the old paradigm. NSL uses the verb ‘cook’, which is distinct by itself and is of great informational value all by itself. Verbs describe the CU activity, which information is of great importance for analysis. The NSL Digital Mind has many verbs that are extensively used.
E. Additional BET Layers: NSL has a couple of dozen layers attached to the principal functional layer of BETs. These are distributed across mandatory layers, new technologies layers, functional layers, and others. Each of these layers carries humongous information of value. Just the statistical layer has opportunities for deployment of all statistical functions that a statistical book specifies.
F. Agent Roles: Digital agent roles are of the kind where digital agents specialize in functions like sending messages, calculating, and attaching security tags. For every human agent role, for example, there are tools of trade or stock in trade items that are associated. Those, in turn, carry with them loads of information. For example, every cook's role demands a kitchen full of groceries, utensils, gadgets, and materials of pertinence. Every tailor's role demands items such as sewing machines, scissors, threads, and clothing.

To state things concisely, NSL provides a framework to extract value from every drop of information associated with any solution. The information itself is on the tentative ground in the old paradigm. The so called information that lends itself to analysis in the old paradigm is quite limited in scope. It is like summarising the text in a chapter of many pages in a few lines and trying to do analysis around it. On the contrary, given the same solution, NSL lends itself to the collection of information in a multidimensional way to do deep analysis and generate a value of a high order.

NSL and the Second Law of Thermodynamics (Entropy): Space and time are filled with either Fermions (matter particles) or Bosons (force carriers). Bosons cause change or transformations. As neither of the particle types is purpose driven, all changes in nature happens randomly, within the constraints of nature's laws. The universe as a whole tends towards disorder consistent with the principles of entropy. Entropy is synonymous with disorder. Agent systems that evolved out of billions of years of learning to beat the randomness (entropy), thrive on order. Agents are equipped to perform OSSA cycles repeatedly. OSSA cycles are generators of order. At each element in the OSSA cycle, possibilities (degrees of freedom) are systematically shrunk by directing the energy for desired purposes. At element O (objective), agents choose from thousands of possibilities that contextually matters. The first S (sense) chooses out of thousands of theoretical entities that exist for being sensed (only those limited entities that could be candidates for being sensed). It is like taking stock of inventory items for cooking. The second S (select) picks one or a few from the sensed entities as potential candidates for the solution. The element A (act) in the OSSA cycle, acts only on that entity combination that matters, ignoring all the other non-trigger CES. As the wheel of OSSA keeps turning relentlessly, randomness is pumped out systematically till such time the desired order (objective) is realized. Every element of the OSSA value wheel and each turn of the value wheel control and direct the energy to serve the causes of agents.

Stock-In-Trade or Tools of Trade—BET Layer: A CU is one of the vantage points of a BET. There is an agent role behind every CU and every type of CU, most often, relies on a set of entities and attributes for its trigger functions which we can call tools of trade. Since every CU is driven by an agent (or a team of agents), every role has its own tools of trade. Stock-in-trade is same as a homemaker having certain items of inventory in the kitchen or a shopkeeper having set of items in the store. This is like having a set of BETs within BETs or agents keeping the BETs for ready access or use contextual to their roles. There are tens of thousands of human agent roles in the world, just as much as there are hundreds of machine agent roles. Some roles are performed by specialists. While most people can cook, not everyone is a master chef! Often, agents perform multiple roles as needed. A writer can cook and do gardening as well. NSL provides for a layer where the tools of every agent are tagged and this can be invoked by the solution designer when designing solutions.

Agent types: Reality entertains both random behaviour of particles such as the way wind blows as well as rhythmic behaviour of a collection of particles such as the way planets revolve around the Sun. But in both instances, nature is not driven by any purpose. It is the agents (products of evolution) that are driven by purpose. Human agents in turn, extend their own phenotypes (like birds create nests) and create extended phenotypes in the form of digital agents (digital mind) to better serve their purposes. The definition of an agent can be stated as an entity that possesses the ability to perform OSSA cycles. These OSSA cycles facilitate a progressive reduction in uncertainty to tend towards certainty of solutions. NSL grammar eliminates the differences between human and digital agents. There could be different pathways to the same destination. Similarly, human agents may be driven primarily by a collection of atoms and the digital agents by a collection of BETs. But the end result is that they are both well equipped to effectively deal with the performance of OSSA cycles. NSL creates a collaborative win-win environment between human and digital agents to maximize the collective good. They build on each other's strengths and cover for the weaknesses of the other once there is a commonality in the grammar and purpose. The digital agents move at the speed of light and have the ability to seamlessly network the whole ecosystem. But they are not self-contained like human agents-such as being composed of senses, the ability to set up objectives for themselves, the ability to make choices in all instances, and have organs to perform actuation functions. Removal of asymmetries between human and digital agents generates unprecedented opportunities. It creates orders of magnitude higher capacity for the NSL Digital Mind and makes it act as a companion, friend, philosopher, and guide to all human agents in the world. On top of it, human agents could now work for their collective good in a highly networked manner at a global level exchanging best practices. In this network of collaborating agents on a global scale, one can expect to have several types of agents.
A) Inner agents: These are reminiscent of inner questioning voices (Q agents) and the answering voices (A agents).
B) External agents: These are either human or digital agents interacting with each other through Q&A methodology. These agents could even be those who are no longer living but have made their thoughts accessible through different mediums to provide answers to our inquiries.
C) Agent Roles: The specialized nature of different roles, running into thousands across human and digital agents, is fully recognized.

The sum and substance of all this is that agents are at the centerstage of all solutions, irrespective of their functions and that most solutions arise out of interactions between agents of one kind or the other. Each agent type is also likely to have a given set of attributes attached. Other than inner agents, external agents, and agent roles, NSL also has OSSA agents. These are nothing but the agents behind each of the elements of OSSA. For example, an agent who helps in determining an objective, sense given inputs or outputs, and so on. There are agents behind both P-OSSA cycles as well as A-OSSA cycles.

### Agent Building Blocks:

A) Human Agents: The building blocks of human agents are atoms. A set of atoms make small molecules, large molecules, and very large molecules (like DNAs and Proteins). There are about 10 trillion atoms that create a human cell. There are about 10 trillion cells that make up the whole human body. The sets of cells lead to tissues, which lead to organs (including the brain) and all organisms at the right places make the human body. Fundamentally, it is the electromagnetic forces that animate the human body. All the other three forces of nature play only a limited role in the overall scheme of things.
   Strong Force: This is confined within the nucleus of an atom, and one can have no influence over it for all practical purposes. Unearthly temperatures are needed to assert any influence.
   Weak Force: This can generate radioactivity and break up atoms and transform them. But NSL can discount the same for the time being.
   Gravity: This force is extremely weak. Electromagnetism is 10\hat{ }35 times stronger than gravity. A massive body like the earth on which humans live creates a strong, attractive force due to the cumulative effects of its size. But it is as though that force is a constant, where agents have no control over it. One can, at best, create gravitational potential energy through electromagnetic forces.
   Electromagnetism: This is the force that fundamentally controls the behaviour of agents. Agents have come to wield some control over this force to direct it to meet their end objectives.
B) Digital Agents: The building blocks of digital agents are bits. Bits operate in an environment of many levels of abstraction (representations) such as bits leading to bytes, bytes leading to characters and symbols, those leading to programming tokens, and so on. The differences between the building blocks of human agents (atoms) and digital agents (bits) apart, both types of agents control electromagnetic forces and are driven by the same. Human agents are equipped to deal with reality based on their understanding of entities and their relationships around them. Their faculties of mind permit them to label all entities and their relationships based on their experiences. This process of labeling enables communication, delivering huge evolutionary advantages. This is how every language evolves naturally. The world works within the constraints laid by nature (through its fundamental forces). If the world works within given constraints, it is natural that the labels attached to the real-world experiences have similar constraints when they retain the truth values. This is the origin of natural language grammar, which is nothing but the constraints within which a language must operate. For example, imagine a person walking in a room. One would say, ‘Rama is walking’. What exactly has happened here? One has described a change in entity relationships. There is an entity/agent Rama, and there is an inevitable change. The nature of change is that Rama changed his entity relationships continuously (with implied spatial and time elements). If anything is described or labeled, change must be considered. Therefore, a fundamental requirement of the presence of verbs in a sentence. Verbs not only describe the nature of change but also temporality (time related aspects). If the temporality is a time related segment that chose the past, the description of the activity would have been, ‘Rama was walking’. The logic humans deploy is establishing entities and their relationships contextual to the situation. This logic is called common sense if it is obvious. If it is not so obvious, one can defer to the experts. But in both cases, the essence is the same.
C) Machine agents: An opportunity to convert a computer into a digital agent, then the whole perspective is changed in NSL. The new reality is that a digital agent (digital mind) accounts for not only its strengths but also its weakness. For example, sometimes digital agents cannot see inputs from human agents. This new reality is provided an opportunity to seamlessly connect all the human and machine agents into a network of interacting agents for the collective good. Taking stock of all things connected to this new reality meant that an extended grammar is needed to guide the electromagnetic forces. Several natural language constructs and grammar constructs (rule sets) are needed to completely take away the asymmetries between human agents and digital agents. NSL grammar enables human agents to talk to digital agents like they are talking to a friend. With the birth of NSL grammar, a new paradigm is born. The paradigm is a radically disruptive technology. The paradigm can ground any complex solution around three orders of magnitude faster (10\hat{ }3) through interactions between the digital mind and stakeholders and solutions that are around 5 times more effective. NSL grammar encompasses all the constructs of natural language grammar and further has extended constructs to make seamless integration with the digital mind. All this is done in strict adherence to the way world works principles-quite consistent with the natural language grammar approaches that always respected those principles. These extended constructs included BETs that made the parts of speech dynamic and followed nearest neighbor principles to bring all entities at all vantage points in the ecosystem together.

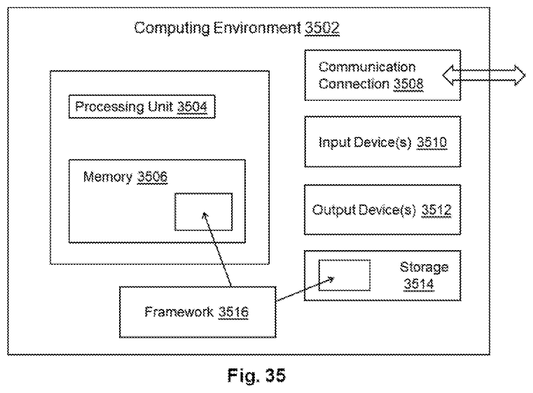

NSL may be implemented in or involve one or more computer systems. FIG. 35 shows a generalized example of a computing environment or system 3502. The terms “computing environment” and “computing system” are interchangeably used in the present disclosure. The computing environment 3502 may include, but is not limited to, a laptop computer, a desktop computer, a server, a cloud-based computing system, and the like. The computing environment 3502 is not intended to suggest any limitation as to scope of use or functionality of described embodiments.

With reference to FIG. 35, the computing environment 3502 includes at least one processor or processing unit 3504 and at least one memory 3506. The processor or processing unit 3504 executes computer-executable instructions and may be a real or a virtual processor. In a multi-processing system, multiple processors or processing units execute computer-executable instructions to increase processing power of the subject matter described in the present disclosure. The memory 3506 may be a volatile memory (e.g., registers, cache, RAM), a non-volatile memory (e.g., ROM, EEPROM, flash memory, etc.), or a combination thereof. In some embodiments, the memory 3506 stores a framework 3516 implementing the methods and techniques described in the present disclosure. In an example, the framework 3516 may be NSL-TF, or a combination of NSL-TF, TTF, and TRF as described herein.

The computing environment 3502 may have additional features, such as a storage 3514, one or more input devices 3510, one or more output devices 3512, and one or more communication connections 3508. The communication connection(s) 3508 may include, but are not limited to, a bus, a controller, or any interface, including a network interface, which interconnects the components of the computing environment 3502. Typically, an operating system software (not shown) provides an operating environment for other software executing in the computing environment 3502, and coordinates activities of the components of the computing environment 3502.

The storage 3514 may be a removable memory or a non-removable memory, and includes magnetic disks, magnetic tapes, cassettes, CD-ROMs, CD-RWs, DVDs, or any other medium which may be used to store information or data, and which may be accessed within the computing environment 3502 and by one or more devices or systems outside of computing environment 3502. In some embodiments, the storage 3514 stores instructions for the framework 3516.

The input device(s) 3510 may include, but is not limited to, a touch input device, such as a keyboard, a mouse, a pen, a trackball, a touch screen, a game controller, a voice input device, a scanning device, a digital camera, or another device that provides input to the computing environment 3502. The output device(s) 3512 may include, but is not limited to, a display, a printer, a speaker, or another device that provides output from the computing environment 3502.

The communication connection(s) 3508 also enables communication over a communication medium from the computing environment 3502 to another computing entity. The communication medium conveys information such as computer-executable instructions, audio or video information, or other data in a form of a signal, for example, a modulated data signal. A modulated data signal is a signal that has one or more of its characteristics set or that is changed in such a manner as to encode information in the signal. By way of an example, and not limitation, communication media include wired or wireless techniques implemented with an electrical, optical, radio frequency (RF), infrared, acoustic, or other types of signal carriers.

Implementations may be described in the general context of computer-readable media. Computer-readable media are any available media that may be accessed within or by a computing environment or a computing system. By way of an example, and not limitation, within the computing environment 3502, computer-readable media may include the memory 3506, the storage 3514, communication media, and any combination thereof.

In an example, the computing environment or the computing system 3502 may include one or more modules or engines which are configured to execute or perform the method described in the present disclosures. A module or an engine may be implemented by way of computer-readable instructions, or a hardware, or a combination thereof.

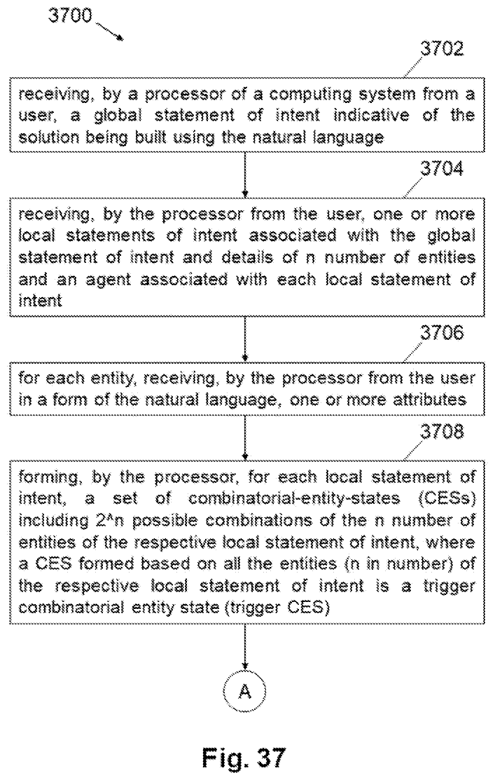

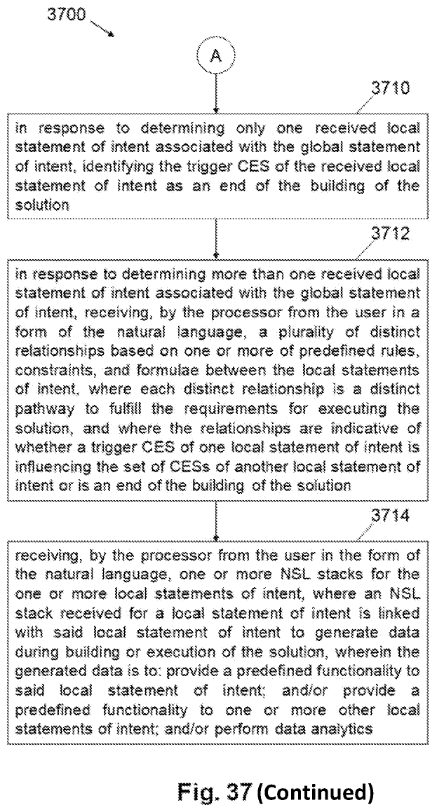

FIG. 37 illustrates an exemplary method 3700 for building a computer-implemented solution using a natural language understood by users and without using programming codes. The described method 3700 may be performed by the processor 3504 of the computing system 3504, as illustrated in FIG. 35. It should also be noted that different implementations of the method 3700 may include performing some or all the steps described herein in different orders or substantially concurrently, that is, in parallel.

In the method 3700, at block 3702, a global statement of intent is received by the processor 3504 of the computing system 3502 from a user. The global statement of intent is indicative of the solution being built using the natural language. The global statement of intent is received in a form of a natural language and is set in a state of potentiality. The natural language herein can be any native language generally spoken by any user, examples of which are described in detail above in the present disclosure.

At block 3704, one or more local statements of intent associated with the global statement of intent and details of n number of entities and an agent associated with each local statement of intent are received by the processor from the user. Each local statement of intent and the details of each entity and the agent are received in a form of the natural language and are respectively set in a state of potentiality. Each local statement of intent is a sentence indicative of a sub-step for fulfilling the requirements for executing the solution. Each entity includes a noun phrase and participates in fulfilling the requirements of the sub-step indicated by the corresponding local statement of intent. The agent is at least one of a human agent and a machine agent.

At block 3706, one or more attributes are received for each entity by the processor from the user in a form of the natural language. The one or more attributes define a characteristic of the respective entity and that differentiate the respective entity from other entities of the corresponding local statement of intent. The one or more attributes are set in a state of potentiality. Each attribute includes at least one of an adjective phrase and an adverb phrase.

Further, the agent at least changes the state of potentiality to a state of reality of each attribute, each entity, each local statement of intent, and the global statement of intent.

At block 3708, a set of combinatorial-entity-states (CESs) are formed by the processor 3504 for each local statement of intent. The CESs for each local statement of intent include 2\hat{ }n possible combinations of the n number of entities associated with the respective local statement of intent. A CES formed based on all the entities (n in number) of the respective local statement of intent is a trigger combinatorial entity state (trigger CES), where each CES in the set is in a state of potentiality and changes to a state of reality in response to changing the associated entities into a state of reality.

Further, at block 3710, the trigger CES of the received local statement of intent is identified as an end of the building of the solution, in response to determining only one received local statement of intent associated with the global statement of intent.

At block 3712, a plurality of distinct relationships is received by the processor 3504 from the user in a form of the natural language based on one or more of predefined rules, constraints, and formulae between the local statements of intent, in response to determining more than one received local statement of intent associated with the global statement of intent. Each distinct relationship is a distinct pathway to fulfill the requirements for executing the solution. The relationships are indicative of whether a trigger CES of one local statement of intent is influencing the set of CESs of another local statement of intent or is an end of the building of the solution.

Further, at block 3714, one or more NSL stacks or layers are received by the processor 3504 from the user in the form of the natural language for the one or more local statements of intent. An NSL stack received for a local statement of intent is linked with said local statement of intent to generate data during building or execution of the solution, where the generated data is to: (a) provide a predefined functionality to said local statement of intent; and/or (b) provide a predefined functionality to one or more other local statements of intent; and/or (c) perform data analytics.

Further, the state of potentiality is referred to as an empty binary state, and the state of reality is a non-empty binary state.

Further, information in the form of the natural language is received through a handwriting-based interface, a touch-sensitive interface, a voice-based interface, or a gesture-based interface, or a combination thereof.

Further, information, received by the processor 3504, in the form of the natural language is collectively referred to as user inputs. Specifically, the information associated with the global statement of intent, the one or more local statements of intent, the one of more entities, the one or more attributes, the agents, the plurality of distinct relationships, the one or more NSL stacks is collectively referred to as user inputs.

Further in an example of the method 3700, for each entity of each local statement of intent, a user input against the respective entity is received by the processor 3504 from the associated agent in a form of the natural language. Receiving the user input against the respective entity is recordation of an event to change the state of potentiality to a state of reality for the respective entity based on the received user input. Receiving the user inputs against all the entities associated with each local statement of intent is recordation of an event to change the state of potentiality to a state of reality for the respective local statement of intent. Further, receiving the user inputs against all the entities associated with all the local statements of intent is recordation of an event to change the state of potentiality to a state of reality for the global statement of intent.

Further in an example of the method 3700, for each attribute of each entity, a user input against the respective attribute is received by the processor 3504 from the associated agent in a form of the natural language. Receiving the user input against the respective attribute is recordation of an event to change the state of potentiality to a state of reality for the respective attribute.

In an example, the NSL stack comprises a language stack, where the language stack is linked to said local statement of intent to generate data which provides the predefined functionality of changing at least one of user inputs and outputs, during the building or the execution of the solution, from a first natural language to a second natural language. The changing is based on a language equivalence matrix, as described above. In an example, selection of the second natural language is received by the processor 3504 from the user in the form of the first natural language.

In an example, the NSL stack comprises a machine learning stack. The machine learning stack is linked to said local statement of intent to generate data which provides the predefined functionality of assessing and/or modifying and/or disregarding and/or recommending at least one of user inputs and outputs, during the building or the execution of the solution. Said predefined functionalities are provided based on one or more machine learning techniques and/or one or more machine leaning databases, associated with said local statement of intent and/or with one or more other local statements of intent.

Further, in an example, the NSL stack comprises a blockchain stack. The blockchain stack is linked to said local statement of intent to generate data which provides the predefined functionality of: securing of at least one of user inputs and outputs, during the building or the execution of the solution, based on one or more blockchain techniques, for said local statement of intent and/or for one or more other local statements of intent; and/or issuing of non-fungible tokens and/or personalized tokens for at least one of user inputs and outputs, during the building or the execution of the solution, based on one or more blockchain techniques, for said local statement of intent and/or for one or more other local statements of intent.

Further, in an example, the NSL stack comprises an analytics stack. The analytics stack is linked to said local statement of intent to generate data which provides the predefined functionality of data analytics of at least one of user inputs and outputs, during the building or the execution of the solution, based on one or more statistical functions, for said local statement of intent and/or for one or more other local statements of intent. The data analytics performed by the analytics stack is as described earlier in the present disclosure.

In an example, the NSL stack comprises a knowledge stack. The knowledge stack is linked to said local statement of intent to generate data which provides the predefined functionality of: determining the knowledge score of the agents associated with said local statement of intent or one or more other local statements of intent based on a predefined set of questions and answers, during the building or the execution of the solution; and storing the knowledge score of the agents in a knowledge database. Further, in an example of the method 3700 described herein, a prompt is generated by the processor 3504 to change one or more agents of said local statement of intent or one or more other local statements of intent based on their respective knowledge scores.

Further, in an example, the NSL stack comprises an integration stack, where the integration stack is linked to said local statement of intent to generate data which provides the predefined functionality of enabling integration of one or more NSL application programming interfaces with the processor 3504 during the building or the execution of the solution.

In an example, the NSL stack comprises an IoT integration stack. The IoT integration stack is linked to said local statement of intent to generate data which provides the predefined functionality of enabling integration of one or more IoT device interfaces, and/or one or more sensor interfaces, and/or IoT application programming interfaces, with the processor 3504 during the building or the execution of the solution.

In an example, the NSL stack comprises a metaverse stack. The metaverse stack is linked to said local statement of intent to generate data which provides the predefined functionality of enabling integration of one or more virtual reality device interfaces, and/or one or more augmented reality device interfaces, and/or one or more mixed-reality device interfaces, and/or holography device interfaces, virtual reality application programming interfaces, and/or one or more augmented reality application programming interfaces, and/or one or more mixed-reality application programming interfaces, and/or holography application programming interfaces, with the processor 3504 during the building or the execution of the solution.

In an example, the NSL stack comprises a value stack, where the value stack is linked to said local statement of intent to generate data which provides the predefined functionality of: receiving a monetary value of at least one of each entity, each attribute, and the agent, associated with said local statement of intent; and generating, based on the received monetary value, a total monetary value for at least one CES, from amongst the set of CESs, associated with said local statement of intent. In an example, the generating is during the execution of the solution and upon changing of the at least one CES into the state of reality.

Further, in an example, the NSL stack comprises an energy stack. The energy stack is linked to said local statement of intent to generate data which provides the predefined functionality of: determining energy and/or storage space consumed by at least one of each entity, each attribute, the agent, and each CES, associated with said local statement of intent during the building or the execution of the solution. In an example, the determining is done upon changing of the respective entity, attribute, agent, and CES, into the state of reality.

In an example, the NSL stack comprises a substrate stack. The substrate stack is linked to said local statement of intent to generate data which provides the predefined functionality of determining a medium of at least one of user inputs and outputs, prior to the execution of the solution. In an example, the medium is at least one of text, audio, video frames, images, and gestures.

In an example, the NSL stack comprises a security stack. The security stack is linked to said local statement of intent to generate data which provides the predefined functionality of providing security to at least one of user inputs and outputs, during the building or the execution of the solution, based on one or more personalization techniques and/or one or more encryption techniques.

In an example, the NSL stack comprises a privacy stack. The privacy stack is linked to said local statement of intent to generate data which provides the predefined functionality of providing privacy to at least one of user inputs and outputs, during the building or the execution of the solution, based on one or more one or more cryptographic techniques and/or based on one or more encryption techniques.

Further, in an example, the NSL stack comprises a masking stack, where the masking stack is linked to said local statement of intent to generate data which provides the predefined functionality of masking at least one of user inputs and outputs, during the building or the execution of the solution.

In an example, the NSL stack comprises an implied stack. The implied stack is linked to said local statement of intent to generate data which provides the predefined functionality of adding one or more implied entities, and/or one or more implied attributes, and/or one or more implied agents, to the said local statement of intent, during the building or the execution of the solution.

In an example, the NSL stack comprises a gaming stack, wherein the gaming stack is linked to said local statement of intent to generate data which provides the predefined functionality of enabling integration of one or more gaming application programming interfaces with the processor 3504 during the building or the execution of the solution.

Further, in an example, the NSL stack comprises a behaviour determination stack. The behaviour determination stack is linked to said local statement of intent to generate data which provides the predefined functionality of determining behaviour of the agent associated with said local statement of intent or of one or more agents of other local statements of intent, based on analytics of user inputs, during the building or the execution of the solution.

Further, in an example of the method 3700, a distinct identifier (ID) for an NSL stack from amongst the one or more NSL stacks is received by the processor 3504. In an example, the one or more NSL stacks are, by default, set in a state of potentiality while building the solution.

Further, in an example, the machine agent comprises a questioning (Q) agent and/or an answering (A) agent. The one or more of the global statement of intent, the local statements of intent, the details of the entities and the agents, the attributes, the distinct relationships, and the NSL stacks, are received is in response to an interactive question-answering session, based on a question-answer repository, between: (a) the Q agent and the A agent; or (b) between the Q agent, the A agent, and the human agent.

Further, in an example, the machine agent comprises an answering (A) agent, and the user inputs are received from at least one of the A agent and the human agent.

In an example, the computing system 3502 is configured to build a computer-implemented solution using a natural language understood by users and without using programming codes, for which the computing system 350 performs the method 3700 described in the present disclosure.

Further, in an example, a non-transitory computer-readable medium has stored thereon instructions for building a computer-implemented solution using a natural language understood by users and without using programming codes. Said non-transitory computer-readable medium comprises machine executable instructions which when executed by a processor 3504, causes the processor 3504 to perform the method 3700 described in the present disclosure.

Having described and illustrated the principles of our disclosure with reference to the described embodiments, it will be recognized that the described embodiments may be modified in arrangement and detail without departing from such principles. In view of the many possible embodiments to which the principles of our disclosure may be applied, we claim as our disclosure all such embodiments as may come within the scope and spirit of the claimed subject matter and equivalents thereto.

While the present disclosure has been related in terms of the foregoing embodiments, those skilled in the art will recognize that the disclosure is not limited to the embodiments depicted. The present disclosure may be practiced with modification and alteration within the spirit and scope of the claimed subject matter. Thus, the description is to be regarded as illustrative instead of restrictive on the present disclosure.

As will be appreciated by those of ordinary skill in the art, the foregoing example, demonstrations, and method steps may be implemented by suitable computer-readable instructions on a processor-based system, such as a general purpose or special purpose computer, which may be understood as examples of the computing environment 3502. It should also be noted that different implementations of the present subject matter may perform some or all the steps described herein in different orders or substantially concurrently, that is, in parallel. Furthermore, the functions may be implemented by way of computer-readable instructions in a variety of programming languages. Such instructions, as will be appreciated by those of ordinary skill in the art, may be stored or adapted for storage in one or more tangible machine-readable media, such as on memory chips, local or remote hard disks, optical disks or other media, which may be accessed by a processor-based system, such as the computing environment 3502, to execute the stored instructions. Note that the tangible media may comprise paper or another suitable medium upon which the instructions are printed. For instance, the instructions may be electronically captured via optical scanning of the paper or other medium, then compiled, interpreted, or otherwise processed in a suitable manner if necessary, and then stored in a computer memory.

The detailed description is presented to enable a person of ordinary skill in the art to make and use the disclosure and is provided in the context of the requirement for obtaining a patent. The present description is the best presently contemplated method for carrying out the present disclosure. Various modifications to the preferred embodiment will be readily apparent to those skilled in the art and the generic principles of the present disclosure may be applied to other embodiments, and some features of the present disclosure may be used without the corresponding use of other features. Accordingly, the present disclosure is not intended to be limited to the embodiment shown but is to be accorded the widest scope consistent with the principles and features described herein.

1. A method for building a computer-implemented solution using a natural language understood by users and without using programming codes, the method comprising:
receiving, by a processor of a computing system from a user, a global statement of intent indicative of the solution being built using the natural language, wherein the global statement of intent is received in a form of the natural language and is set in a state of potentiality;
receiving, by the processor from the user, one or more local statements of intent associated with the global statement of intent and details of n number of entities and an agent associated with each local statement of intent, wherein each local statement of intent and the details of each entity and the agent are received in a form of the natural language and are respectively set in a state of potentiality, wherein each local statement of intent is a sentence indicative of a sub-step for fulfilling the requirements for executing the solution, wherein each entity includes a noun phrase and participates in fulfilling the requirements of the sub-step indicated by the corresponding local statement of intent, and wherein the agent is at least one of a human agent and a machine agent;
for each entity, receiving, by the processor from the user in a form of the natural language, one or more attributes that define a characteristic of the respective entity and that differentiate the respective entity from other entities of the corresponding local statement of intent and are set in a state of potentiality, wherein each attribute includes at least one of an adjective phrase and an adverb phrase;
wherein the agent at least changes the state of potentiality to a state of reality of each attribute, each entity, each local statement of intent, and the global statement of intent, forming, by the processor, for each local statement of intent, a set of combinatorial-entity-states, CESs, including 2\hat{ }n possible combinations of the n number of entities of the respective local statement of intent, wherein a CES formed based on all, the entities, n in number, of the respective local statement of intent is a trigger combinatorial entity state, trigger CES, and wherein each CES in the set is in a state of potentiality and changes to a state of reality in response to changing the associated entities into a state of reality;
in response to determining only one received local statement of intent associated with the global statement of intent, identifying the trigger CES of the received local statement of intent as an end of the building of the solution;
in response to determining more than one received local statement of intent associated with the global statement of intent, receiving, by the processor, from the user in a form of the natural language, a plurality of distinct relationships based on one or more of predefined rules, constraints, and formulae between the local statements of intent, wherein each distinct relationship is a distinct pathway to fulfill the requirements for executing the solution, wherein the relationships are indicative of whether a trigger CES of one local statement of intent is influencing the set of CESs of another local statement of intent or is an end of the building of the solution; and
receiving, by the processor, from the user in the form of the natural language, one or more natural solution language (NSL) stacks for the one or more local statements of intent, wherein an NSL stack received for a local statement of intent is linked with said local statement of intent to generate data during building or execution of the solution, wherein the generated data is to:
provide a predefined functionality to said local statement of intent; and/or
provide a predefined functionality to one or more other local statements of intent; and/or
perform data analytics,
wherein the state of potentiality is an empty binary state, and the state of reality is a non-empty binary state, and
wherein information in the form of the natural language is received through a handwriting-based interface, a touch-sensitive interface, a voice-based interface or a combination thereof.

2. The method of claim 1, wherein the method comprises:
for each entity of each local statement of intent, receiving, by the processor from the associated agent in a form of the natural language, a user input against the respective entity, wherein receiving the user input against the respective entity is recordation of an event to change the state of potentiality to a state of reality for the respective entity based on the received user input, wherein receiving the user inputs against all the entities associated with each local statement of intent is recordation of an event to change the state of potentiality to a state of reality for the respective local statement of intent, and wherein receiving the user inputs against all the entities associated with all the local statements of intent is recordation of an event to change the state of potentiality to a state of reality for the global statement of intent; and
for each attribute of each entity, receiving, by the processor from the associated agent in a form of the natural language, a user input against the respective attribute, wherein receiving the user input against the respective attribute is recordation of an event to change the state of potentiality to a state of reality for the respective attribute.

3. The method of claim 1, wherein the NSL stack comprises a language stack, wherein the language stack is linked to said local statement of intent to generate data which provides the predefined functionality of changing at least one of user inputs and outputs, during the building or the execution of the solution, from a first natural language to a second natural language, wherein the changing is based on a language equivalence matrix.

4. The method of claim 3, wherein the method comprises:
receiving, by the processor from the user in the form of the first natural language, selection of the second natural language.

5. The method of claim 1, wherein the NSL stack comprises a machine learning stack, wherein the machine learning stack is linked to said local statement of intent to generate data which provides the predefined functionality of assessing and/or modifying and/or disregarding and/or recommending at least one of user inputs and outputs, during the building or the execution of the solution, based on one or more machine learning techniques and/or one or more machine leaning databases, associated with said local statement of intent and/or with one or more other local statements of intent.

6. The method of claim 1, wherein the NSL stack comprises a blockchain stack, wherein the blockchain stack is linked to said local statement of intent to generate data which provides the predefined functionality of:
securing of at least one of user inputs and outputs, during the building or the execution of the solution, based on one or more blockchain techniques, for said local statement of intent and/or for one or more other local statements of intent; and/or
issuing of non-fungible tokens and/or personalized tokens for at least one of user inputs and outputs, during the building or the execution of the solution, based on one or more blockchain techniques, for said local statement of intent and/or for one or more other local statements of intent.

7. The method of claim 1, wherein the NSL stack comprises an analytics stack, wherein the analytics stack is linked to said local statement of intent to generate data which provides the predefined functionality of data analytics of at least one of user inputs and outputs, during the building or the execution of the solution, based on one or more statistical functions, for said local statement of intent and/or for one or more other local statements of intent.

8. The method of claim 1, wherein the NSL stack comprises a knowledge stack, wherein the knowledge stack is linked to said local statement of intent to generate data which provides the predefined functionality of:
determining the knowledge score of the agents associated with said local statement of intent or one or more other local statements of intent based on a predefined set of questions and answers, during the building or the execution of the solution; and
storing the knowledge score of the agents in a knowledge database.

9. The method of claim 8, wherein the method comprises generating, by the processor, a prompt to change one or more agents of said local statement of intent or one or more other local statements of intent based on their respective knowledge scores.

10. The method of claim 1, wherein the NSL stack comprises an integration stack, wherein the integration stack is linked to said local statement of intent to generate data which provides the predefined functionality of enabling integration of one or more NSL application programming interfaces with the processor during the building or the execution of the solution.

11. The method of claim 1, wherein the NSL stack comprises an Internet-of-Things (IoT) integration stack, wherein the IoT integration stack is linked to said local statement of intent to generate data which provides the predefined functionality of enabling integration of one or more IoT device interfaces, and/or one or more sensor interfaces, and/or IoT application programming interfaces, with the processor during the building or the execution of the solution.

12. he method of claim 1, wherein the NSL stack comprises a metaverse stack, wherein the metaverse stack is linked to said local statement of intent to generate data which provides the predefined functionality of enabling integration of one or more virtual reality device interfaces, and/or one or more augmented reality device interfaces, and/or one or more mixed-reality device interfaces, and/or holography device interfaces, virtual reality application programming interfaces, and/or one or more augmented reality application programming interfaces, and/or one or more mixed-reality application programming interfaces, and/or holography application programming interfaces, with the processor during the building or the execution of the solution.

13. he method of claim 1, wherein the NSL stack comprises a value stack, wherein the value stack is linked to said local statement of intent to generate data which provides the predefined functionality of:
receiving a monetary value of at least one of each entity, each attribute, and the agent, associated with said local statement of intent; and
generating, based on the received monetary value, a total monetary value for at least one CES, from amongst the set of CESs, associated with said local statement of intent.

14. The method of claim 13, wherein the generating is during the execution of the solution and upon changing of the at least one CES into the state of reality.

15. The method of claim 1, wherein the NSL stack comprises an energy stack, wherein the energy stack is linked to said local statement of intent to generate data which provides the predefined functionality of:
determining energy and/or storage space consumed by at least one of each entity, each attribute, the agent, and each CES, associated with said local statement of intent during the building or the execution of the solution.

16. The method of claim 15, wherein the determining is upon changing of the respective entity, attribute, agent, and CES, into the state of reality.

17. The method of claim 1, wherein the NSL stack comprises a substrate stack, wherein the substrate stack is linked to said local statement of intent to generate data which provides the predefined functionality of determining a medium of at least one of user inputs and outputs, prior to the execution of the solution.

18. The method of claim 17, wherein the medium is at least one of text, audio, video frames, images, and gestures.

19. The method of claim 1, wherein the NSL stack comprises a security stack, wherein the security stack is linked to said local statement of intent to generate data which provides the predefined functionality of providing security to at least one of user inputs and outputs, during the building or the execution of the solution, based on one or more personalization techniques and/or one or more encryption techniques.

20. The method of claim 1, wherein the NSL stack comprises a privacy stack, wherein the privacy stack is linked to said local statement of intent to generate data which provides the predefined functionality of providing privacy to at least one of user inputs and outputs, during the building or the execution of the solution, based on one or more one or more cryptographic techniques and/or based on one or more encryption techniques.

21. The method of claim 1, wherein the NSL stack comprises a masking stack, wherein the masking stack is linked to said local statement of intent to generate data which provides the predefined functionality of masking at least one of user inputs and outputs, during the building or the execution of the solution.

22. The method of claim 1, wherein the NSL stack comprises an implied stack, wherein the implied stack is linked to said local statement of intent to generate data which provides the predefined functionality of adding one or more implied entities, and/or one or more implied attributes, and/or one or more implied agents, to the said local statement of intent, during the building or the execution of the solution.

23. The method of claim 1, wherein the NSL stack comprises a gaming stack, wherein the gaming stack is linked to said local statement of intent to generate data which provides the predefined functionality of enabling integration of one or more gaming application programming interfaces with the processor during the building or the execution of the solution.

24. The method of claim 1, wherein the NSL stack comprises a behaviour determination stack, wherein the behaviour determination stack is linked to said local statement of intent to generate data which provides the predefined functionality of determining behaviour of the agent associated with said local statement of intent or of one or more agents of other local statements of intent, based on analytics of user inputs, during the building or the execution of the solution.

25. The method of claim 1, wherein the method comprises receiving, by the processor, a distinct identifier (ID) for an NSL stack from amongst the one or more NSL stacks.

26. The method of claim 1, wherein the one or more NSL stacks are, by default, set in a state of potentiality while building the solution.

27. The method of claim 1, wherein the machine agent comprises a questioning (Q) agent and/or an answering (A) agent, wherein receiving one or more of the global statement of intent, the local statements of intent, the details of the entities and the agents, the attributes, the distinct relationships, and the NSL stacks, is in response to an interactive question-answering session, based on a question-answer repository, between the Q agent and the A agent, or between the Q agent, the A agent, and the human agent.

28. The method of claim 2, wherein the machine agent comprises an answering (A) agent, and wherein the user inputs are received from at least one of the A agent and the human agent.

29. A computing system for building a computer-implemented solution using a natural language understood by users and without using programming codes, the computing system comprising:
a processor; and
a memory coupled to the processor, the method comprising instructions executable by the processor to:
receive, from a user, a global statement of intent indicative of the solution being built using the natural language, wherein the global statement of intent is received in a form of the natural language and is set in a state of potentiality;
receive, from the user, one or more local statements of intent associated with the global statement of intent and details of n number of entities and an agent associated with each local statement of intent, wherein each local statement of intent and the details of each entity and the agent are received in a form of the natural language and are respectively set in a state of potentiality, wherein each local statement of intent is a sentence indicative of a sub-step for fulfilling the requirements for executing the solution, wherein each entity includes a noun phrase and participates in fulfilling the requirements of the sub-step indicated by the corresponding local statement of intent, and wherein the agent is at least one of a human agent and a machine agent;
for each entity, receive, from the user in a form of the natural language, one or more attributes that define a characteristic of the respective entity and that differentiate the respective entity from other entities of the corresponding local statement of intent and are set in a state of potentiality, wherein each attribute includes at least one of an adjective phrase and an adverb phrase;
wherein the agent at least changes the state of potentiality to 28. a state of reality of each attribute, each entity, each local statement of intent, and the global statement of intent,
form, for each local statement of intent, a set of combinatorial-entity-states, CESs, including 2\hat{ }n possible combinations of the n number of entities of the respective local statement of intent, wherein a CES formed based on all, the entities, n in number, of the respective local statement of intent is a trigger combinatorial entity state, trigger CES, and wherein each CES in the set is in a state of potentiality and changes to a state of reality in response to changing the associated entities into a state of reality;
in response to determining only one received local statement of intent associated with the global statement of intent, identify the trigger CES of the received local statement of intent as an end of the building of the solution;
in response to determining more than one received local statement of intent associated with the global statement of intent, receive, from the user in a form of the natural language, a plurality of distinct relationships based on one or more of predefined rules, constraints, and formulae between the local statements of intent, wherein each distinct relationship is a distinct pathway to fulfill the requirements for executing the solution, wherein the relationships are indicative of whether a trigger CES of one local statement of intent is influencing the set of CESs of another local statement of intent or is an end of the building of the solution; and
receive, from the user in the form of the natural language, one or more natural solution language (NSL) stacks for the one or more local statements of intent, wherein an NSL stack received for a local statement of intent is linked with said local statement of intent to generate data during building or execution of the solution, wherein the generated data is to:
provide a predefined functionality to said local statement of intent; and/or
provide a predefined functionality to one or more other local statements of intent; and/or
wherein the state of potentiality is an empty binary state, and the state of reality is a non-empty binary state, and
wherein information in the form of the natural language is received through a handwriting-based interface, a touch-sensitive interface, a voice-based interface or a combination thereof.

30. A non-transitory computer-readable medium having stored thereon instructions for building a computer-implemented solution using a natural language understood by users and without using programming codes, the non-transitory computer-readable medium comprising machine executable instructions which when executed by a processor, causes the processor to:
receive, from a user, a global statement of intent indicative of the solution being built using the natural language, wherein the global statement of intent is received in a form of the natural language and is set in a state of potentiality;
receive, from the user, one or more local statements of intent associated with the global statement of intent and details of n number of entities and an agent associated with each local statement of intent, wherein each local statement of intent and the details of each entity and the agent are received in a form of the natural language and are respectively set in a state of potentiality, wherein each local statement of intent is a sentence indicative of a sub-step for fulfilling the requirements for executing the solution, wherein each entity includes a noun phrase and participates in fulfilling the requirements of the sub-step indicated by the corresponding local statement of intent, and wherein the agent is at least one of a human agent and a machine agent;
for each entity, receive, from the user in a form of the natural language, one or more attributes that define a characteristic of the respective entity and that differentiate the respective entity from other entities of the corresponding local statement of intent and are set in a state of potentiality, wherein each attribute includes at least one of an adjective phrase and an adverb phrase;
wherein the agent at least changes the state of potentiality to 28a state of reality of each attribute, each entity, each local statement of intent, and the global statement of intent,
form, for each local statement of intent, a set of combinatorial-entity-states, CESs, including 2\hat{ }n possible combinations of the n number of entities of the respective local statement of intent, wherein a CES formed based on all, the entities, n in number, of the respective local statement of intent is a trigger combinatorial entity state, trigger CES, and wherein each CES in the set is in a state of potentiality and changes to a state of reality in response to changing the associated entities into a state of reality;
in response to determining only one received local statement of intent associated with the global statement of intent, identify the trigger CES of the received local statement of intent as an end of the building of the solution;
in response to determining more than one received local statement of intent associated with the global statement of intent, receive, from the user in a form of the natural language, a plurality of distinct relationships based on one or more of predefined rules, constraints, and formulae between the local statements of intent, wherein each distinct relationship is a distinct pathway to fulfill the requirements for executing the solution, wherein the relationships are indicative of whether a trigger CES of one local statement of intent is influencing the set of CESs of another local statement of intent or is an end of the building of the solution; and
receive, from the user in the form of the natural language, one or more natural solution language (NSL) stacks for the one or more local statements of intent, wherein an NSL stack received for a local statement of intent is linked with said local statement of intent to generate data during building or execution of the solution, wherein the generated data is to:
provide a predefined functionality to said local statement of intent; and/or
provide a predefined functionality to one or more other local statements of intent; and/or
perform data analytics,
wherein the state of potentiality is an empty binary state, and the state of reality is a non-empty binary state, and
wherein information in the form of the natural language is received through a handwriting-based interface, a touch-sensitive interface, a voice-based interface or a combination thereof.
